(19) United States
(12) Patent Application Publication
(10) Pub. No.: US 2026/0220067 A1
(43) Pub. Date: Jul. 30, 2026

(54) Translating CXL.io UIO for Cross-Protocol Memory Access and Legacy Infrastructure Integration

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/629,076

(22) Filed: Mar. 26, 2026

Related U.S. Application Data
(63) Continuation-in-part of application No. 19/371,779, filed on Oct. 28, 2025.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

In environments where entities utilize different protocols while requiring coordinated access to shared resources, there may be scenarios where translations between CXL.io Unordered IO (UIO) TLPs and other TLP types facilitate memory operations and data transfers across different domains. Such translations may be performed by a computer, an apparatus, a cable, or other suitable devices. In some implementations, a method includes translating CXL.io UIOMRd to PCIe memory requests, and translating PCIe Completions to CXL.io UIORdCplD, enabling CXL.io UIO entities to access PCIe-attached resources. In other implementations, an apparatus includes a first interface for CXL.io UIO communication and a second interface for PCIe communication, with a computer that translates between the interfaces. In still other implementations, a method includes translating CXL.io MRd to CXL.io UIOMRd, and translating CXL.io UIORdCplD to CXL.io CplD, enabling entities supporting different CXL.io revisions to interoperate.

### CROSS-REFERENCE TO RELATED APPLICATIONS

This Application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This Application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

Unordered IO (UIO) is an optional capability originally introduced as an Engineering Change Notice for PCIe and later incorporated into the PCIe 6.2 Base Specification. UIO introduces a new wire semantic, capability bits, and Virtual-Channel usage rules to enable multi-path fabrics. UIO defines new TLP types, including UIO Memory Read (UIOMRd), UIO Memory Write (UIOMWr), and corresponding completion types. PCIe 6.2 specification requires UIO to operate only in Flit Mode, requires that UIO TLPs transmit only on Virtual Channels configured for UIO (with Streamlined Virtual Channel capability), forbids ordering dependencies between UIO and non-UIO traffic, forbids the mixing of UIO and non-UIO TLPs on the same Virtual Channel, and does not permit the direct translation of UIO TLPs to non-Flit Mode TLPs (such as a standard MRd). This is because the UIO and non-UIO TLPs protocols have incompatible ordering guarantees, thus a direct translation may violate the ordering model of one or both domains, potentially leading to data corruption or system deadlocks.

### SUMMARY

Computing environments may incorporate entities that communicate using different protocols or different protocol revisions while requiring coordinated access to shared resources. For example, entities supporting CXL.io UIO may need to access resources coupled to entities supporting PCIe, or entities supporting CXL.io without UIO capabilities may need to communicate with entities supporting CXL.io UIO. The UIO protocol defines ordering semantics and TLP formats that differ from non-UIO protocols, which may create incompatibilities when entities attempt to communicate across protocol boundaries. Some implementations provide methods, apparatus, and systems for translating between CXL.io UIO TLPs and other TLP types, enabling interoperability between entities utilizing different protocols or protocol revisions.

In various implementations, a method for translating between CXL TLPs and PCIe TLPs comprises receiving, from a first entity, a CXL.io Unordered Input/Output (UIO) Memory Read (UIOMRd) request comprising a first address and a first Tag; translating, by a computer, the CXL.io UIOMRd to a PCIe memory request comprising a second address and a second Tag; sending the PCIe memory request to a second entity; receiving, from the second entity, a PCIe Completion corresponding to the PCIe memory request; translating the PCIe Completion to a CXL.io UIORdCplD comprising the first Tag and a data payload; and sending the CXL.io UIORdCplD to the first entity.

In other implementations, an apparatus comprises a first interface configured to communicate with a first entity based on CXL.io UIO; a second interface configured to communicate with a second entity based on PCIe; and a computer coupled to the first and second interfaces, the computer configured to receive, via the first interface, a CXL.io UIOMRd comprising a first address and a first Tag; translate the CXL.io UIOMRd to a PCIe memory request comprising a second address and a second Tag; and send, via the second interface, the PCIe memory request to the second entity.

In yet other implementations, a system comprises a first entity configured to communicate based on CXL.io UIO; a second entity configured to communicate based on PCIe; and a computer coupled between the first entity and the second entity, the computer configured to receive a CXL.io UIOMRd from the first entity, translate the CXL.io UIOMRd to a PCIe memory request, send the PCIe memory request to the second entity, receive a PCIe Completion from the second entity, translate the PCIe Completion to a CXL.io UIORdCplD, and send the CXL.io UIORdCplD to the first entity.

In still other implementations, a method for translating between CXL TLPs comprises receiving, from a first entity, a CXL.io MRd comprising a first address and a first Tag; translating, by a computer, the CXL.io MRd to a CXL.io UIOMRd comprising a second address and a second Tag; sending the CXL.io UIOMRd to a second entity; receiving, from the second entity, a CXL.io UIORdCplD comprising the second Tag and a data payload; translating the CXL.io UIORdCplD to a CXL.io CplD comprising the first Tag and the data payload; and sending the CXL.io CplD to the first entity.

### BRIEF DESCRIPTION OF THE DRAWINGS

FIG. 1A illustrates an example of a system that translates between CXL-based traffic and PCIe-based traffic;

FIG. 1B illustrates an example of a TFD demonstrating translations between CXL.io UIOMRd and PCIe UIOMRd;

FIG. 1C illustrates an example of a TFD demonstrating translations between CXL.io UIOMRd and PCIe MRd;

FIG. 2A illustrates an example of a system that translates between CXL.io traffic;

FIG. 2B illustrates an example of a TFD demonstrating translations between CXL.io MRd and CXL.io UIOMRd;

FIG. 2C illustrates an example of a TFD demonstrating translations between CXL.io UIOMRd and CXL.io MRd;

FIG. 3A illustrates an example of a system that translates between NVLink-based traffic and PCIe-based traffic;

FIG. 3B illustrates an example of a TFD demonstrating translations between an NVLink read request and a PCIe UIOMRd;

FIG. 3C illustrates an example of a TFD demonstrating translations between an NVLink read request and a PCIe MRd;

FIG. 4A illustrates an example of a cable comprising an RPU that translates between PCIe-based traffic and NVLink-based traffic;

FIG. 4B illustrates an example of a TFD demonstrating translations between PCIe-based requests and NVLink-based requests;

FIG. 5A illustrates an example of a system that translates between CXL.mem and PCIe;

FIG. 5B illustrates an example of a transaction flow diagram (TFD) demonstrating translations between CXL.mem M2S request and PCIe MRd;

FIG. 5C illustrates an example of a TFD demonstrating translations between CXL.mem M2S request and PCIe UIOMRd;

FIG. 6A illustrates an example of a system comprising first and second entities coupled by a computer that translates between CXL.mem and PCIe;

FIG. 6B illustrates an example of a TFD demonstrating translations between CXL.mem M2S RwD and PCIe MWr;

FIG. 6C illustrates an example of a TFD demonstrating translations between CXL.mem M2S RwD and PCIe UIOMWr;

FIG. 7A illustrates an example of a system comprising a cable that translates between CXL-based traffic and PCIe-based traffic;

FIG. 7B illustrates an example of a TFD demonstrating translations performed by an active cable between CXL.mem transactions and PCIe transactions;

FIG. 8A illustrates an example of a system that translates between CXL.mem and CXL.io;

FIG. 8B illustrates an example of a TFD demonstrating translations between CXL.mem M2S request and CXL.io UIOMRd;

FIG. 8C illustrates an example of a TFD demonstrating translations between CXL.mem M2S request and CXL.io MRd;

FIG. 9A illustrates an example of a system comprising a first host coupled to a first memory, a second host coupled to a second memory, and a computer to translate between CXL.mem and CXL.io;

FIG. 9B illustrates an example of a TFD demonstrating translations between CXL.mem M2S request with data (RwD) and CXL.io Memory Write request (MWr);

FIG. 9C illustrates an example of a TFD demonstrating translations between CXL.mem M2S request with data (RwD) and CXL.io UIO Memory Write request (UIOMWr);

FIG. 10A illustrates an example of a system that translates between CXL protocols, such as between CXL.io and CXL.mem;

FIG. 10B illustrates an example of a TFD demonstrating translations between CXL.io TLPs and CXL.mem messages;

FIG. 10C illustrates an example of a TFD demonstrating translations between CXL.io UIO TLPs and CXL.mem messages;

FIG. 11 illustrates an example of a system comprising a processor comprising an RPU based interface including an IEEE 802.3 PMA coupled to a CXL Device;

FIG. 12A illustrates an example of a system comprising a processor comprising a CXL EP and a PHY based on IEEE 802.3 PMA;

FIG. 12B illustrates an example of a TFD demonstrating CXL.mem communications over a carrier protocol utilizing PHY based on IEEE 802.3 PMA;

FIG. 13A illustrates an example of a system comprising a processor comprising multiple interfaces;

FIG. 13B illustrates an example of a system comprising a processor capable of servicing external requests through CCGs optimized for handling CXL.mem traffic;

FIG. 14A illustrates an example of a silicon device functioning as an established xPU design before modification;

FIG. 14B illustrates an example of a silicon device capable of providing the functionality of a CXL MHD;

FIG. 14C illustrates an example of a silicon device capable of providing the functionality of a UALink Switch;

FIG. 15A illustrates a system comprising a prior art xPU design, such as a processor design, that includes a repurposed area;

FIG. 15B illustrates an example of a Multi-Headed Device (MHD) implementation that may be based on an xPU or an MxPU design, such as a processor design, that includes a repurposed area;

FIG. 15C illustrates an example of a processor comprising termination circuits implemented at interfaces between silicon die areas;

FIG. 16 illustrates an example of utilizing a node controller to connect processors of a memory pool;

FIG. 17A illustrates an example of a system that translates between NVLink-based traffic and CXL-based traffic;

FIG. 17B illustrates an example of a TFD demonstrating translations between an NVLink request and a CXL.io request;

FIG. 18A illustrates an example of a system that translates between NVLink-based traffic and CXL-based traffic;

FIG. 18B illustrates an example of a TFD demonstrating translations between NVLink-based read requests and CXL.io UIO TLPs;

FIG. 18C illustrates an example of a TFD demonstrating translations between NVLink-based read requests and CXL.io MRd TLPs;

FIG. 19A illustrates an example of a system comprising a computer configured to translate between CXL.io traffic and NVLink-based traffic;

FIG. 19B illustrates an example of a TFD demonstrating translations between CXL.io read requests and NVLink-based read requests;

FIG. 20A illustrates an example of a system that translates between PCIe and CXL.mem;

FIG. 20B illustrates an example of a TFD demonstrating translations between PCIe TLPs and CXL.mem messages;

FIG. 20C illustrates an example of a TFD demonstrating translations between PCIe UIO TLPs and CXL.mem messages;

FIG. 21A illustrates an example of a system that translates between first and second PCIe-based protocols;

FIG. 21B illustrates an example of a TFD demonstrating translations between PCIe MRd and PCIe UIOMRd; and

FIG. 21C illustrates an example of a TFD demonstrating translations between PCIe UIOMRd and PCIe MRd.

### DETAILED DESCRIPTION

In heterogeneous computing architectures, entities may utilize different protocols while requiring coordinated access to shared resources. PCIe UIO and CXL UIO define wire semantics and TLP types to enable multi-path fabrics and improved performance. In environments where a first entity supporting CXL.io UIO needs to access resources coupled to a second entity supporting PCIe, translations between CXL.io UIO TLPs and PCIe TLPs may facilitate memory operations and data transfers across different domains. Such translations may be performed by a computer, an apparatus, a cable, or other suitable devices positioned between the first entity and the second entity. The translations may further enable communication over split flit/non-flit paths, wherein the CXL.io UIO portion utilizes flit-based encoding while the PCIe portion may utilize non-flit-based encoding.

In various implementations, a method for translating between Compute Express Link (CXL) Transaction Layer Packets (TLPs) and Peripheral Component Interconnect Express (PCIe) TLPs, comprising: receiving, from a first entity, a CXL.io Unordered Input/Output (UIO) Memory Read (UIOMRd) request comprising a first address and a first Tag; translating, by a computer, the CXL.io UIOMRd to a PCIe memory request comprising a second address and a second Tag; sending, to a second entity, the PCIe memory request; receiving, from the second entity, a PCIe Completion corresponding to the PCIe memory request; translating, by the computer, the PCIe Completion to a CXL.io UIO Read Completion with Data (UIORdCplD) comprising the first Tag and a data payload; and sending, to the first entity, the CXL.io UIORdCplD. The translation process may encompass various aspects of the protocol messages, including opcodes, addresses, Tags, and other TLP fields, thereby enabling communication between entities that utilize different protocols. The computer may maintain state information, such as pending transaction tables or tracker entries, to correlate incoming PCIe Completions with previously transmitted PCIe memory requests and with pending CXL.io transactions. The method may be implemented in hardware, firmware, software, or combinations thereof, and may be performed by various types of devices, such as semiconductor devices, switches, or active cables. Additionally, the elements may communicate through one or more intermediary components, such as a switch, a retimer, or other suitable entity that facilitates information transfer.

In some implementations of the method, the first address is associated with a first physical address space utilized by the first entity, and wherein translating the CXL.io UIOMRd to the PCIe memory request comprises generating the PCIe memory request comprising the second address that is associated with a second physical address space utilized by the second entity. The address translation may be implemented utilizing lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations of the method, the PCIe memory request comprises a PCIe UIO Memory Read (UIOMRd) request, the PCIe Completion comprises a PCIe UIORdCplD, and the CXL.io UIORdCplD comprises a CXL DevLoad (CDL) populated by the computer with Quality-of-Service (QoS) telemetry information. The UIO-to-UIO path may preserve UIO semantics across the protocol boundary, enabling multi-path routing and out-of-order completion capabilities on both sides of the computer. The CDL in CXL.io UIO completions may carry telemetry information such as device load indicators, queue depth information, or latency metrics. The computer may populate the CDL with information derived from the PCIe UIORdCplD, from the computer itself, or from intermediate components. This telemetry propagation may enable the first entity to make informed decisions regarding request pacing, load balancing, or resource allocation.

In some implementations of the method, the PCIe memory request comprises a PCIe non-UIO Memory Read (MRd) request, and the PCIe Completion comprises a PCIe non-UIO Completion with Data (CplD). The UIO-to-non-UIO translation may enable a first entity utilizing CXL.io UIO to access resources coupled to a second entity that does not support UIO capabilities. The computer may translate the UIOMRd to MRd that conforms to non-UIO PCIe memory read. This translation may extend the reach of UIO-capable devices to legacy PCIe infrastructure or to devices that have not implemented UIO support.

In some implementations of the method, the CXL.io UIORdCplD comprises a CXL DevLoad (CDL), and wherein the computer populates the CDL with Quality-of-Service (QoS) telemetry information. When translating from PCIe non-UIO completions that do not include a CDL, the computer may generate QoS telemetry information based on locally observed conditions, such as queue depths, latency measurements, or congestion indicators. The computer may thus provide telemetry to the first entity even when the second entity does not support telemetry reporting.

In some implementations of the method, communication between the computer and the first entity utilizes flit-based encoding, and wherein communication between the computer and the second entity utilizes non-flit-based encoding. The split flit/non-flit path may enable communication between entities operating in different encoding modes. PCIe specifications define UIO for flit-based encoding, and do not permit direct translation of UIO TLPs to non-flit-based encoding. The translations may enable the computer to bridge these incompatible modes, enabling CXL.io UIO transactions to reach PCIe devices operating in non-flit mode. This capability may extend the utility of UIO-based systems to include legacy PCIe infrastructure.

In some implementations, the method further comprises receiving, from the first entity, a CXL.io UIO Memory Write request (UIOMWr) comprising a third address, a third Tag, and write data; translating, by the computer, the CXL.io UIOMWr to a PCIe UIOMWr comprising a fourth address, a fourth Tag, and the write data; sending, to the second entity, the PCIe UIOMWr; receiving, from the second entity, a PCIe UIO Write Completion (UIOWrCpl) comprising the fourth Tag; translating, by the computer, the PCIe UIOWrCpl to a CXL.io UIOWrCpl comprising a CXL DevLoad (CDL) and the third Tag; and sending, to the first entity, the CXL.io UIOWrCpl. UIO write transactions may provide non-posted write with completion acknowledgment, unlike non-UIO PCIe memory writes that are posted. The computer may maintain a mapping between the third Tag associated with the CXL.io transaction and the fourth Tag associated with the PCIe transaction. Upon receiving the PCIe UIOWrCpl from the second entity, the computer may utilize the fourth Tag to identify the corresponding pending transaction and retrieve the third Tag for inclusion in the CXL.io UIOWrCpl.

In some implementations of the method, the third address is associated with a first physical address space, wherein the fourth address is associated with a second physical address space, and wherein the computer translates between the third address and the fourth address. The computer may track both read and write transactions in the same tracker entries or may maintain separate tracking structures for different transaction types.

In some implementations, the method further comprises receiving, from the first entity, a CXL.io UIO Memory Write request (UIOMWr) comprising a third address and write data; translating, by the computer, the CXL.io UIOMWr to a PCIe non-UIO Memory Write request (MWr) comprising a fourth address and the write data; and sending, to the second entity, the PCIe MWr. The PCIe non-UIO Memory Write request may be a posted write that does not require a completion from the second entity. The computer may synthesize a CXL.io UIOWrCpl to send to the first entity upon accepting the write request, since CXL.io UIOMWr is non-posted and the first entity expects a completion, while the underlying PCIe non-UIO MWr is a posted write that does not generate a PCIe completion. The translation from non-posted UIO to posted non-UIO may involve buffering the write data and managing ordering requirements.

In some implementations of the method, the third address is associated with a first physical address space utilized by the first entity; wherein the fourth address is associated with a second physical address space utilized by the second entity; wherein the first entity comprises a CXL host or a CXL device; and wherein the second entity comprises a PCIe host or a PCIe device. The first entity may include CXL hosts such as processors or CXL devices such as accelerators, memory expanders, or NICs. The second entity may include PCIe hosts such as processors or PCIe devices such as GPUs, storage controllers, or network adapters. The address translation may accommodate the different address space configurations utilized by these various entity types.

In various implementations, an apparatus comprising: a first interface configured to communicate with a first entity based on CXL.io Unordered Input/Output (UIO), wherein CXL denotes Compute Express Link; a second interface configured to communicate with a second entity based on Peripheral Component Interconnect Express (PCIe); and a computer coupled to the first interface and the second interface, the computer configured to: receive, via the first interface, a CXL.io UIO Memory Read (UIOMRd) request comprising a first address and a first Tag; translate the CXL.io UIOMRd to a PCIe memory request comprising a second address and a second Tag; and send, via the second interface, the PCIe memory request to the second entity. The apparatus may be implemented as a semiconductor device, a card, a module, an active cable, or other suitable form factor. The first interface may expose the apparatus to the first entity as a CXL device, such as a CXL Type-2 device or a CXL Type-3 device. The second interface may expose the apparatus to the second entity as a PCIe device or as a host via a root port. The computer may include logic for address translation, Tag management, protocol conversion, and transaction tracking. Optionally, the apparatus may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and optional PCIe switch(es) may be positioned between the second interface and the second entity.

In some implementations of the apparatus, the computer is further configured to: receive, via the second interface, a PCIe Completion corresponding to the PCIe memory request; translate the PCIe Completion to a CXL.io UIO Read Completion with Data (UIORdCplD) comprising the first Tag and a data payload; and send, via the first interface, the CXL.io UIORdCplD to the first entity. The computer may maintain tracker entries or similar data structures to associate incoming PCIe Completions with their corresponding CXL.io requests. The translation may include extracting the data payload from the PCIe Completion and formatting it for CXL.io UIORdCplD.

In some implementations of the apparatus, the first address is associated with a first physical address space utilized by the first entity, the second address is associated with a second physical address space utilized by the second entity, and wherein the computer is further configured to translate between the first address and the second address. The apparatus may include address translation logic, which may be implemented using lookup tables, content-addressable memory, translation lookaside buffers, or programmable translation functions. The translation may enable the first entity to access resources using addresses within its native address space while the second entity operates within its own address space.

In some implementations of the apparatus, the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information. The apparatus may extract CDL information from the PCIe UIORdCplD or may generate telemetry based on locally observed conditions. The CDL may enable end-to-end QoS telemetry propagation across the protocol boundary.

In some implementations of the apparatus, the PCIe memory request comprises a PCIe non-UIO Memory Read (MRd) request, the PCIe Completion comprises a PCIe non-UIO Completion with Data (CplD), wherein communication via the first interface utilizes flit-based encoding, and wherein communication via the second interface utilizes non-flit-based encoding. The apparatus may bridge flit-based and non-flit-based encoding modes, enabling CXL.io UIO transactions to reach legacy PCIe devices. The computer may handle the different header formats and encoding requirements of each mode.

In some implementations of the apparatus, the first interface exposes a first endpoint to the first entity, and wherein the second interface exposes a second endpoint to the second entity. The first endpoint may be configured as a CXL endpoint that appears to the first entity as a CXL device. The second endpoint may be configured as a PCIe endpoint that appears to the second entity as a PCIe device. The apparatus may thus function as a bridge between CXL and PCIe domains while presenting standard endpoint interfaces to both entities.

In some implementations of the apparatus, the apparatus comprises a cable including a first module coupled to the first interface, a second module coupled to the second interface, and a physical medium coupling the first module and the second module. The cable may be an active cable that includes the computer for performing protocol and address translations. The first module may include electrical or optical components for communicating with the first entity, and the second module may include electrical or optical components for communicating with the second entity. The physical medium may include twinaxial cable, multimode fiber (MMF), or single-mode fiber (SMF). The cable may be implemented as an Active Optical Cable (AOC) or an Active Copper Cable (ACC).

In various implementations, a system comprising: a first entity configured to communicate based on CXL.io Unordered Input/Output (UIO), wherein CXL denotes Compute Express Link; a second entity configured to communicate based on Peripheral Component Interconnect Express (PCIe); and a computer coupled between the first entity and the second entity, the computer configured to: receive, from the first entity, a CXL.io UIO Memory Read (UIOMRd) request comprising a first address; translate the CXL.io UIOMRd to a PCIe memory request comprising a second address; send, to the second entity, the PCIe memory request; receive, from the second entity, a PCIe Completion corresponding to the PCIe memory request; translate the PCIe Completion to a CXL.io UIO Read Completion with Data (UIORdCplD); and send, to the first entity, the CXL.io UIORdCplD. The system may be deployed in datacenters, HPC environments, or AI/ML training and inference clusters. The system architecture may enable CXL-based hosts or devices to access PCIe-attached resources using CXL.io UIO transactions, which may provide performance benefits such as multi-path routing and out-of-order completions. The computer may function as a bridge that maintains the requirements of each protocol while enabling interoperability.

In some implementations of the system, the first address is associated with a first physical address space utilized by the first entity, the second address is associated with a second physical address space utilized by the second entity, wherein the first entity comprises a CXL host or a CXL device, and wherein the second entity comprises at least one of a memory device, a memory expander, a memory pool, a Graphics Processing Unit (GPU), a Network Interface Card (NIC), an accelerator, a PCIe host, or a PCIe device. GPUs may be accessed via the system for AI/ML workloads, graphics rendering, or general-purpose GPU computing. NICs may be accessed for network packet processing, RDMA, or storage traffic handling. Memory devices, memory expanders, or memory pools may provide expanded memory capacity beyond what is directly attached to the first entity. The address translation may enable the first entity to access these diverse resources using a unified address space.

In some implementations of the system, the PCIe memory request comprises a PCIe non-UIO Memory Read (MRd) request, the PCIe Completion comprises a PCIe non-UIO Completion with Data (CplD), and wherein the CXL.io UIORdCplD comprises a CXL DevLoad (CDL) populated by the computer with Quality-of-Service (QoS) telemetry information. The system may enable CXL.io UIO-capable entities to access legacy PCIe devices while still receiving QoS telemetry in the completion. The computer may generate telemetry information based on observed system conditions when the second entity does not provide such information.

In some implementations of the system, the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information. The UIO-to-UIO system configuration may preserve UIO semantics end-to-end, enabling multi-path routing and enhanced performance on both sides of the computer. QoS telemetry may be propagated from the second entity through the computer to the first entity.

In some implementations of the system, communication between the computer and the first entity utilizes flit-based encoding, and wherein communication between the computer and the second entity utilizes non-flit-based encoding. The system may enable deployment scenarios where newer CXL infrastructure utilizing flit-based encoding needs to communicate with legacy PCIe infrastructure utilizing non-flit-based encoding. The computer may handle the encoding mode differences transparently to the first and second entities.

In heterogeneous computing architectures, entities may communicate using different revisions of CXL.io, wherein earlier protocol revisions may lack support for UIO capabilities present in newer protocol revisions. CXL.io UIO defines wire semantics and TLP types to enable multi-path fabrics and improved performance. In environments where a first entity supporting a first CXL.io needs to access resources coupled to a second entity supporting a second CXL.io with UIO capabilities, translations between CXL.io non-UIO TLPs and CXL.io UIO TLPs may facilitate memory operations and data transfers across incompatible domains. Such translations may be performed by a computer, an apparatus, a cable, or other suitable devices positioned between the first entity and the second entity.

In various implementations, a method for translating between Compute Express Link (CXL) Transaction Layer Packets (TLPs), comprising: receiving, from a first entity, a CXL.io Memory Read (MRd) request comprising a first address and a first Tag; translating, by a computer, the CXL.io MRd to a CXL.io Unordered Input/Output (UIO) Memory Read (UIOMRd) request comprising a second address and a second Tag; sending, to a second entity, the CXL.io UIOMRd; receiving, from the second entity, a CXL.io UIO Read Completion with Data (UIORdCplD) comprising the second Tag and a data payload; translating, by the computer, the CXL.io UIORdCplD to a CXL.io Completion with Data (CplD) comprising the first Tag and the data payload; and sending, to the first entity, the CXL.io CplD. The translation process may encompass various aspects of the protocol messages, including opcodes, addresses, Tags, and other TLP fields, thereby enabling communication between entities that utilize different CXL.io revisions. The computer may convert non-UIO TLP formats to UIO TLP formats for the request path and convert UIO TLP formats back to non-UIO TLP formats for the completion path. The method may be implemented in hardware, firmware, software, or combinations thereof, and may be performed by various types of devices, such as semiconductor devices, switches, or active cables. Additionally, the elements may communicate through one or more intermediary components, such as a switch, a retimer, or other suitable entity that facilitates information transfer.

In some implementations of the method, the first address is associated with a first physical address space utilized by the first entity, and wherein translating the CXL.io MRd to the CXL.io UIOMRd comprises generating the CXL.io UIOMRd comprising the second address that is associated with a second physical address space utilized by the second entity. The address translation may be implemented utilizing mechanisms such as lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include a first HPA space utilized by a first host, and the second physical address space may include a second HPA space utilized by a second host or an address space utilized by a CXL device.

In some implementations of the method, the computer maintains state information comprising tracker entries or pending transaction tables to correlate the CXL.io UIORdCplD with the CXL.io UIOMRd and to associate the second Tag with the first Tag. The computer may allocate tracker entries upon receiving the CXL.io MRd and may store information including the first Tag, the first address, and transaction metadata. When the computer generates the CXL.io UIOMRd, it may assign the second Tag and record the mapping between the first Tag and the second Tag in the tracker entry. Upon receiving the CXL.io UIORdCplD comprising the second Tag, the computer may utilize the state information to identify the corresponding pending transaction and retrieve the first Tag for inclusion in the CXL.io CplD. The tracker entries may be implemented in hardware registers, content-addressable memory, or other suitable storage structures.

In some implementations of the method, the CXL.io UIORdCplD comprises a CXL DevLoad (CDL) field carrying Quality-of-Service (QoS) telemetry information, the second entity utilizes the CDL field for throttling requests from the computer, and the computer does not propagate the CDL field to the first entity in the CXL.io CplD. The CDL in CXL.io UIO completions may carry telemetry information such as device load indicators, queue depth information, or latency metrics populated by the second entity. The second entity may utilize the CDL to communicate its current load state to the computer, enabling the computer to adjust request pacing or implement congestion management. Because the CXL.io utilized by the first entity does not support UIO, the CXL.io CplD does not include a CDL field, and the computer may drop the CDL information when performing the translation and/or log or utilize the CDL information internally for its own traffic management decisions.

In some implementations of the method, a first CXL.io utilized for communicating the CXL.io MRd is an earlier revision than a second CXL.io utilized for communicating the CXL.io UIOMRd, and wherein a first interface utilized by the computer to communicate with the first entity and a second interface utilized by the computer to communicate with the second entity each comprise a CXL endpoint or a switch port. The first CXL.io may conform to an earlier CXL specification revision, such as CXL Specification Revision 1.1, that does not support UIO capabilities, while the second CXL.io may conform to a later CXL specification revision, such as CXL Specification Revision 3.2, that supports UIO capabilities. The first interface may expose a first CXL endpoint or a first switch port to the first entity, and the second interface may expose a second CXL endpoint or a second switch port to the second entity. The computer may thus function as a bridge between different CXL.io revisions while presenting CXL interfaces to both entities. Optionally, the computer may be implemented in an IC package having high-speed differential I/O balls positioned according to a ball grid array layout defined by a PCIe Retimer Supplemental Features and Standard BGA Footprint Specification.

In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

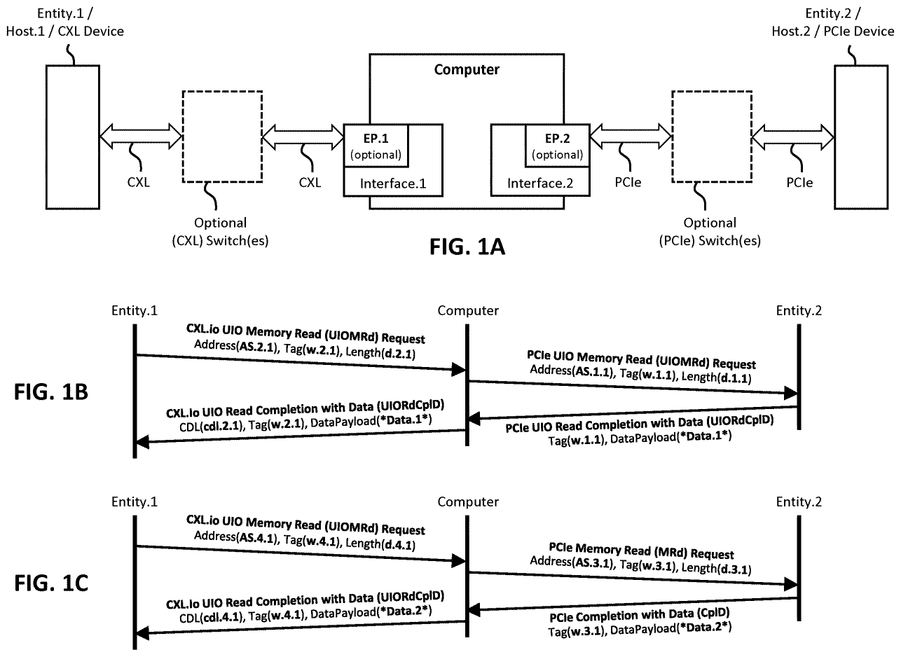

FIG. 1A illustrates an example of a system comprising a computer coupled between a first interface (Interface.1) that may communicate according to a CXL-based protocol, such as CXL.io, CXL.mem, or CXL. cache, and a second interface (Interface.2) that may communicate according to a PCIe-based protocol, such as a protocol conforming to PCI Express Base Specification Revision 6.2. The computer may be implemented in an IC package having high-speed differential I/O balls positioned according to a ball grid array layout defined by the PCIe Retimer Supplemental Features and Standard BGA Footprint Specification. The first interface may expose a first endpoint (EP.1) and may communicate according to a CXL-based protocol with a first entity (Entity.1), which may be a first host (Host.1) or a CXL device. The second interface may expose a second endpoint (EP.2) and may communicate according to a PCIe-based protocol, with a second entity (Entity.2), which may be a second host (Host.2) or a PCIe device. The computer may extract physical addresses from TLPs, PDUs, or messages, received via the first interface, wherein these addresses may refer to a first HPA space utilized by the first entity; translate these addresses; and generate TLPs, PDUs, or messages carrying the translated physical addresses for transmission via the second interface; wherein these translated addresses may correspond to a second HPA space utilized by the second entity. Optional switch(es), such as CXL switches, may be positioned between the first interface and the first entity. Additionally or alternatively, optional switch(es), such as PCIe switches, may be positioned between the second interface and the second entity.

FIG. 1B illustrates an example of a TFD demonstrating translations, performed by a computer, between CXL-based protocol data units (PDUs), such as CXL.io TLPs, received from a first entity (Entity.1), which may be a first host (Host.1) or a CXL device, and PCIe TLPs, sent to a second entity (Entity.2), which may be a second host (Host.2) or a PCIe device, possibly enabling the first entity to access resources mapped to an address space utilized by the second entity. The first entity may initiate a CXL.io transaction that includes a CXL.io UIO Memory Read (UIOMRd) request comprising Address(AS.2.1), Tag(w.2.1), and Length(d.2.1). The computer may translate the CXL.io transaction to a PCIe transaction that includes a PCIe UIOMRd comprising Address(AS.1.1), Tag(w.1.1), and Length(d.1.1), and may send the PCIe UIOMRd to the second entity. Upon receiving a completion from the second entity, which may include a PCIe UIO Read Completion with Data (UIORdCplD) comprising Tag(w.1.1) and DataPayload(*Data.1*), the computer may translate the PCIe UIORdCplD to a CXL.io UIORdCplD comprising CDL(cdl.2.1), Tag(w.2.1), and DataPayload(*Data.1*), wherein the CDL may be populated by the computer with information related to QoS, such as QoS telemetry value or values. The computer may perform further translations, such as protocol translations, opcode translations, command translations, or TLP type translations, e.g., translating between CXL.io UIO TLPs, such as CXL.io UIOMRd TLP, and PCIe non-UIO TLPs, such as PCIe MRd.

Recent PCIe hosts and devices may leverage the PCIe Unordered IO (UIO) optional capability, originally introduced as ECN, and later incorporated into PCIe Base Specification Revision 6.2. PCIe UIO defines a new wire semantic and related capabilities that address limitations of the PCI/PCIe fabric-based ordering rules, enabling improved performance and efficiency, such as by utilizing multi-path routing. The computer may further perform other translations, such as field translations between TLPs conforming to CXL.io and TLPs conforming to PCIe, translations between CXL.io Tags and PCIe Tags, translations between reserved fields, and/or translations between reserved and non-reserved fields.

FIG. 1C illustrates an example of a TFD demonstrating translations between CXL.io TLPs, received from a first entity (Entity.1), and PCIe TLPs, sent to a second entity (Entity.2), possibly enabling the first entity to access resources mapped to an address space utilized by the second entity. The computer may perform further translations, such as protocol translations, opcode translations, command translations, TLP type translations, or field translations, between CXL.io TLPs and PCIe TLPs. The first entity may initiate a CXL.io transaction that includes a CXL.io UIOMRd comprising Address(AS.4.1), Tag(w.4.1), and Length(d.4.1). The computer may translate the CXL.io transaction to a PCIe transaction that includes a PCIe Memory Read (MRd) request comprising Address(AS.3.1), Tag(w.3.1), and Length(d.3.1), and may send the PCIe MRd to the second entity. Upon receiving a completion from the second entity, which may include a PCIe Completion with Data (CplD) comprising Tag(w.3.1) and DataPayload(*Data.2*), the computer may translate the PCIe CplD to a CXL.io UIORdCplD comprising CDL(cdl.4.1), Tag(w.4.1), and DataPayload(*Data.2*), wherein the CDL may be populated by the computer with information related to QoS.

The translations may further enable communication between the first entity and the second entity over a split flit/non-flit path, wherein the CXL.io UIO portion of the path may utilize CXL protocol flits, whereas the PCIe non-UIO portion of the path may utilize Non-Flit Mode (NFM). Such split flit/non-flit path setup is not allowed in standard PCIe Revision 6.2 environments when the whole path utilizes PCIe. In the context of PCIe, Flit Mode (FM) and NFM may use different header formats, wherein routing elements may be required to translate between the FM TLP and NFM TLP formats when the Ingress Port and Egress Port are in different modes. The current PCIe specifications define PCIe UIO for FM, and no translations of UIO TLPs to NFM are permitted.

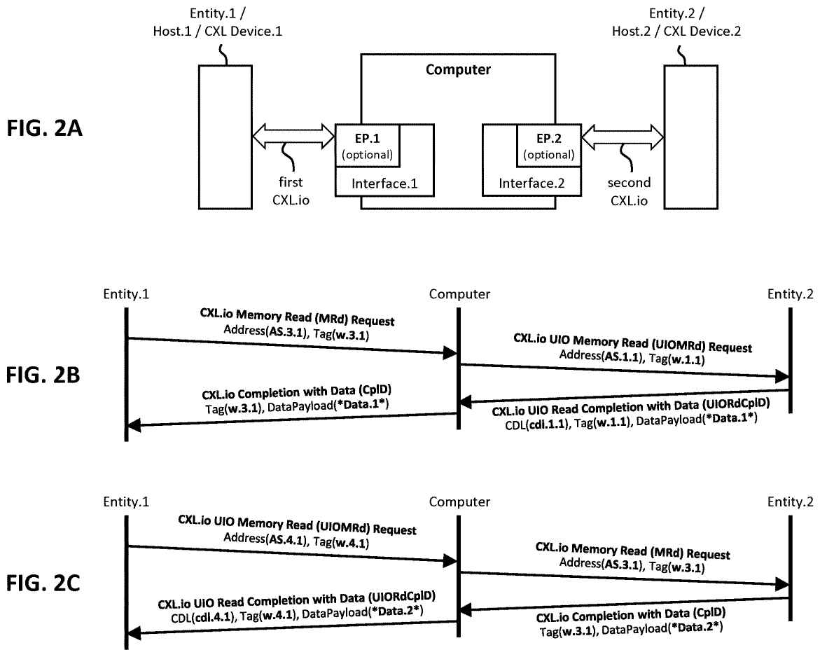

FIG. 2A illustrates an example of a system comprising a computer coupled between first and second interfaces. The first interface (Interface.1) may communicate according to first CXL.io, such as CXL.io conforming to CXL Specification Revision 1.1. The second interface (Interface.2) may communicate according to second CXL.io, such as CXL.io conforming to CXL Specification Revision 3.2. The computer may be implemented in an IC package having high-speed differential I/O balls positioned according to a ball grid array layout defined by PCIe Retimer Supplemental Features and Standard BGA Footprint Specification. The first interface may expose a first endpoint (EP.1) and may communicate according to the first CXL.io with a first entity (Entity.1), which may be a first host (Host.1) or a first CXL device (CXL Device.1). The second interface may expose a second endpoint (EP.2) and may communicate according to the second CXL.io, with a second entity (Entity.2), which may be a second host (Host.2) or a second CXL device (CXL Device.2). The computer may extract physical addresses from first PDUs, such as first CXL.io TLPs, received via the first interface, wherein these addresses may refer to a first physical address space utilized by the first entity; translate these addresses; and generate second PDUs, such as second CXL.io TLPs, carrying the translated physical addresses for transmission via the second interface; wherein these translated addresses may correspond to a second physical address space utilized by the second entity.

FIG. 2B illustrates an example of a TFD demonstrating translations between CXL.io non-UIO TLPs associated with first CXL.io, received from a first entity (Entity.1), which may be a first host (Host.1) or a first CXL device (CXL Device.1), and CXL.io UIO TLPs associated with second CXL.io, sent to a second entity (Entity.2), which may be a second host (Host.2) or a second CXL device (CXL Device.2), possibly enabling the first entity to access resources mapped to an address space utilized by the second entity. The first entity may initiate a CXL.io non-UIO transaction that may include a CXL.io Memory Read (MRd) request comprising Address(AS.3.1) and Tag(w.3.1). A computer may translate the CXL.io non-UIO transaction to a CXL.io UIO transaction that may include a CXL.io UIO Memory Read (UIOMRd) request comprising Address(AS.1.1) and Tag(w.1.1), and may send the CXL.io UIOMRd to the second entity. Upon receiving a completion from the second entity, which may include a CXL.io UIO Read Completion with Data (UIORdCplD) comprising CDL(cdl.1.1), Tag(w.1.1), and DataPayload(*Data.1*), the computer may translate the CXL.io UIORdCplD to a CXL.io Completion with Data (CplD) comprising Tag(w.3.1) and DataPayload(*Data.1*), and send the CXL.io CplD to the first entity. CDL in CXL.io UIO completions may be populated with information related to QoS, such as QoS telemetry value or values. The second entity may utilize the CDL for throttling requests from the computer. The computer may perform additional translations, such as protocol translations, opcode translations, command translations, TLP type translations, Tag translations, length translations, or field translations.

Translations from CXL.io non-UIO to CXL.io UIO may enable CXL hosts and CXL devices to utilize additional capabilities on top of capabilities provided by CXL.io non-UIO, such as peer-to-peer flows to CXL.mem regions, QoS telemetry via CDL Devload (CDL) field in UIO completions, non-posted UIO writes, access to Global-Fabric-Attached Memory Devices (GFDs), use of the Global Integrated Memory (GIM), and cross-domain UIO accesses over a CXL fabric.

FIG. 2C illustrates an example of a TFD demonstrating translations between CXL.io UIO TLPs associated with first CXL.io, received from a first entity (Entity.1), which may be a first host (Host.1) or a first CXL device (CXL Device.1), and CXL.io non-UIO TLPs associated with second CXL.io, sent to a second entity (Entity.2), which may be a second host (Host.2) or a second CXL device (CXL Device.2), possibly enabling the first entity to access resources mapped to an address space utilized by the second entity. The first entity may initiate a CXL.io UIO transaction that may include a CXL.io UIOMRd comprising Address(AS.4.1) and Tag(w.4.1). A computer may translate the CLX.io UIO transaction to a CLX.io non-UIO transaction that may include a CXL.io MRd comprising Address(AS.3.1) and Tag(w.3.1), and may send the CXL.io MRd to the second entity. Upon receiving a completion from the second entity, which may include a CXL.io Completion with Data (CplD) comprising Tag(w.3.1) and DataPayload(*Data.2*), the computer may translate the CXL.io CplD to a CXL.io UIORdCplD comprising CDL(cdl.4.1), Tag(w.4.1), and DataPayload(*Data.2*), and send the CXL.io UIORdCplD to the first entity. CDL in CXL.io UIO completions may be populated with information related to QoS, such as QoS telemetry value or values. The computer may utilize CDL for throttling requests from the first entity. The computer may perform additional translations, such as protocol translations, opcode translations, command translations, TLP type translations, Tag translations, length translations, or field translations. Translations from CXL.io UIO to CXL.io non-UIO may enable newer CXL hosts and CXL devices to utilize legacy non-UIO resources over CXL fabrics and mixed CXL/PCIe fabrics.

In heterogeneous computing architectures, entities may communicate using different interconnect protocols while requiring coordinated access to shared resources. NVLink is a high-bandwidth interconnect technology utilized for communication among GPUs, accelerators, and switches, while PCIe is an interconnect technology utilized for communication between hosts and devices. NVLink-based PDUs utilize an NVLink-based address space, whereas PCIe TLPs utilize a PCIe address space, such as a Host Physical Address (HPA) space. In environments where a first entity communicating via NVLink needs to access resources coupled to a second entity communicating via PCIe, or vice versa, translations between NVLink-based PDUs and PCIe TLPs may facilitate memory operations and data transfers across the different protocol domains. Such translations may be performed by a computer, an apparatus, a cable, or other suitable devices positioned between the first entity and the second entity. The translations may include translating physical addresses between the NVLink-based address space and the PCIe address space, translating between NVLink-based request types and PCIe TLP types, and translating identifier fields such as Tags, SourceIDs, DestinationIDs, and RequesterIDs. The translations may support AI workloads, such as training and inference of large language models (LLMs), mixture-of-experts (MoE) models, multi-modal models, and diffusion models, which may involve transferring model weights, key-value (KV) cache entries, activation tensors, and embedding tables between NVLink-connected entities and PCIe-connected resources.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe Transaction Layer Packets (TLPs) communicated via the second interface, wherein the translating comprises: translating physical addresses between a first address space associated with the NVLink-based protocol and a second address space associated with the PCIe protocol; and translating between NVLink-based request types and PCIe TLP types. The computer may be implemented as a semiconductor device, an integrated circuit (IC), a chiplet, an active cable, a switch, or another suitable device positioned between the first entity and the second entity. The first address space may include an NVLink-based network address space or a GPU physical address space, and the second address space may include an HPA space or another PCIe memory address space. The computer may maintain address translation tables, such as Link TLBs or address mapping tables, to translate between addresses in the first and second address spaces. The translating may be bidirectional: in one direction, the computer may translate NVLink-based PDUs received from the first entity to PCIe TLPs sent to the second entity; in the opposite direction, the computer may translate PCIe TLPs received from the second entity to NVLink-based PDUs sent to the first entity. The NVLink-based request types may include NVLink read requests and NVLink write requests, and the PCIe TLP types may include Memory Read (MRd) requests, Memory Write (MWr) requests, and Completions. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity, the NVLink-based request comprising a first address in the first address space; wherein the PCIe TLPs comprise a PCIe Memory Read (MRd) request comprising a second address in the second address space; and wherein the translating further comprises translating the NVLink-based request to the PCIe MRd and sending the PCIe MRd to the second entity via the second interface. The NVLink-based request may be an NVLink read request carrying a GPU physical address or an NVLink-based network address. The computer may translate this address to an HPA or another address within the PCIe memory address space. The computer may further translate NVLink Tags or transaction identifiers to PCIe Tags for tracking the transaction.

In some implementations of the method, the PCIe TLPs further comprise a PCIe Completion with Data (CplD) from the second entity, the PCIe CplD comprising a data payload corresponding to the PCIe MRd; and wherein the translating further comprises translating the PCIe CplD to an NVLink-based response comprising the data payload. The computer may correlate the PCIe CplD with the previously sent PCIe MRd using the PCIe Tag, and may translate the PCIe Tag back to the corresponding NVLink Tag or transaction identifier. The data payload may be forwarded from the PCIe CplD into the NVLink-based response without modification.

In some implementations of the method, the PCIe TLPs comprise a PCIe Memory Read (MRd) request from the second entity, the PCIe MRd comprising a first address in the second address space; wherein the NVLink-based PDUs comprise an NVLink-based request comprising a second address in the first address space; and wherein the translating further comprises translating the PCIe MRd to the NVLink-based request and sending the NVLink-based request to the first entity via the first interface. In the opposite direction, the second entity may initiate a PCIe MRd targeting a resource accessible via the NVLink fabric. The computer may translate the PCIe address, such as an HPA, to an NVLink-based address, and may generate NVLink identifier fields such as SourceID and DestinationID that are not present in the PCIe domain. The computer may further translate the PCIe Tag to an NVLink Tag for transaction tracking.

In some implementations of the method, the NVLink-based PDUs further comprise an NVLink-based response from the first entity, the NVLink-based response comprising a data payload; and wherein the translating further comprises translating the NVLink-based response to a PCIe Completion with Data (CplD) comprising the data payload. The computer may translate the NVLink Tag back to the PCIe Tag of the original MRd and may generate PCIe completion header fields such as CompleterID and RequesterID. The data payload may be forwarded from the NVLink response into the PCIe CplD.

In some implementations of the method, the PCIe MRd further comprises a RequesterID, and wherein the PCIe CplD further comprises a CompleterID and the RequesterID, and wherein the computer generates the CompleterID for the PCIe CplD. The CompleterID may identify the computer as the PCIe Completer for the transaction. The RequesterID may be reflected from the original PCIe MRd to enable correct routing of the CplD back to the originating entity. These identifiers may be set during enumeration or initialization phases.

In some implementations of the method, the PCIe MRd further comprises a RequesterID and a first Tag, and wherein the NVLink-based request further comprises a SourceID, a DestinationID, and a second Tag; and wherein translating the PCIe MRd to the NVLink-based request comprises generating the SourceID and the DestinationID, and translating the first Tag to the second Tag. The PCIe domain utilizes RequesterID (Bus/Device/Function) for identifying the requester, whereas the NVLink domain utilizes separate SourceID and DestinationID fields for routing. The computer may generate the SourceID based on its own NVLink identity, and the DestinationID based on the target entity in the NVLink fabric. The computer may maintain a Tag mapping table to translate between PCIe Tags and NVLink Tags and to correlate responses with their corresponding requests.

In some implementations of the method, the PCIe TLPs communicated via the second interface utilize a Flit Mode (FM) format, and wherein the first entity comprises a GPU or an accelerator, and the second entity comprises a PCIe host or a PCIe device. Flit Mode may be supported by PCIe Revision 6.0 and above, and may provide increased bandwidth efficiency and support for 14-bit Tags. The second entity may be a PCIe host, such as a CPU or a Root Complex, or a PCIe device, such as an NVMe SSD, a network interface card (NIC), or a memory controller.

In some implementations of the method, the computer translates between Flit Mode (FM) and Non-Flit Mode (NFM) TLP formats for the PCIe TLPs communicated via the second interface, and wherein the NVLink-based PDUs carry data associated with an artificial intelligence (AI) model comprising at least one of: a large language model (LLM), a mixture-of-experts (MoE) model, a multi-modal model, or a diffusion model. When the second interface operates in a different data stream mode than an adjacent PCIe link segment, the computer may translate between FM and NFM TLP formats, including adapting header formats, Tag widths, and encoding mechanisms. LLMs may include transformer-based architectures, MoE models may route inputs to subsets of expert sub-networks, multi-modal models may process inputs across text, image, and video modalities, and diffusion models may generate content through iterative denoising.

In some implementations of the method, the PCIe TLPs carry a data payload not exceeding 64 Double Words (DWs), and wherein the computer translates an NVLink-based PDU to multiple PCIe TLPs. The 64 DW ceiling (256 bytes) may correspond to a maximum payload size supported by the NVLink-based protocol, which may be imposed on the PCIe domain. When an NVLink request targets a data block that exceeds the PCIe Maximum Payload Size or requires multiple completions, the computer may split the request into smaller PCIe TLPs and may reassemble the returned data before translating it back to the NVLink domain.

In some implementations of the method, at least one physical address within the second address space, which is a PCIe memory address space, is not mapped to an NVLink address in the first address space, and wherein the NVLink-based PDUs and the PCIe TLPs carry data associated with an artificial intelligence (AI) workload, the data comprising at least one of: model weights, key-value (KV) cache entries, activation tensors, or embedding tables. The computer may expose only a subset of the PCIe memory address space to the NVLink domain. Unmapped PCIe addresses may correspond to configuration registers, management interfaces, or memory regions reserved for local use by the second entity. KV cache entries may be utilized during autoregressive inference, activation tensors may represent intermediate computation results, and embedding tables may map discrete tokens to continuous vector representations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system translates between NVLink-based traffic and PCIe traffic. The system may support various form factors, including semiconductor devices packaged in retimer-compatible BGA layouts, active cables with optical or copper physical media, and chiplet-based implementations. The system may further include NVLink switches or PCIe switches positioned between the interfaces and the respective entities, enabling multi-entity topologies. The system may be deployed in datacenters, high-performance computing (HPC) environments, or AI/ML training and inference clusters, where NVLink-connected accelerators/GPUs need to access PCIe-attached resources such as host memory, NVMe storage, or network interface cards.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe traffic communicated via the second interface, comprising translating physical addresses between a first address space associated with the NVLink-based protocol and a second address space associated with the PCIe protocol. The system may be deployed in environments where NVLink-connected entities, such as GPUs, accelerators, or NVLink switches, need to access resources coupled to PCIe-connected entities, such as PCIe hosts, NVMe SSDs, or network interface cards. The computer may be implemented as a semiconductor device comprising translation logic, address mapping tables, and pending transaction trackers. The first and second interfaces may support different link speeds, lane widths, and signaling technologies. The system may support bidirectional translation, wherein in one direction the computer translates NVLink-based traffic to PCIe traffic, and in the opposite direction the computer translates PCIe traffic to NVLink-based traffic. Optional switches may be positioned between the first interface and the first entity, and between the second interface and the second entity, to support multi-entity topologies.

In some implementations of the system, the computer is implemented in an IC package having differential input/output (I/O) balls positioned according to a ball grid array (BGA) layout, and wherein the system further comprises a cable including a first module and a second module coupled by a physical medium, the computer residing within the first module or the second module. The BGA layout may conform to a retimer specification, such as the PCIe 5.0, 6.0, or 7.0 Retimer Supplemental Features and Standard BGA Footprint Specification. The physical medium may include a copper wire, a twinaxial cable, a multimode fiber (MMF), or a single-mode fiber (SMF). The cable may be implemented as an Active Optical Cable (AOC) or an Active Copper Cable (ACC).

In some implementations of the system, the computer comprises an NVLink Fusion chiplet, and wherein an NVLink switch is coupled between the first interface and the first entity. The NVLink Fusion chiplet may integrate the translation logic, address mapping functionality, and NVLink interface within a chiplet package. The NVLink switch may enable multi-entity connectivity, allowing multiple accelerators (e.g., GPUs) to access PCIe resources through the same computer. The NVLink Fusion chiplet may be a component of an RPU within an active cable or a discrete semiconductor device.

In some implementations of the system, the second interface operates in Flit Mode (FM), and wherein the NVLink-based traffic and the PCIe traffic carry data associated with an artificial intelligence (AI) workload comprising at least one of: model training, model inference, or model fine-tuning. Flit Mode operation on the second interface may provide increased bandwidth efficiency and support for 14-bit Tags and UIO capabilities. Model training may involve distributing gradient computations and model parameters across NVLink-connected GPUs while accessing datasets stored on PCIe-attached storage. Model inference may involve transferring model weights and KV cache entries between memory tiers. Model fine-tuning may involve adapting pre-trained model parameters using task-specific data.

In some implementations, the translations between NVLink-based traffic and PCIe traffic may involve PCIe Unordered I/O (UIO) TLPs. UIO is an optional capability defined in PCIe that introduces TLP types associated with UIO Virtual Channels, including UIO Memory Read (UIOMRd) and UIO Read Completion with Data (UIORdCplD). UIO enables multi-path routing and may provide improved performance in fabric environments. In environments where a first entity communicating via NVLink needs to access resources coupled to a second entity via PCIe UIO, or vice versa, translations between NVLink-based PDUs and PCIe UIO TLPs may facilitate memory operations and data transfers. UIO TLPs are defined for Flit Mode and are associated with dedicated UIO Virtual Channels. The translations between NVLink-based PDUs and PCIe UIO TLPs may involve translating between NVLink identifier fields, such as SourceID and DestinationID, and PCIe UIO identifier fields, such as RequesterID and DestinationBDF/BF. The translations may support AI workloads such as training and inference of LLMs, MoE models, and multi-modal models.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe UIO Transaction Layer Packets (TLPs) communicated via the second interface. The computer may be implemented as a semiconductor device, an IC, a chiplet, an active cable, a switch, or another suitable device positioned between the first entity and the second entity. PCIe UIO TLPs are distinct from standard PCIe TLPs and are associated with UIO Virtual Channels. The method may be bidirectional: in one direction, the computer may translate NVLink-based PDUs received from the first entity to PCIe UIO TLPs sent to the second entity; in the opposite direction, the computer may translate PCIe UIO TLPs received from the second entity to NVLink-based PDUs sent to the first entity. The translating may include opcode translations, Tag translations, address translations, and identifier translations between the NVLink-based domain and the PCIe UIO domain. The PCIe UIO TLPs may include UIOMRd, UIOMWr, UIORdCplD, UIORdCpl, and UIOWrCpl. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity; wherein the PCIe UIO TLPs comprise a PCIe UIO Memory Read (UIOMRd) request; and wherein the translating further comprises translating the NVLink-based request to the PCIe UIOMRd and sending the PCIe UIOMRd to the second entity via the second interface. The NVLink-based request may be an NVLink read request comprising a physical address and a Tag or transaction identifier. The computer may translate the NVLink-based request to a PCIe UIOMRd carrying a translated address and a PCIe Tag. The UIOMRd may utilize a UIO Virtual Channel for transmission to the second entity.

In some implementations of the method, the PCIe UIO TLPs further comprise a PCIe UIO Read Completion with Data (UIORdCplD) from the second entity, the UIORdCplD comprising a data payload; and wherein the translating further comprises translating the UIORdCplD to an NVLink-based response comprising the data payload. The computer may correlate the UIORdCplD with the previously sent UIOMRd using the PCIe Tag, and may translate the response back to the NVLink domain. UIO completions may be received in any order by the requester, and the computer may handle out-of-order completions when reassembling data for the NVLink response.

In some implementations of the method, the PCIe UIO TLPs comprise a PCIe UIO Memory Read (UIOMRd) request from the second entity; wherein the NVLink-based PDUs comprise an NVLink-based request; and wherein the translating further comprises translating the UIOMRd to the NVLink-based request and sending the NVLink-based request to the first entity via the first interface. In the opposite direction, the second entity may initiate a PCIe UIOMRd targeting a resource accessible via the NVLink fabric. The computer may translate the UIOMRd to an NVLink-based request, generating NVLink SourceID and DestinationID fields and translating the PCIe Tag to an NVLink Tag. The UIOMRd may carry a RequesterID that the computer may store for generating the corresponding UIORdCplD.

In some implementations of the method, the NVLink-based PDUs further comprise an NVLink-based response from the first entity, the NVLink-based response comprising a data payload; and wherein the translating further comprises translating the NVLink-based response to a PCIe UIO Read Completion with Data (UIORdCplD) comprising the data payload. The computer may generate PCIe UIO completion header fields, such as CompleterID and DestinationBDF/BF, when constructing the UIORdCplD. The DestinationBDF/BF may correspond to the RequesterID of the originating UIOMRd. The data payload may be forwarded from the NVLink response into the UIORdCplD.

In some implementations of the method, the translating further comprises translating physical addresses between a first address space associated with the NVLink-based protocol and a second address space associated with the PCIe protocol. The address translation for UIO transactions may utilize the same address mapping tables or Link TLBs as standard PCIe translations. The first address space may include an NVLink-based network address space, and the second address space may include a PCIe memory address space. The address translation may be applied in both directions.

In some implementations of the method, the PCIe UIO TLPs carry a data payload not exceeding 64 Double Words (DWs), wherein the PCIe UIO TLPs are associated with a UIO Virtual Channel, and wherein the NVLink-based PDUs carry data associated with an artificial intelligence (AI) model comprising at least one of: a large language model (LLM), a mixture-of-experts (MoE) model, or a multi-modal model. The 64 DW ceiling (256 bytes) may correspond to a maximum payload size supported by the NVLink-based protocol. UIO TLPs may only be transmitted on Virtual Channels configured for UIO. The first UIO Virtual Channel may be VC2, and a second UIO Virtual Channel, if supported, may be VC4. LLMs may generate token sequences using autoregressive decoding, MoE models may route tokens to specialized expert sub-networks, and multi-modal models may fuse representations across text, image, and video inputs.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

In some implementations, translations between NVLink-based traffic and PCIe UIO TLPs may be implemented as a system comprising interfaces and a computer. The system may support PCIe UIO transactions that enable multi-path routing and out-of-order completions, providing performance benefits for fabric-based deployments. The system may be deployed in environments where NVLink-connected accelerators/GPUs need to access PCIe UIO-capable resources, or where PCIe UIO-capable entities need to access resources accessible via the NVLink fabric.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe UIO Transaction Layer Packets (TLPs) communicated via the second interface. The system may be deployed in environments where NVLink-connected entities need to access PCIe UIO-capable resources, or vice versa. The computer may translate between NVLink-based PDUs and PCIe UIO TLPs, including UIOMRd, UIOMWr, and UIORdCplD. The system may support bidirectional translation: in one direction the computer translates NVLink-based traffic to PCIe UIO TLPs, and in the opposite direction the computer translates PCIe UIO TLPs to NVLink-based traffic. The second interface may operate in Flit Mode, as UIO TLPs are defined for Flit Mode. The system may be implemented in various form factors, including semiconductor devices, active cables, chiplets, and switches.

In some implementations of the system, at least one physical address within a PCIe memory address space is not mapped to an NVLink address, and wherein the first entity comprises a GPU, a CPU, or an accelerator, and the second entity comprises a PCIe host or a PCIe device. The partial address space exposure may allow the system to selectively map only certain PCIe memory regions to the NVLink domain. The first entity may be a GPU, a CPU, or an accelerator connected via NVLink. The second entity may be a PCIe host, such as a CPU comprising a Root Complex, or a PCIe device, such as an NVMe SSD or a network interface card.

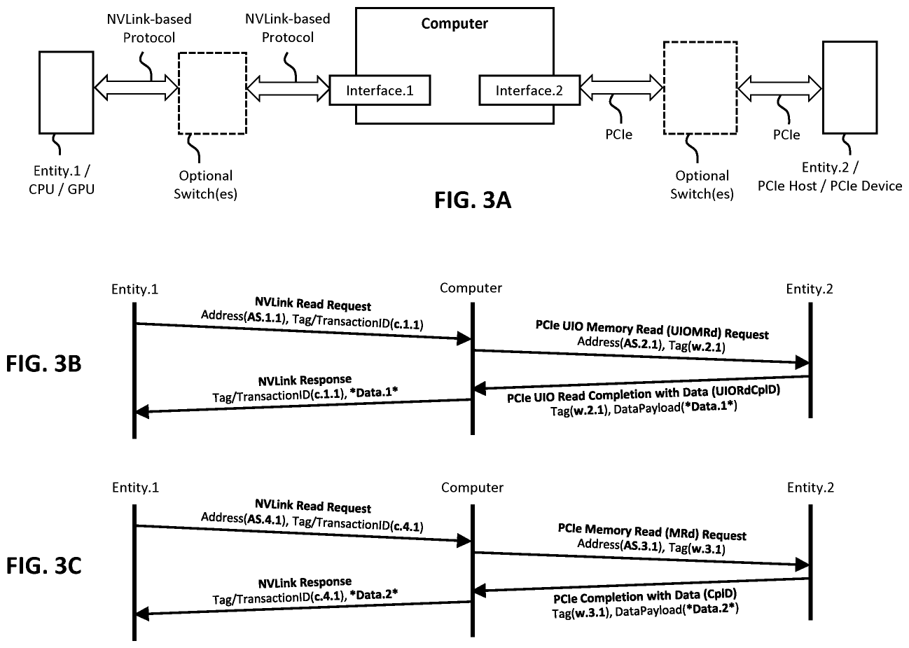

FIG. 3A illustrates an example of a system comprising a computer, which may be referred to as a semiconductor device, coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a PCIe-based protocol with a second entity (Entity.2), which may be a PCIe host or a PCIe device. The first interface may communicate bidirectionally with the first entity using the NVLink-based protocol. The second interface may communicate bidirectionally with the second entity using PCIe. The computer may be implemented in an IC package having high-speed differential I/O balls positioned according to a ball grid array (BGA) layout defined by a retimer specification, such as the PCIe 5.0, 6.0, or 7.0 Retimer Supplemental Features and Standard BGA Footprint Specification. The computer may translate between NVLink-based traffic communicated via the first interface and PCIe traffic communicated via the second interface, including translating physical addresses between a first address space associated with the NVLink-based protocol and a second address space associated with the PCIe protocol. Optional switch(es) may be positioned between the first interface and the first entity. Similarly, optional switch(es) may be positioned between the second interface and the second entity. The system may support bidirectional translation, wherein the computer may translate NVLink-based traffic to PCIe traffic in one direction, and may translate PCIe traffic to NVLink-based traffic in the opposite direction.

FIG. 3B illustrates an example of a TFD demonstrating translations, in one direction, between NVLink-based requests, such as NVLink read requests, received from a first entity (Entity.1), which may be a CPU or a GPU, and PCIe UIO TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address Address(AS.1.1), such as a GPU physical address or an NVLink-based network address, and Tag/TransactionID(c.1.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe UIO Memory Read (UIOMRd) request comprising Address(AS.2.1) and Tag(w.2.1), and may send the PCIe UIOMRd to the second entity. Upon receiving a completion from the second entity, which may include a PCIe UIO Read Completion with Data (UIORdCplD) comprising Tag(w.2.1) and DataPayload(*Data.1*), the computer may translate the PCIe UIORdCplD to an NVLink response comprising Tag/TransactionID(c.1.1) and *Data.1*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe UIO memory read requests in response to receiving an NVLink request from the first entity, such as when splitting an NVLink request for a large block of data to smaller PCIe UIO memory read requests, or when prefetching data from the second entity. The computer may translate NVLink-based traffic to PCIe UIO traffic in one direction, and/or may translate PCIe UIO traffic to NVLink-based traffic in the opposite direction.

FIG. 3C illustrates an example of a TFD demonstrating translations, in one direction, between NVLink-based requests, such as NVLink read requests, received from a first entity (Entity.1), which may be a CPU or a GPU, and PCIe TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.4.1), and Tag/TransactionID(c.4.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe request, such as a PCIe Memory Read (MRd) request comprising a physical address, such as an HPA Address(AS.3.1), and Tag(w.3.1), and may send the PCIe MRd to the second entity. Upon receiving a completion from the second entity, which may include a PCIe Completion with Data (CplD) comprising Tag(w.3.1) and DataPayload(*Data.2*), the computer may translate the PCIe CplD to an NVLink response comprising Tag/TransactionID(c.4.1) and *Data.2*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe memory read requests in response to receiving an NVLink request from the first entity, such as when splitting an NVLink request for a large block of data to smaller PCIe memory read requests, or when prefetching data from the second entity. The computer may translate NVLink-based traffic to PCIe traffic in one direction, and/or may translate PCIe traffic to NVLink-based traffic in the opposite direction.

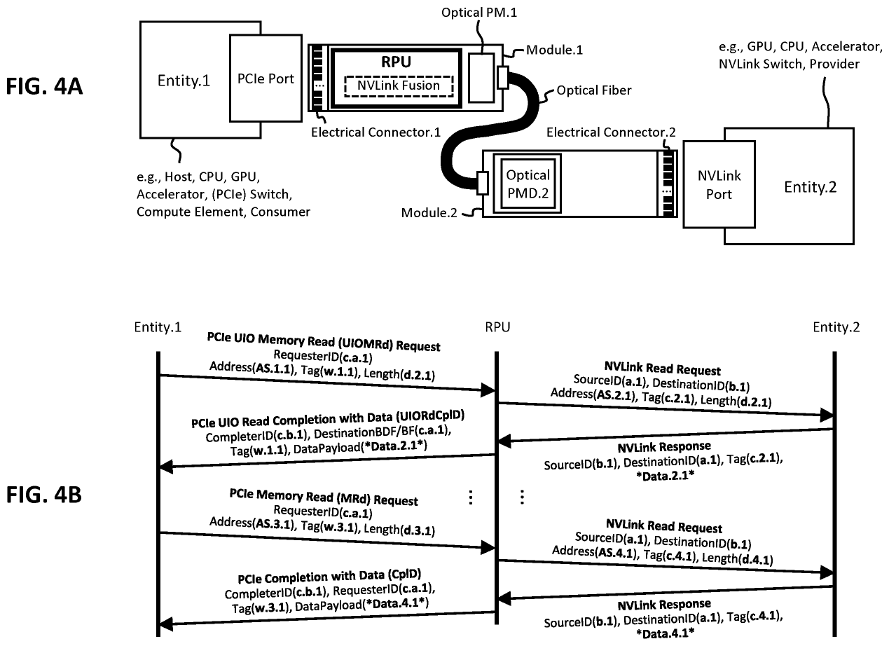

FIG. 4A illustrates an example of a cable comprising an RPU that translates between PCIe-based traffic and NVLink-based traffic. A first entity (Entity.1), which may be a host, a CPU, a GPU, an accelerator, a PCIe switch, or a compute element, and which may be referred to as a consumer, is coupled to a PCIe Port. The PCIe Port is coupled via a first electrical connector (Electrical Connector.1) to a first module (Module.1) within the cable. Module.1 may include an RPU, wherein the RPU may include an NVLink Fusion chiplet shown as an optional component, and an optical physical medium dependent (Optical PMD.1). The RPU within Module.1 may translate between PCIe-based traffic received from the first entity via the PCIe Port and NVLink-based traffic for transmission over the cable, and may translate between NVLink-based traffic received over the cable and PCIe-based traffic sent to the first entity. The cable may further include an optical fiber coupling Module.1 to a second module (Module.2), wherein the optical fiber carries NVLink-based traffic between the modules. Module.2 may include an optical physical medium dependent (Optical PMD.2). Module.2 is coupled via a second electrical connector (Electrical Connector.2) to an NVLink Port of a second entity (Entity.2), which may be a GPU, a CPU, an accelerator, or an NVLink switch, and which may be referred to as a provider. Placing the RPU in Module.1, closer to the PCIe Port, facilitates the translation from PCIe signaling to NVLink signaling at the entry point of the cable, such that the optical fiber carries NVLink-based traffic rather than PCIe-based traffic. NVLink may incorporate electrical signaling characteristics that are compatible with longer-reach interconnects, and may utilize a signaling rate higher than PCIe, and may therefore require fewer lanes for the same bandwidth. Consequently, placing the RPU closer to the PCIe Port may allow for reducing the number of optical fibers or optical wavelengths, which may simplify the cable design and reduce cost. In other examples, the RPU may reside in Module.2 instead of Module.1.

FIG. 4B illustrates an example of a TFD demonstrating translations, by an RPU, between PCIe-based requests received from a first entity (Entity.1) and NVLink-based requests sent to a second entity (Entity.2). The TFD illustrates two exemplary transactions, separated by a vertical ellipsis, demonstrating both PCIe UIO and standard PCIe paths. In a first exemplary transaction, the first entity may send a PCIe UIO Memory Read (UIOMRd) request comprising RequesterID(c.a.1), Address(AS.1.1), Tag(w.1.1), and Length(d.2.1). The RPU may translate the PCIe UIOMRd to an NVLink read request comprising SourceID(b.1), DestinationID(a.1), Address(AS.2.1), Tag(c.2.1), and Length(d.2.1), and may send the NVLink read request to the second entity. Upon receiving an NVLink response from the second entity comprising SourceID(b.1), DestinationID(a.1), Tag(c.2.1), and *Data.2.1*, the RPU may translate the NVLink response to a PCIe UIO Read Completion with Data (UIORdCplD) comprising CompleterID(c.b.1), DestinationBDF/BF(c.a.1), Tag(w.1.1), and DataPayload(*Data.2.1*), and may send the PCIe UIORdCplD to the first entity. The DestinationBDF/BF field in the UIORdCplD may correspond to the RequesterID of the originating UIOMRd, facilitating routing of the completion back to the requester.

In a second exemplary transaction, the first entity may send a PCIe Memory Read (MRd) request comprising RequesterID(c.a.1), Address(AS.3.1), Tag(w.3.1), and Length(d.3.1). The RPU may translate the PCIe MRd to an NVLink read request comprising SourceID(a.1), DestinationID(b.1), Address(AS.4.1), Tag(c.4.1), and Length(d.4.1), and may send the NVLink read request to the second entity. Upon receiving an NVLink response from the second entity comprising SourceID(b.1), DestinationID(a.1), Tag(c.4.1), and *Data.4.1*, the RPU may translate the NVLink response to a PCIe Completion with Data (CplD) comprising CompleterID(c.b.1), RequesterID(c.a.1), Tag(w.3.1), and DataPayload(*Data.4.1*), and may send the PCIe CplD to the first entity. In both transactions, the RPU may generate NVLink SourceID and DestinationID values when translating from PCIe requests, and may generate PCIe CompleterID values when translating NVLink responses to PCIe completions. The RPU may maintain state information, such as pending transaction tables, to correlate PCIe Tags with NVLink Tags and to associate completions with their corresponding requests. The RPU may translate physical addresses between the PCIe address space and the NVLink address space.

Heterogeneous computing architectures may incorporate systems wherein entities utilize different protocols while requiring coordinated access to shared resources. In such environments, a first entity operating with CXL.mem may need to access resources coupled to a second entity operating with PCIe. For example, a newer generation server may utilize CXL.mem to access data on a non-CXL server populated with DDR4, where translations between CXL.mem and PCIe enable utilizing the non-CXL server as a memory pool. Translations between CXL.mem messages and PCIe TLPs may facilitate memory operations, data transfers, and resource sharing across different domains while maintaining the requirements of each protocol. Such translations may be performed by a computer, an apparatus, a cable, or other suitable devices positioned between the first entity and the second entity.

In various implementations, a method for translating between Compute Express Link (CXL) messages and Peripheral Component Interconnect Express (PCIe) Transaction Layer Packets (TLPs), comprising: receiving, by a computer from a first entity, a CXL.mem Master-to-Subordinate (M2S) request; translating, by the computer, the CXL.mem M2S request to a PCIe memory request; sending, by the computer to a second entity, the PCIe memory request; receiving, by the computer from the second entity, a PCIe Completion corresponding to the PCIe memory request; translating, by the computer, the PCIe Completion to a CXL.mem Subordinate-to-Master (S2M) response; and sending, by the computer to the first entity, the CXL.mem S2M response. The translation process may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information, such as pending transaction tables or tracker entries, to correlate incoming PCIe Completions with previously transmitted PCIe memory requests and with pending CXL.mem transactions. Additionally, the elements may communicate through one or more intermediary components, such as a switch, a retimer, or other suitable entity that facilitates information transfer.

In some implementations of the method, the CXL.mem M2S request comprises a first physical address belonging to a first physical address space utilized by the first entity, and wherein translating the CXL.mem M2S request to the PCIe memory request comprises generating the PCIe memory request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations of the method, the CXL.mem M2S request comprises MemRd* and a first Tag, the PCIe memory request comprises a non-UIO Memory Read request comprising a second Tag, the PCIe Completion comprises a Completion with Data (CplD) comprising Data, and the CXL.mem S2M response comprises an S2M Data Response (S2M DRS) comprising MemData, the Data, and the first Tag. The computer may maintain a mapping between the first Tag associated with the CXL.mem transaction and the second Tag associated with the PCIe transaction, wherein this mapping may be stored in a tracker entry, a translation table, or similar data structure. Upon receiving the CplD from the second entity, the computer may utilize the second Tag to identify the corresponding pending transaction and retrieve the first Tag for inclusion in the S2M DRS. The non-UIO Memory Read request may conform to non-UIO PCIe memory read semantics as defined in applicable PCIe specifications.

In some implementations, the method further comprises receiving, by the computer from the first entity, a CXL.mem M2S request with Data (M2S RwD) comprising a MemWr* and write data; translating the CXL.mem M2S RwD to a PCIe non-UIO Memory Write request comprising the write data; sending the PCIe non-UIO Memory Write request to the second entity; and sending a CXL.mem S2M No Data Response (S2M NDR) to the first entity. The PCIe non-UIO Memory Write request may be a posted write that may not require a completion from the second entity. The S2M NDR may include Cmp* indicating successful acceptance of the write request by the computer. The computer may include a DevLoad in the S2M NDR to provide telemetry information or to throttle subsequent requests from the first entity.

In some implementations of the method, the computer sends the CXL.mem S2M NDR to the first entity before sending the non-UIO Memory Write request to the second entity. Sending the S2M NDR before the PCIe Memory Write request may reduce latency observed by the first entity and may allow the first entity to proceed with subsequent operations without waiting for the write to propagate to the second entity. The computer may buffer the write data and transmit the PCIe Memory Write request asynchronously, optionally implementing flow control or ordering mechanisms to maintain consistency guarantees.

In some implementations, the method further comprises receiving, by the computer from the first entity, a CXL.mem M2S request with Data (M2S RwD) comprising a MemWr* and write data; translating the CXL.mem M2S RwD to a PCIe UIO Memory Write request (UIOMWr) comprising the write data; sending the PCIe (UIOMWr) to the second entity; receiving, from the second entity, a PCIe UIO Write Completion (UIOWrCpl); and sending a CXL.mem S2M No Data Response (S2M NDR) comprising Cmp* to the first entity. PCIe UIO may provide enhanced capabilities compared to non-UIO PCIe, including support for non-posted writes that return completions. The UIOWrCpl may indicate successful completion of the write operation by the second entity and may carry additional information.

In some implementations of the method, the CXL.mem S2M NDR comprises a DevLoad, and wherein the computer populates the DevLoad with information derived from at least one of the PCIe UIOWrCpl, or telemetry information. In some revisions of the CXL specification, CXL.mem S2M NDR messages may include a DevLoad. The computer may populate the DevLoad of the CXL.mem S2M NDR with information derived from the UIOWrCpl or with telemetry information generated by the computer.

In some implementations of the method, the PCIe UIOWrCpl comprises a CXL DevLoad (CDL) comprising Quality-of-Service (QoS) telemetry, and wherein the computer translates the QoS telemetry carried in the CDL of the PCIe UIOWrCpl to a DevLoad of the CXL.mem S2M NDR, enabling the first entity to receive QoS information originating from the second entity. The CDL may carry telemetry information, such as device load indicators, queue depth information, or latency metrics generated by the second entity. By translating the CDL to the DevLoad, the computer may propagate QoS telemetry across the protocol boundary, enabling the first entity to make informed decisions regarding request pacing, load balancing, or resource allocation based on conditions at the second entity. The translation may involve copying, scaling, adjusting, or mapping of the telemetry values between the CDL and DevLoad field formats.

In some implementations of the method, the CXL.mem M2S request comprises MemRd* and a first Tag, the PCIe memory request comprises a UIO Memory Read (UIOMRd) request comprising a second Tag, the PCIe Completion comprises a UIO Read Completion with Data (UIORdCplD) comprising Data, and the CXL.mem S2M response comprises an S2M Data Response (S2M DRS) comprising MemData, the Data, and the first Tag. The UIOMRd may provide enhanced semantics compared to non-UIO PCIe memory read operations, such as support for out-of-order completions or additional metadata fields. The UIORdCplD may carry the requested data along with status information or telemetry. The computer may extract the data from the UIORdCplD and format it according to CXL.mem S2M DRS requirements for delivery to the first entity.

In some implementations of the method, the CXL.mem S2M response comprises a DevLoad, wherein the computer populates the DevLoad with telemetry information or utilizes the DevLoad to throttle CXL.mem M2S requests from the first entity, wherein the first entity comprises a first host, and wherein the second entity comprises a second host or a PCIe device. The DevLoad may enable the computer to communicate backpressure, congestion indicators, or performance metrics to the first host. The first host may utilize this information to adjust its request rate, implement adaptive flow control, or make scheduling decisions. The second entity may include various types of devices, such as a server, a memory expander, a GPU, a NIC, a storage device, or other PCIe-attached resources.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a first interface configured to communicate with a first entity based on CXL.mem, wherein CXL denotes Compute Express Link; a second interface configured to communicate with a second entity based on Peripheral Component Interconnect Express (PCIe); a computer coupled to the first interface and the second interface, the computer configured to: receive, via the first interface, a CXL.mem Master-to-Subordinate (M2S) request comprising a first physical address belonging to a first physical address space utilized by the first entity; translate the CXL.mem M2S request to a PCIe memory request comprising a second physical address belonging to a second physical address space utilized by the second entity; and send, via the second interface, the PCIe memory request to the second entity. The apparatus may be implemented as a semiconductor device, a card, a module, an active cable, or other suitable form factor. The first interface may expose the apparatus to the first entity as a CXL switch, or as a CXL device, such as a CXL Type-2 device or a CXL Type-3 device. The second interface may expose the apparatus to the second entity as a PCIe switch, as a PCIe device, or as a host via a root port. The computer may include logic for address translation, Tag management, protocol conversion, and transaction tracking. Optionally, the apparatus may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and optional PCIe switch(es) may be positioned between the second interface and the second entity.

In some implementations of the apparatus, the computer is further configured to: receive, via the second interface, a PCIe Completion corresponding to the PCIe memory request; translate the PCIe Completion to a CXL.mem Subordinate-to-Master (S2M) response; and send, via the first interface, the CXL.mem S2M response to the first entity; wherein the first interface exposes to the first entity one of the following: a CXL switch, a CXL Type-2 device, or a CXL Type-3 device; and wherein the second interface exposes to the second entity one of the following: a PCIe switch, a PCIe device, or a root port. When the second interface exposes a root port, the apparatus may function as a host toward the second entity, enabling the apparatus to initiate PCIe transactions to downstream PCIe devices. When the second interface exposes a PCIe device, the apparatus may function as an endpoint toward the second entity, such as when coupled to another host.

In some implementations of the apparatus, the first physical address space comprises the second physical address space. The second physical address space may be a PCIe Memory Address Space, a DMA address space, an IO virtual address (IOVA) space, or a system address space, and may further be a subset of the first physical address space or identical to the first physical address space.

In some implementations of the apparatus, the apparatus comprises a cable including a first module coupled to the first interface, a second module coupled to the second interface, and a physical medium coupling the first module and the second module. The cable may be an active cable that includes the computer for performing protocol and address translations. The first module may include electrical or optical components for communicating with the first entity, and the second module may include electrical or optical components for communicating with the second entity. The cable may conform to various industry standards or specifications, such as those defined by the Optical Internetworking Forum (OIF), the Small Form Factor Committee (SFF), or the IEEE.

In some implementations of the apparatus, the physical medium comprises a twinaxial cable, a multimode fiber (MMF), or a single-mode fiber (SMF); and wherein the cable is configured to couple to the first entity or the second entity via a connector selected from Octal Small Form Factor Pluggable Module (OSFP), Octal Small Form Factor eXtra Dense Pluggable Module (OSFP-XD), Quad Small Form-Factor Pluggable (QSFP), or Quad Small Form-Factor Pluggable Double Density (QSFP-DD). The twinaxial cable may be suitable for shorter reach applications within a rack or between adjacent racks, while fiber options may enable longer reach connectivity. The MMF may be utilized for distances up to several hundred meters, while SMF may be utilized for longer distances. The connector type may be selected based on bandwidth requirements, density considerations, and deployment environment. The cable may be implemented as an Active Optical Cable (AOC) or an Active Copper Cable (ACC) depending on the physical medium utilized.

In various implementations, a system comprising: a first entity coupled to a first memory; a second entity coupled to a second memory, wherein the second entity comprises a Central Processing Unit (CPU) configured to support Peripheral Component Interconnect Express (PCIe) but not Compute Express Link (CXL); and a computer coupled between the first entity and the second entity, the computer configured to: receive, from the first entity, a CXL.mem Master-to-Subordinate (M2S) request; translate the CXL.mem M2S request to a PCIe memory request; send, to the second entity, the PCIe memory request to access the second memory; receive, from the second entity, a PCIe Completion; and send, to the first entity, a CXL.mem Subordinate-to-Master (S2M) response corresponding to the PCIe Completion. The system may enable the first entity to access memory resources coupled to CPUs that do not support CXL, thereby extending the reach of CXL-based memory pooling to include legacy and/or non-CXL infrastructure. The CPU of the second entity may be a processor from a generation that predates CXL support, or may be a processor that uses its CXL capabilities for other purposes. The second memory may be attached to the second entity via memory controllers integrated in the CPU, and the computer may enable the first entity to access this memory utilizing PCIe transactions that the CPU can process.

In some implementations of the system, the second entity and the second memory form a memory pool, and wherein the computer is configured to expose the memory pool to the first entity. The memory pool may appear to the first entity as CXL-attached memory, even though the underlying memory is coupled to a non-CXL CPU. The computer may expose the memory pool by responding to CXL.mem initialization and configuration operations from the first entity and by translating subsequent memory access requests to PCIe transactions directed to the second entity. Multiple second entities and their associated memories may be aggregated into a larger memory pool that the computer exposes to one or more first entities.

In some implementations of the system, the second memory comprises DDR4 memory, and wherein the first memory comprises DDR5 memory. The system may enable tiered memory architectures wherein the first entity utilizes higher-performance memory technologies, such as DDR5, for latency-sensitive operations, while utilizing DDR4 memory coupled to the second entity for capacity-oriented workloads. The computer may enable the first entity to transparently access the DDR4 memory tier utilizing CXL.mem, and memory management software executing on the first entity may place data across tiers based on access patterns, SLA requirements, tenant identities, temperature thresholds, or other policies.

In some implementations of the system, The system of claim 20 wherein the CPU comprises a pre-CXL generation CPU, and the pre-CXL generation CPU is installed in a datacenter server. The pre-CXL generation CPU may include processors that were manufactured or designed before CXL became available, or processors that do not include CXL capability. The datacenter server may be a server that has been decommissioned from primary compute duties but retains functional memory and PCIe connectivity. The system may enable repurposing of such servers as memory pool contributors, thereby extending the useful life of datacenter infrastructure and reducing electronic waste while providing additional memory capacity to CXL-enabled first entities.

In multi-host environments, there may be scenarios where first entities operating with CXL.mem need to access memory or other resources coupled to a second entity operating with PCIe. For example, newer generation servers may utilize CXL.mem to access data on a non-CXL server, where translations between CXL.mem and PCIe enable utilizing the non-CXL server as a shared memory pool. Translations between CXL.mem messages and PCIe TLPs may facilitate memory operations, data transfers, and resource sharing across different protocol domains while maintaining the requirements of each protocol and routing responses to the appropriate requesting entities.

In various implementations, a method for translating between Compute Express Link (CXL) messages and Peripheral Component Interconnect Express (PCIe) Transaction Layer Packets (TLPs), comprising: receiving, by a computer, CXL.mem Master-to-Subordinate (M2S) requests from first entities; translating, by the computer, the CXL.mem M2S requests to PCIe memory requests; sending, by the computer to a second entity, the PCIe memory requests; receiving, by the computer from the second entity, PCIe Completions corresponding to the PCIe memory requests; translating, by the computer, the PCIe Completions to CXL.mem Subordinate-to-Master (S2M) responses; and sending, by the computer, each of the CXL.mem S2M responses to a corresponding one of the first entities. The translation process may encompass various aspects of the protocol messages, including opcodes, addresses, and transaction identifiers, thereby enabling communication between CXL.mem-capable entities and a PCIe-capable entity. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information to correlate incoming PCIe Completions with previously transmitted PCIe memory requests and with the originating first entities, enabling responses to be routed to the correct requester. The first entities may include hosts, accelerators, GPUs, NICs, or other CXL-capable devices that share access to resources coupled to the second entity. Additionally, the elements may communicate through one or more intermediary components, such as a switch, a retimer, or other suitable entity that facilitates information transfer.

In some implementations of the method, the computer maintains separate tracking structures for each of the first entities, and wherein the computer processes CXL.mem M2S requests received from different ones of the first entities in parallel, by storing transaction information in the respective separate tracking structures. The separate tracking structures may enable the computer to manage outstanding transactions from different first entities without interference. Each tracking structure may store information such as CXL.mem Tags, addresses, opcodes, and timestamps associated with transactions from the corresponding first entity. By maintaining separate structures, the computer may support concurrent processing wherein a CXL.mem M2S request from one first entity may be translated and sent while awaiting a PCIe Completion for a request from another first entity. The tracking structures may be implemented as tables, queues, linked lists, content-addressable memories, or other data structures suitable to associate PCIe Completions with their originating CXL.mem transactions and first entities.

In some implementations of the method, the computer sequentially processes the CXL.mem M2S requests received from the first entities by queuing the CXL.mem M2S requests and translating each queued CXL.mem M2S request in order, wherein the computer completes sending one of the PCIe memory requests before translating a subsequent one of the CXL.mem M2S requests. Sequential processing may be utilized in implementations where simplicity, determinism, and/or resource constraints favor processing one request at a time. The computer may queue incoming CXL.mem M2S requests in a first-in-first-out (FIFO) buffer or other queuing structure and may process each request to completion before beginning the next, which may reduce the complexity of tracking concurrent transactions and may provide predictable ordering of memory operations. Sequential processing may be suitable for scenarios where the first entities have relatively low aggregate request rates or where strict ordering guarantees are desired.

In some implementations of the method, a first one of the first entities utilizes a first Host Physical Address (HPA) space, wherein a second one of the first entities utilizes a second HPA space different from the first HPA space, and wherein translating the CXL.mem M2S requests to the PCIe memory requests comprises translating addresses from the first HPA space and addresses from the second HPA space to corresponding addresses in a physical address space utilized by the second entity. The address translation may accommodate scenarios where different first entities operate with independent HPA spaces that may have overlapping address ranges. The computer may maintain separate translation tables or functions for each first entity, mapping addresses from each first entity's HPA space to non-overlapping regions of the second entity's physical address space. Alternatively, the computer may utilize a unified translation mechanism that incorporates first entity identifiers as part of the address mapping. The second entity's physical address space may be a PCIe Memory Address Space, a system address space, or a DMA address space. The translation may involve base-and-offset calculations, page table lookups, or programmable translation functions.

In some implementations of the method, the computer allocates PCIe Tags for the PCIe memory requests, wherein the computer associates the PCIe Tags with identifiers of the corresponding ones of the first entities, and wherein the computer utilizes the PCIe Tags in the PCIe Completions to identify the corresponding ones of the first entities. PCIe Tags serve as transaction identifiers that enable completers to associate completions with their originating requests. The computer may allocate PCIe Tags from a pool and may record, for each allocated Tag, the identifier of the first entity that originated the corresponding CXL.mem M2S request. When a PCIe Completion arrives, the computer may extract the Tag from the completion, look up the associated first entity identifier, and route the translated CXL.mem S2M response to that first entity. The computer may also maintain a mapping between PCIe Tags and CXL.mem Tags to populate the correct Tag in the S2M response.

In some implementations of the method, the computer detects a timeout condition when a PCIe Completion corresponding to one of the PCIe memory requests is not received within a threshold duration, and wherein responsive to detecting the timeout condition, the computer sends a CXL.mem S2M response comprising an error indication to the corresponding one of the first entities. The timeout detection may provide a mechanism for handling non-responsive or failed transactions, preventing indefinite waiting by the first entities. The computer may associate a timestamp or timer with each outstanding PCIe memory request and may periodically check whether any pending transactions have exceeded the threshold duration. The threshold duration may be configurable and may be selected based on expected latencies, system policies, or protocol requirements. Upon detecting a timeout, the computer may release resources associated with the timed-out transaction, such as allocated Tags or tracking structure entries, and may generate an S2M response with an error opcode to notify the first entity of the failure. The timeout mechanism may also trigger logging, alerting, or error recovery procedures.

In some implementations of the method, at least one of the PCIe Completions comprises an error status indicating an Unsupported Request (UR) or a Completer Abort (CA), and wherein the computer translates the error status to an error indication in a corresponding one of the CXL.mem S2M responses. PCIe defines completion status values that indicate error conditions encountered by the completer. An Unsupported Request (UR) status indicates that the completer does not support the request type or that the request targeted an invalid address range. A Completer Abort (CA) status indicates that the completer encountered an error that prevented completion of the request. Other PCIe completion statuses, such as Configuration Request Retry Status (CRS), may also be translated to appropriate CXL.mem error indications. The computer may map these PCIe error statuses to CXL.mem S2M NDR messages with error opcodes or to S2M DRS messages with poison indicators, depending on the nature of the original request and the error encountered. The translation may preserve error semantics to enable the first entity to take appropriate recovery actions.

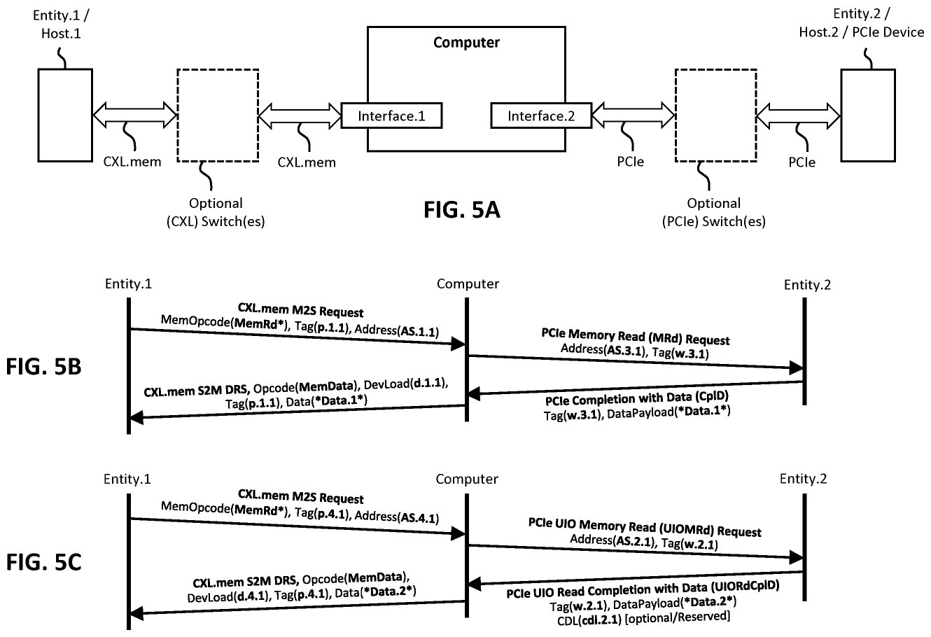

FIG. 5A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). In some examples, the second interface may expose a PCIe device, and may communicate according to PCIe with a second entity (Entity.2), such as a second host (Host.2) or another PCIe device. In other examples, the second interface may expose a root port (RP) and may communicate according to PCIe with a PCIe device. The computer may extract physical addresses within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity. Similarly, optional PCIe switch(es) may be positioned between the second interface and the second entity.

FIG. 5B illustrates an example of a transaction flow diagram (TFD) demonstrating translations, performed by a computer, between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that includes a CXL.mem M2S request comprising MemOpcode(MemRd*), Tag(p.1.1), and Address(AS.1.1). The computer may translate the CXL.mem transaction to a PCIe transaction, which may include a PCIe Memory Read (MRd) request comprising Address(AS.3.1) and Tag(w.3.1), and may send the PCIe MRd to the second entity. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*), and may send the CXL.mem S2M DRS to the first entity. The computer may perform further translations, such as protocol translations, opcode translations, command translations, TLP type translations, or field translations, such as Tag translations, between messages conforming to CXL.mem and TLPs conforming to PCIe. The computer may populate the DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification.

FIG. 5C illustrates an example of a TFD demonstrating translations between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request comprising MemOpcode(MemRd*), Tag(p.4.1), and Address(AS.4.1). The computer may translate the CXL.mem transaction to a PCIe transaction, which may include a PCIe UIO Memory Read (UIOMRd) request comprising Address(AS.2.1) and Tag(w.2.1), and may send the PCIe UIOMRd to the second entity. Upon receiving a response or completion from the second entity, which may include a PCIe UIO Read Completion with Data (UIORdCplD) comprising Tag(w.2.1), DataPayload(*Data.2*), and optionally CDL(cdl.2.1), the computer may translate the PCIe UIORdCplD to a CXL.mem S2M DRS comprising Opcode(MemData), DevLoad(d.4.1), Tag(p.4.1), and Data(*Data.2*) and may send the CXL.mem S2M DRS to the first entity. The optional CDL in the PCIe UIORdCplD, when not reserved, may be populated by the second entity with information such as QoS telemetry. The computer may translate the information carried in the optional CDL of the PCIe UIORdCplD received from the second entity, and populate the translated information in the DevLoad of the CXL.mem S2M DRS sent to the first entity. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

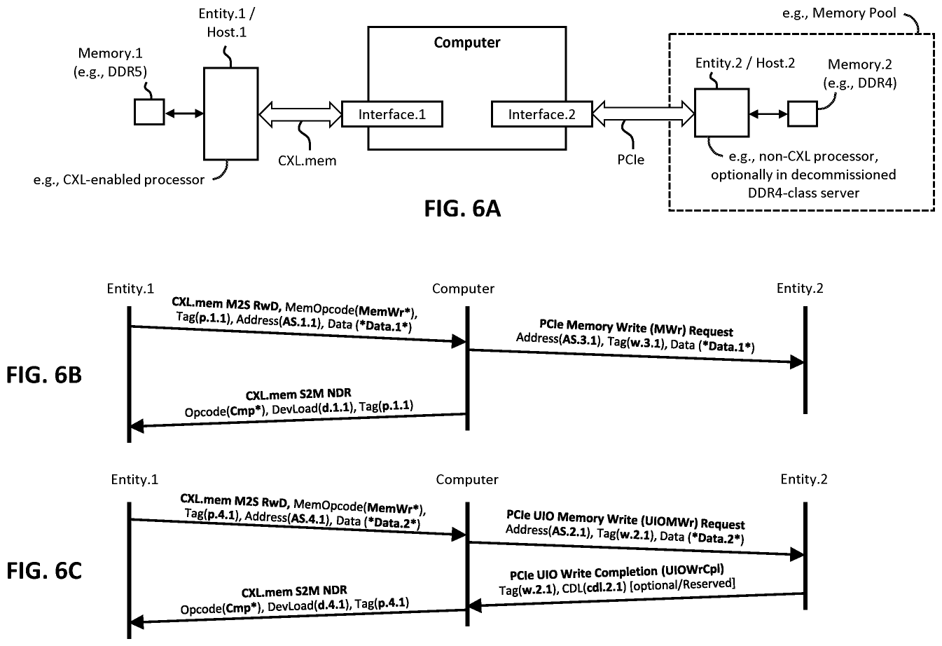

FIG. 6A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). The second interface may expose a PCIe device, and may communicate according to PCIe with a second entity (Entity.2), such as a second host (Host.2). The computer may extract physical addresses carried within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification.

The system may further include a memory pool comprising the second entity and a second memory, such as DDR4, wherein the computer may utilize the memory pool to expose a DDR4 memory tier to the first entity which may be coupled to a first memory, such as DDR5. In some examples, the second entity may not support CXL, or may be configured not to support CXL, potentially preventing the computer from utilizing CXL for accessing the second memory. In some examples, the second entity may include a server, such as a DDR4-class datacenter server, wherein the server may include a non-CXL processor that may not support CXL, such as a pre-CXL generation processor configured to support PCIe but not CXL, and wherein the non-CXL processor may enable the computer to access the second memory by utilizing PCIe.

FIG. 6B illustrates an example of a TFD demonstrating translations, optionally performed by a computer, between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request with data (RwD) comprising MemOpcode(MemWr*), Tag(p.1.1), Address(AS.1.1), and Data (*Data.1*). The computer may translate the CXL.mem M2S RwD transaction to a PCIe transaction, which may include a PCIe Memory Write request (MWr) comprising Address(AS.3.1), Tag(w.3.1), and Data (*Data.1*), and may send the PCIe MWr to the second entity. In some examples, the PCIe MWr may be a posted write that may not be followed by a response or completion from the second entity. The computer may respond to the CXL.mem M2S RwD received from the first entity with a CXL.mem S2M NDR comprising Opcode(Cmp*), DevLoad(d.1.1), and Tag(p.1.1), wherein the computer may send the CXL.mem S2M NDR to the first entity before sending the PCIe MWr to the second entity. Alternatively, the computer may send the CXL.mem S2M NDR to the first entity in parallel to sending the PCIe MWr to the second entity, or the computer may send the CXL.mem S2M NDR to the first entity after sending the PCIe MWr to the second entity. The computer may further populate the DevLoad of the CXL.mem S2M NDR with telemetry information, metadata, or other types of information collected or generated by the computer, or may utilize the DevLoad of the CXL.mem S2M NDR to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

FIG. 6C illustrates an example of a TFD demonstrating translations between CXL.mem requests received from a first entity (Entity.1), such as a first host (Host.1), and PCIe UIO requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe UIO requests sent to the second entity. The first entity may initiate a CXL.mem transaction that may include a CXL.mem M2S request with Data (M2S RwD) comprising MemOpcode(MemWr*), Tag(p.4.1), Address(AS.4.1), and Data (*Data.2*). A computer may translate the CXL.mem M2S RwD transaction to a PCIe transaction, which may include a PCIe UIO Memory Write request (UIOMWr) comprising Address(AS.2.1), Tag(w.2.1), and Data (*Data.2*), and may send the PCIe UIOMWr to the second entity. Upon receiving a response or completion from the second entity, which may include a PCIe UIO Write Completion (UIOWrCpl) comprising Tag(w.2.1) and optionally CDL(cdl.2.1), the computer may translate the PCIe UIOWrCpl to a CXL.mem S2M No Data Response (S2M NDR) comprising Opcode(Cmp*), DevLoad(d.4.1), and Tag(p.4.1), and may send the CXL.mem S2M NDR to the first entity.

The optional CDL in the PCIe UIOWrCpl, when not reserved, may be populated by the second entity with information such as QoS telemetry. The computer may translate the information carried in the optional CDL of the PCIe UIOWrCpl received from the second entity, and populate the translated information in the DevLoad of the CXL.mem S2M NDR sent to the first entity. DevLoad in CXL messages may be optional and may not exist in some revisions of the CXL specification. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. The computer may perform further translations, such as protocol translations, opcode translations, command translations, TLP type translations, or field translations, such as Tag translations, between messages conforming to CXL.mem and TLPs conforming to PCIe.

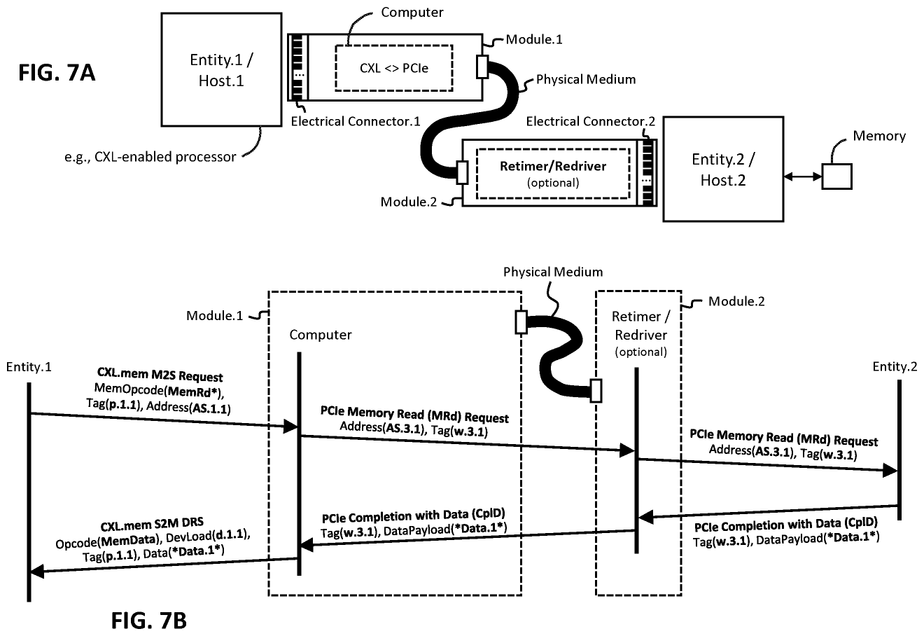

FIG. 7A illustrates an example of a system comprising a cable, such as an active cable, that may include a first module (Module.1), a second module (Module.2), and a physical medium coupling the first module and the second module. The physical medium may include a twinaxial cabling (also known as twinax cable), a multimode fiber (MMF), or a single-mode fiber (SMF). The cable may further include a computer that translates between CXL-based traffic, such as CXL.mem traffic, and a PCIe-based traffic, such as a PCIe or a PCIe-over-Ethernet traffic. The cable may enable a first entity (Entity.1) to access resources coupled to a second entity (Entity.2), such as a second host (Host.2). The first entity (Entity.1), which may be a first host (Host.1), may include a CXL-enabled processor. The access may be via the first module, the physical medium, and the second module. The resources may be memory coupled to the second entity, and the second entity may be a second host that may include a server, such as a DDR4-class datacenter server that may include a non-CXL processor that does not support CXL, such as a pre-CXL generation processor configured to support PCIe.

The cable may communicate with the first entity according to a CXL-based protocol, such as CXL.mem, and may communicate with the second entity according to a PCIe-based protocol. In some examples, messages conforming to the CXL-based protocol, such as CXL.mem, may be associated with a first address space, such as a first Host Physical Address (HPA) space; and messages conforming to the PCIe-based protocol may be associated with a second address space, such as a PCIe Memory Address Space, a DMA address space, an IO virtual address (IOVA) space, a system address space, or a second HPA space; wherein the cable may perform address translations between addresses within the first and second address spaces, respectively, such as between addresses within the first HPA space and addresses within the second HPA space. In other examples, messages conforming to the CXL-based protocol and messages conforming to the PCIe-based protocol may be associated with the same address space, wherein the cable may perform address translations between addresses within the same address space. Additionally, or alternatively, the system may perform further address translations, such as by an I/O Memory Management Unit (IOMMU), a System Memory Management Unit (SMMU), or a DMA address translation. The cable may perform further translations, such as protocol translations, opcode translations, command translations, TLP translations, or field translations between the CXL-based domain and the PCIe-based domain, such as translations of Tags and translations of error indications (e.g. data corruption indications such as poison).

The cable may further include a redriver or a retimer, such as a PCIe retimer, a CXL retimer, a dual-protocol CXL/PCIe retimer, a PAM4 retimer, or a retimer PHY. The cable, such as an OSFP copper cable, an OSFP-XD copper cable, an OSFP Active Optical Cable (AOC), or an OSFP-XD AOC cable, may conform to a standard specification, an industry standard, an implementation agreement (IA), or a multi-source agreement (MSA), such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard (such as SFF-8665), an Optical Internetworking Forum (OIF) implementation agreement, or an Institute of Electrical and Electronics Engineers (IEEE) standard. In some examples, the cable may be coupled to the first entity via a first electrical connector (Connector.1) and may be further coupled to the second entity via a second electrical connector (Connector.2), whereas in other examples, the cable may be coupled to the first entity and/or to the second entity via optical connectors.

FIG. 7B illustrates an example of a TFD demonstrating translations performed by a cable, such as an active cable comprising a computer and optionally a retimer or a redriver. The cable may include a first module (Module.1), a second module (Module.2), and a physical medium coupling the first module and the second module. The translations may be between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that may include a CXL.mem M2S request comprising MemOpcode(MemRd*), Tag(p.1.1), and Address(AS.1.1). The computer included in the cable may translate the CXL.mem transaction to a PCIe transaction, which may include a PCIe Memory Read (MRd) request comprising Address(AS.3.1) and Tag(w.3.1). The computer may send the PCIe MRd to the second entity, optionally via the second module that may include a retimer or a redriver. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*). The computer may send the CXL.mem S2M DRS to the first entity. The computer may populate DevLoad of CXL.mem S2M messages with telemetry information, metadata, or other types of information collected or generated by the cable, or may utilize the DevLoad of CXL.mem S2M messages to throttle CXL.mem requests from the first entity, enabling the cable to control, limit, shape, or throttle the rate of data communications between the first entity and the second entity. The computer may perform further translations, such as protocol translations, opcode translations, command translations, TLP type translations, or field translations, such as Tag translations, between messages conforming to CXL.mem and TLPs conforming to PCIe.

In environments comprising hosts and devices that may utilize different CXL domains, while requiring coordinated access to shared resources, there may be scenarios where a first entity that communicates utilizing CXL.mem needs to access resources associated with a second entity that communicates utilizing CXL.io, wherein the first and second entities may operate with different address spaces. Translations between CXL.mem messages and CXL.io messages may facilitate memory reads, memory writes, and data transfers across different domains while enabling interoperability between entities that cannot communicate directly due to protocol limitations or semantic mismatches. Additionally, CXL.io UIO may provide enhanced capabilities for peer-to-peer communication and fabric-based topologies. UIO transactions may include CDLs that carry QoS telemetry, metadata, or other information that may be translated to DevLoad fields in CXL.mem messages, thereby enabling end-to-end propagation of telemetry information across domain boundaries.

In various implementations, a method for translating between Compute Express Link (CXL) messages, comprising: receiving, from a first entity via a first interface, a CXL.mem Master-to-Subordinate (M2S) request comprising a first opcode, a first Tag, and a first address; translating the CXL.mem M2S request to a CXL.io request comprising a second Tag and a second address; sending, via a second interface, the CXL.io request to a second entity; receiving, from the second entity via the second interface, a CXL.io completion comprising the second Tag and a data payload; translating the CXL.io completion to a CXL.mem Subordinate-to-Master Data Response (S2M DRS) comprising a second opcode, the first Tag, and the data payload; and sending, via the first interface, the CXL.mem S2M DRS to the first entity. The translation process may encompass various aspects of the protocol messages, including opcodes, addresses, Tags, and additional fields, thereby enabling communication between entities that operate according to different CXL protocols. The method may be implemented in hardware, firmware, software, or combinations thereof, and may be performed by various types of devices, such as semiconductor devices, switches, bridges, RPUs, Fabric Processing Units (FPUs), Fabric NICs, or other suitable intermediary components. The first interface may expose the computer, which operates as the translating device, as a CXL Type-2 or Type-3 device to the first entity, while the second interface may expose the computer as a CXL device or CXL host to the second entity, depending on system configuration. The elements may communicate through one or more intermediary components, such as a switch, a retimer, or other suitable entity that facilitates information transfer. The Tag translations may involve maintaining a bidirectional mapping between the CXL.mem-side and CXL.io-side transaction identifiers, wherein such mapping may be stored in a translation table, a tracker entry, or similar data structure to enable proper translations of responses with their corresponding requests. The first and second addresses may indicate the same address or indicate different addresses.

In some implementations of the method, the CXL.io request comprises a CXL.io Unordered Input/Output (UIO) Memory Read (UIOMRd) request, the CXL.io completion comprises a CXL.io Unordered Input/Output (UIO) Read Completion with Data (UIORdCplD) comprising a CXL DevLoad (CDL), and the CXL.mem S2M DRS comprises a DevLoad. CXL.io UIO may enable fabric-based topologies with multiple paths between source and destination. UIO may be utilized when the entire path from requester to completer uses Flit Mode, supports UIO, and has UIO enabled. The UIOMRd request type may be selected when the second entity supports UIO capabilities, or when the system topology benefits from the ordering flexibility provided by UIO semantics. The CDL in the UIORdCplD completion may carry information populated by the second entity or by intermediate components along the data path, and this information may be propagated to the first entity via the DevLoad in the CXL.mem S2M DRS message.

In some implementations of the method, translating the CXL.io completion to the CXL.mem S2M DRS comprises translating information carried in the CDL to the DevLoad. The translation of information from the CDL to the DevLoad may involve direct copying, format conversion, or semantic translation depending on the encoding schemes utilized by the CXL.io and CXL.mem. The CDL may utilize a multi-bit encoding that represents various categories of information, and the DevLoad may utilize a corresponding or different encoding scheme. The translation logic may apply mapping functions, lookup tables, or algorithmic transformations to convert between these encodings while preserving the meaning of the carried information.

In some implementations of the method, the information carried in the CDL comprises information selected from at least one of: Quality-of-Service (QoS) telemetry, metadata, or throttling information. The QoS telemetry information may include bandwidth utilization metrics, latency measurements, congestion indicators, or other performance-related data that may assist the first entity in making scheduling or resource allocation decisions. The metadata may include information about the data payload, the second entity, the traversed path, or other contextual information that may be useful for system management or optimization. The throttling information may indicate back-pressure conditions, credit availability, or flow control state that may cause the first entity to modulate its request rate. Additionally or alternatively, the computer may populate the DevLoad with telemetry information, metadata, or throttling information collected or generated by the computer itself, independent of the CDL content received from the second entity.

In some implementations of the method, the first address is associated with a first physical address space utilized by the first entity, the second address is associated with a second physical address space utilized by the second entity, and wherein the method further comprises translating the first address to the second address. The address translation may be implemented utilizing lookup tables, page tables, hash tables, base-and-offset calculations, range-based mapping, and/or programmable translation functions. The first and second address spaces may have different sizes, different base addresses, different memory layouts, or different granularities, and the translation may accommodate these differences while maintaining the meaning of the memory operations.

In some implementations of the method, the first entity comprises a first CXL host, the second entity comprises a second CXL host or a CXL device, the first opcode comprises MemRd*, the CXL.io request comprises a CXL.io Memory Read (MRd) request, and the CXL.io completion comprises a CXL.io Completion with Data (CplD). The standard CXL.io MRd and CplD transaction types may be utilized when the second entity does not support UIO, when UIO is not enabled along the path, or when standard CXL.io is preferred. The CplD completion may not include a CDL, and accordingly the computer may populate the DevLoad in the CXL.mem S2M DRS with locally generated information, or may set the DevLoad to a default or null value.

In some implementations, the method further comprises receiving, from the first entity via the first interface, a CXL.mem M2S request with data (RwD) comprising a third opcode, a third Tag, a third address, and write data; translating the CXL.mem M2S RwD to a CXL.io Memory Write request (MWr) comprising a fourth address and the write data; sending, via the second interface, the CXL.io MWr to the second entity; and sending, via the first interface to the first entity, a CXL.mem S2M No Data Response (NDR) comprising a completion opcode and the third Tag. The CXL.io MWr may be a posted write transaction that does not require a completion from the second entity, per the PCIe and CXL.io specifications. The computer may generate the CXL.mem S2M NDR completion locally without waiting for acknowledgment from the second entity, thereby potentially reducing write latency as observed by the first entity. The fourth address in the CXL.io MWr may be derived from the third address through address translation. The write data may be transferred from the CXL.mem domain to the CXL.io domain with optional format conversion, alignment adjustment, or byte enable manipulation as required by the respective protocol specifications.

In some implementations of the method, the third opcode comprises a MemWr*, the completion opcode comprises Cmp*, and sending the CXL.mem S2M NDR to the first entity occurs before sending the CXL.io MWr to the second entity. Sending the CXL.mem S2M NDR before sending the CXL.io MWr may enable the first entity to receive early acknowledgment of the write operation, potentially allowing the first entity to proceed with subsequent operations without waiting for the write data to reach the second entity. It may be beneficial in scenarios where write latency as observed by the first entity is more significant than end-to-end write completion guarantees. The computer may buffer the write data internally and may implement mechanisms to handle scenarios where the CXL.io MWr encounters errors or back-pressure from the second entity after the S2M NDR has already been sent to the first entity.

In some implementations of the method, the third opcode comprises a MemWr*, the completion opcode comprises Cmp*, and sending the CXL.mem S2M NDR to the first entity occurs in parallel with or after sending the CXL.io MWr to the second entity. Sending the CXL.mem S2M NDR in parallel with or after sending the CXL.io MWr may provide different trade-offs between latency, buffering, and ordering guarantees. When sent in parallel, the first entity may receive acknowledgment with minimal additional delay beyond the transmission time of the MWr. When sent after the MWr, the computer may wait until the write data has been accepted by the downstream interface or by the second entity before acknowledging to the first entity, potentially providing stronger ordering guarantees at the cost of increased latency and possibly added buffering for storing the context required for generating the CXL.mem S2M NDR. The selection between these timing options may be configurable through device registers, may be determined dynamically based on system conditions, or may be fixed by implementation.

In some implementations, the method further comprises receiving, from the first entity via the first interface, a CXL.mem M2S request with data (RwD) comprising a third opcode, a third Tag, a third address, and write data; translating the CXL.mem M2S RwD to a CXL.io Unordered Input/Output (UIO) Memory Write request (UIOMWr) comprising a fourth Tag, a fourth address, and the write data; sending, via the second interface, the CXL.io UIOMWr to the second entity; receiving, from the second entity via the second interface, a CXL.io Unordered Input/Output (UIO) Write Completion (UIOWrCpl) comprising the fourth Tag; and sending, via the first interface to the first entity, a CXL.mem S2M No Data Response (NDR) comprising a completion opcode and the third Tag. The UIOMWr may be a non-posted write transaction that receives a UIOWrCpl from the second entity, in contrast to standard CXL.io MWr transactions which are posted and do not receive completions. The non-posted nature of UIOMWr may provide end-to-end acknowledgment that the write data has been received by the second entity, which may be beneficial for maintaining ordering guarantees or for implementing synchronization mechanisms. The fourth Tag in the UIOMWr may be generated by the computer to track the outstanding write transaction, and may be different from the third Tag used in the CXL.mem domain.

In some implementations of the method, the CXL.io UIOWrCpl further comprises a CXL DevLoad (CDL), and the CXL.mem S2M NDR further comprises a DevLoad populated based on information carried in the CDL. The CDL in the UIOWrCpl may carry information populated by the second entity to indicate write completion status, QoS telemetry, or other metadata associated with the completed write operation. The computer may translate this information to the DevLoad in the CXL.mem S2M NDR, thereby propagating completion-related information back to the first entity. This end-to-end propagation of telemetry information may enable the first entity to make informed decisions about subsequent write operations, resource allocation, or flow control based on conditions observed at the second entity.

In some implementations, the method further comprises receiving, from a third entity via a third interface, a CXL.io request comprising a third Tag and a third address; translating the CXL.io request to a CXL.mem M2S request comprising a third opcode, a fourth Tag, and a fourth address; sending, via a fourth interface, the CXL.mem M2S request to a fourth entity; receiving, from the fourth entity via the fourth interface, a CXL.mem S2M DRS comprising the fourth Tag and a second data payload; translating the CXL.mem S2M DRS to a CXL.io completion comprising the third Tag and the second data payload; and sending, via the third interface, the CXL.io completion to the third entity. The bidirectional translation capability may enable the computer to serve as a multi-port bridge between CXL.mem and CXL.io domains, supporting transactions initiated from either protocol domain. In some examples, the third and fourth entities may be the same as or different from the first and second entities, depending on system topology and configuration. In some examples, the first interface may communicate with CXL.mem-capable entities, and the second interface may communicate with CXL.io-capable entities, wherein the computer may handle translations in both directions. The bidirectional capability may be particularly beneficial in fabric-attached memory architectures where devices and hosts with different protocol capabilities require mutual access to shared resources.

In computing systems utilizing CXL protocols, a computer may translate between CXL.mem and CXL.io to enable interoperability, such as between entities that communicate according to different CXL protocols, or between entities that may not be able to communicate according to CXL.mem due to protocol limitations (e.g., communication between two hosts). The computer may include translation logic, tracker entries, and interface circuitry configured to perform protocol translations while maintaining transaction integrity and proper Tag correlation. The computer may be implemented as a standalone device, as part of a switch, as part of a bridge, or as a component within a larger system-on-chip.

In various implementations, a system comprising: a computer coupled to a first interface and a second interface; wherein the first interface is configured to communicate with a first entity according to CXL.mem; wherein the second interface is configured to communicate with a second entity according to CXL.io; and wherein the computer is configured to: receive, via the first interface, a CXL.mem Master-to-Subordinate (M2S) request comprising a first opcode, a first Tag, and a first address; translate the CXL.mem M2S request to a CXL.io request comprising a second Tag and a second address; send, via the second interface, the CXL.io request to the second entity; receive, via the second interface, a CXL.io completion comprising the second Tag and a data payload; translate the CXL.io completion to a CXL.mem Subordinate-to-Master Data Response (S2M DRS) comprising a second opcode, the first Tag, and the data payload; and send, via the first interface, the CXL.mem S2M DRS to the first entity. The system may enable a first entity that utilizes CXL.mem for memory access to communicate with a second entity that utilizes CXL.io. The computer may function as a bridge, a switch component, an RPU, an FPU, or a dedicated translation unit that maintains the applicable state to translate incoming CXL.mem requests to outgoing CXL.io requests, and to translate returning CXL.io completions to the appropriate CXL.mem responses. The first interface may expose the computer as a CXL Type-2 or Type-3 device to the first entity, enabling the first entity to direct CXL.mem transactions to the computer. The second interface may expose the computer as a CXL device or CXL host to the second entity, depending on system requirements. Both interfaces may operate over CXL links, UCIe links, or other suitable interconnects that support the respective protocols.

In some implementations of the system, the CXL.io request comprises a CXL.io Unordered Input/Output (UIO) Memory Read (UIOMRd) request, the CXL.io completion comprises a CXL.io Unordered Input/Output (UIO) Read Completion with Data (UIORdCplD) comprising a CXL DevLoad (CDL), the CXL.mem S2M DRS comprises a DevLoad, and the computer is further configured to translate information carried in the CDL to the DevLoad. The CDL-to-DevLoad translation may propagate QoS telemetry, metadata, or throttling information from the CXL.io domain to the CXL.mem domain.

In some implementations of the system, the computer comprises tracker entries, each configured to store state information for a pending transaction including a mapping between the first Tag from the CXL.mem M2S request and the second Tag for the CXL.io request; and wherein the first interface exposes the computer as a CXL Type-2 device or a CXL Type-3 device to the first entity. The tracker entries may enable the computer to correlate incoming CXL.io completions with their corresponding CXL.mem M2S requests, enabling correct restoration of Tags when translating completions back to the CXL.mem domain. The tracker entries may support concurrent transactions, with each entry tracking a separate pending operation. Each tracker entry may additionally store address information, transaction type, expected completion size, and other state information utilized for proper translation and error handling. Moreover, exposing the computer as a CXL Type-2 or Type-3 device may enable the first entity to direct CXL.mem transactions to the computer utilizing standard device enumeration and addressing mechanisms. A CXL Type-2 device exposure may be utilized when the computer also supports CXL.cache transactions, while a CXL Type-3 device exposure may be utilized when the computer functions primarily as a memory expander or a memory pool from the perspective of the first entity.

In some implementations of the system, the computer is further configured to: receive, via the first interface, a CXL.mem M2S request with data (RwD) comprising a third opcode, a third Tag, a third address, and write data; translate the CXL.mem M2S RwD to a CXL.io Unordered Input/Output (UIO) Memory Write request (UIOMWr) comprising a fourth Tag, a fourth address, and the write data; send, via the second interface, the CXL.io UIOMWr to the second entity; receive, via the second interface, a CXL.io Unordered Input/Output (UIO) Write Completion (UIOWrCpl) comprising the fourth Tag and a CXL DevLoad (CDL); translate the CXL.io UIOWrCpl to a CXL.mem S2M No Data Response (NDR) comprising a completion opcode, the third Tag, and a DevLoad populated based on information carried in the CDL; and send, via the first interface, the CXL.mem S2M NDR to the first entity. The UIO write path may provide end-to-end acknowledgment and telemetry propagation for write transactions.

In heterogeneous computing systems, devices such as GPUs, NICs, DMA engines, and accelerators may initiate memory transactions based on CXL.io to access memory resources managed by other devices such as memory expanders, memory pools, or Global Fabric-Attached Memory Devices (GFDs) that communicate based on CXL.mem. Translations between CXL.io requests and CXL.mem requests may enable such device-to-device communication while accommodating differences in transaction granularity, ordering, and protocol capabilities. The translation from CXL.io to CXL.mem may involve splitting larger CXL.io transactions into cacheline-sized CXL.mem transactions, aggregating data from CXL.mem responses into CXL.io completions, or trimming data payloads to match requested lengths. Additionally, the computer may initiate speculative memory reads to data that the first entity is likely to request, thereby potentially reducing read latency and improving overall system throughput.

In various implementations, a method for translating between Compute Express Link (CXL) messages, comprising: receiving, from a first entity via a first interface, a CXL.io request comprising a first Tag and a first address; translating the CXL.io request to a CXL.mem Master-to-Subordinate (M2S) request comprising a second Tag and a second address; sending, via a second interface, the CXL.mem M2S request to a second entity; receiving, from the second entity via the second interface, a CXL.mem Subordinate-to-Master Data Response (S2M DRS) comprising the second Tag and data; translating the CXL.mem S2M DRS to a CXL.io completion comprising the first Tag and the data; and sending, via the first interface, the CXL.io completion to the first entity. The translation process may enable entities that utilize CXL.io for memory access to communicate with entities that expose memory resources utilizing CXL.mem. The computer may function as a bridge, a switch component, or a dedicated translation unit that maintains the applicable state to translate incoming CXL.io requests to outgoing CXL.mem requests, and to translate returning CXL.mem responses to the appropriate CXL.io completions. The first interface may communicate with the first entity based on CXL.io, while the second interface may communicate with the second entity based on CXL.mem, wherein both interfaces may operate over CXL links, UCIe links, or other suitable interconnects. The method may be implemented in hardware, firmware, software, or combinations thereof, and may be performed by various types of devices comprising a computer, such as CXL switches, bridges, or semiconductor devices incorporating translation logic. The Tag translations may involve maintaining a mapping between CXL.io Tags utilized by the first entity and CXL.mem Tags utilized for communication with the second entity.

In some implementations of the method, the CXL.io request comprises a CXL.io Unordered Input/Output (UIO) Memory Read (UIOMRd) request, and the CXL.io completion comprises a CXL.io Unordered Input/Output (UIO) Read Completion with Data (UIORdCplD). The UIO transaction types may be utilized when the first entity supports UIO capabilities and when the path between the first entity and the computer has UIO enabled. The UIOMRd request type may provide ordering flexibility that enables more efficient utilization of fabric bandwidth in topologies with multiple paths between source and destination. The UIORdCplD completion may include a CDL that the computer may populate with information collected from the CXL.mem domain, from the computer itself, or from intermediate components.

In some implementations, the method further comprises sending to the second entity, via the second interface, a CXL.mem M2S request comprising MemSpecRd. The speculative memory read may be initiated by the computer to facilitate the readiness of data from the second entity before, or without, the first entity explicitly requesting that data. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. MemSpecRd may indicate to the second entity that the request is speculative in nature, which may affect caching behavior, priority handling, and/or error reporting at the second entity. Additionally or alternatively, the computer may issue prefetch read targeting the second entity. Data returned in response to prefetch reads may be buffered by the computer and may be utilized to satisfy subsequent requests from the first entity, potentially reducing observed read latency.

In some implementations of the method, the first address is associated with a first physical address space utilized by the first entity, the second address is associated with a second physical address space utilized by the second entity, and wherein the method further comprises translating the first address to the second address. The address translation may accommodate scenarios where the first entity and the second entity utilize different physical address spaces. The translation may be implemented utilizing lookup tables, page tables, base-and-offset calculations, or programmable translation functions.

In some implementations of the method, the first entity comprises at least one of a GPU, a Network Interface Card (NIC), or a DMA engine; wherein the second entity comprises at least one of a CXL memory expander, a CXL memory pool, or a Global Fabric-Attached Memory Device (GFD); wherein the CXL.io request comprises a CXL.io Memory Read (MRd) request; and wherein the CXL.io completion comprises a CXL.io Completion with Data (CplD). GPUs may utilize CXL.io memory reads to access large memory pools for workloads such as graphics rendering, machine learning inference, or general-purpose GPU computing workloads. NICs may utilize CXL.io memory reads to access memory buffers for network packet processing, RDMA, or storage traffic handling. DMA engines may utilize CXL.io memory reads to transfer data between memory regions on behalf of other system components. The second entity may expose memory resources that are implemented using various memory technologies such as DDR5, DDR4, HBM, persistent memory, or combinations thereof. A GFD may provide fabric-attached memory resources that are accessible by multiple devices in the system.

In some implementations of the method, translating the CXL.io request to the CXL.mem M2S request comprises translating the CXL.io request to CXL.mem M2S requests, and wherein the method further comprises aggregating data from CXL.mem S2M DRS responses into the CXL.io completion. CXL.io transactions may request data payloads larger than the cacheline size supported by CXL.mem transactions. For example, a CXL.io request for a 256-byte data payload may be translated to four CXL.mem requests each carrying a 64-byte cacheline-sized payload. The computer may track the outstanding CXL.mem requests and may aggregate the returned data into a CXL.io completion, or into CXL.io completions as permitted by CXL.io. The aggregation may involve buffering data from multiple responses, ordering the data according to address sequence, and formatting the aggregated data according to CXL.io completion requirements.

In some implementations, the method further comprises receiving, from a third entity via a third interface, a CXL.mem M2S request comprising a first opcode, a third Tag, and a third address; translating the CXL.mem M2S request to a CXL.io request comprising a fourth Tag and a fourth address; sending, via a fourth interface, the CXL.io request to a fourth entity; receiving, from the fourth entity via the fourth interface, a CXL.io completion comprising the fourth Tag and a data payload; translating the CXL.io completion to a CXL.mem S2M DRS comprising a second opcode, the third Tag, and the data payload; and sending, via the third interface, the CXL.mem S2M DRS to the third entity. The bidirectional translation capability may enable the computer to serve as a multi-port bridge between CXL.io and CXL.mem domains, supporting transactions initiated from either protocol domain. In some examples, the third and fourth entities may be the same as or different from the first and second entities, depending on system topology and configuration. In some examples, the first interface may communicate with CXL.io-capable entities, and the second interface may communicate with CXL.mem-capable entities, wherein the computer may handle translations in both directions. The bidirectional capability may be particularly beneficial in fabric-attached memory architectures where devices and hosts with different protocol capabilities require mutual access to shared resources.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In computing systems utilizing CXL protocols, a computer may translate between CXL.io and CXL.mem to enable interoperability between entities that communicate according to different CXL protocols. The computer may include translation logic, tracker entries, aggregation logic, and interface circuitry configured to perform protocol translations while maintaining transaction integrity and proper Tag correlation. The computer may be implemented as a standalone device, as part of a switch, as part of a bridge, or as a component within a larger system-on-chip.

In various implementations, a system comprising: a computer coupled to a first interface and a second interface; wherein the first interface is configured to communicate with a first entity according to CXL.io; wherein the second interface is configured to communicate with a second entity according to CXL.mem; and wherein the computer is configured to: receive, via the first interface, a CXL.io request comprising a first Tag and a first address; translate the CXL.io request to a CXL.mem Master-to-Subordinate (M2S) request comprising a second Tag and a second address; send, via the second interface, the CXL.mem M2S request to the second entity; receive, via the second interface, a CXL.mem Subordinate-to-Master Data Response (S2M DRS) comprising the second Tag and data; translate the CXL.mem S2M DRS to a CXL.io completion comprising the first Tag and the data; and send, via the first interface, the CXL.io completion to the first entity. The system may enable a first entity that utilizes CXL.io for memory access to communicate with a second entity that exposes memory resources utilizing CXL.mem. The computer may function as a bridge, a switch component, an RPU, an FPU, or a dedicated translation unit that maintains the applicable state to translate incoming CXL.io requests to outgoing CXL.mem requests, and to translate returning CXL.mem responses to the appropriate CXL.io completions. The first interface may communicate with the first entity based on CXL.io, supporting standard MRd/CplD transactions or UIO transactions such as UIOMRd/UIORdCplD. The second interface may communicate with the second entity based on CXL.mem, supporting M2S requests and S2M DRS messages. Both interfaces may operate over CXL links, UCIe links, or other suitable interconnects that support the respective protocols. The computer may be included in a switch, a bridge, or a standalone translation device.

In some implementations of the system, the CXL.io request comprises a CXL.io Unordered Input/Output (UIO) Memory Read (UIOMRd) request, the CXL.io completion comprises a CXL.io Unordered Input/Output (UIO) Read Completion with Data (UIORdCplD) comprising a CXL DevLoad (CDL), the CXL.mem S2M DRS comprises a DevLoad, and the computer is further configured to translate information carried in the DevLoad to the CDL. The DevLoad-to-CDL translation may propagate QoS telemetry, metadata, or throttling information from the CXL.mem domain to the CXL.io domain.

In some implementations of the system, the second entity is coupled to a first memory comprising a first DDR version, wherein the first entity is coupled to a second memory comprising a second DDR version different from the first DDR version, and wherein the computer is configured to translate addresses between a first address space associated with the first entity and a second address space associated with the second entity. The system may enable memory tiering across different DDR generations, wherein a host coupled to a higher-performance memory tier may access a lower-performance memory tier through the translation provided by the computer. The address translation may map addresses within the first entity's address space to corresponding addresses within the second entity's address space, enabling transparent access to the tiered memory resources. The memory tiering may be utilized for capacity expansion, cost optimization, Total Cost of Ownership (TCO) reduction, or workload-specific memory allocation strategies. The computer may expose the second entity's memory resources as an additional memory tier accessible by the first entity, potentially extending the total addressable memory capacity available to the first entity without requiring direct support for the second DDR version.

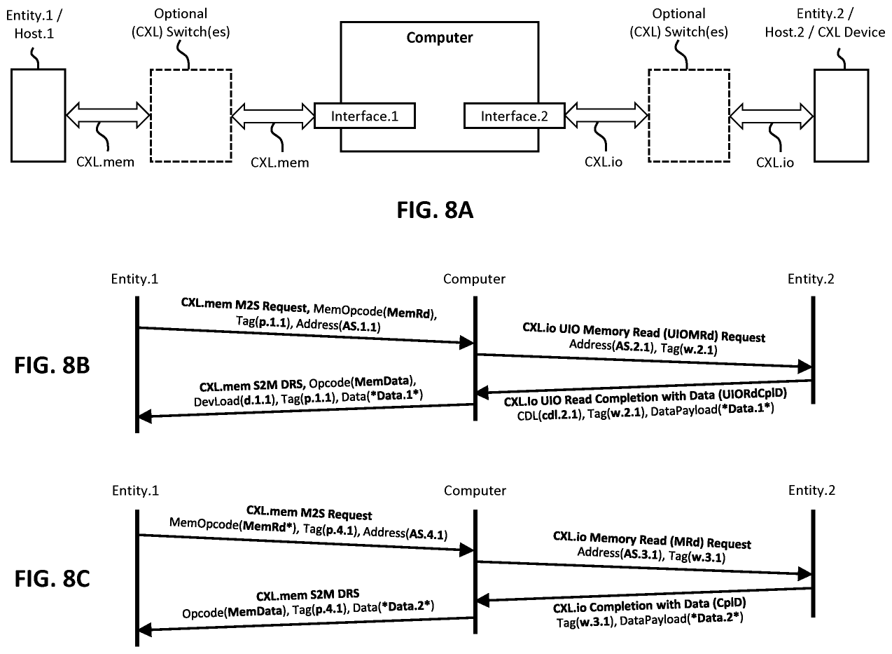

FIG. 8A illustrates an example of a system comprising a computer coupled between first and second interfaces. The first interface (Interface.1) may expose a CXL device, such as a CXL type-2 device or a CXL type-3 device, and communicate according to CXL.mem with a first entity (Entity.1), such as a first host (Host.1). The second interface may expose a CXL device, such as a CXL type-1/2/3 device, and communicate according to CXL.io with a second entity (Entity.2), such as a second host (Host.2). Alternatively, the second interface may expose a CXL host, and may further communicate according to CXL.io with a CXL device. The computer may extract physical addresses within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and/or between the second interface and the second entity.

FIG. 8B illustrates an example of a TFD demonstrating translations, optionally performed by a computer, between CXL.mem requests received from a first entity (Entity.1), such as a first host (Host.1), and CXL.io requests sent to a second entity (Entity.2), such as a second host (Host.2) or a CXL device, possibly enabling the first entity to access resources mapped to an address space utilized by the second entity. The translations may further include address translations between physical addresses carried in the CXL.mem requests received from the first entity and physical addresses carried in the CXL.io requests sent to the second entity. The first entity may initiate a CXL.mem transaction, which may include a CXL.mem M2S request comprising MemOpcode(MemRd), Tag(p.1.1), and Address(AS.1.1). The computer may translate the CXL.mem transaction to a CXL.io transaction, which may include a CXL.io Unordered Input/Output Memory Read (UIOMRd) request comprising Address(AS.2.1) and Tag(w.2.1), and may send the CXL.io UIOMRd to the second entity. Upon receiving a response or completion from the second entity, which may include a CXL.io UIO Read Completion with Data (UIORdCplD) comprising CDL(cdl.2.1), Tag(w.2.1), and DataPayload(*Data.1*), the computer may translate the CXL.io UIORdCplD to a CXL.mem S2M DRS comprising Opcode(MemData), DevLoad(d.1.1), Tag(p.1.1), and Data(*Data.1*) and may send the CXL.mem S2M DRS to the first entity. The CDL in the CXL.io UIORdCplD may be populated, by the second entity, with information related to QoS, such as QoS telemetry value or values. The computer may translate the information carried in the CDL of the UIORdCplD completion received from the second entity, and populate the translated information in the DevLoad of the CXL.mem S2M DRS message sent to the first entity. Additionally or alternatively, the computer may populate DevLoad of CXL.mem S2M messages with telemetry information, metadata, or other types of information collected by the computer, or may utilize the DevLoad of CXL.mem S2M messages to throttle CXL.mem requests from the first entity. The computer may perform further translations, such as protocol translations, opcode translations, command translations, TLP type translations, or field translations, such as Tag translations, between messages conforming to CXL.mem and TLPs conforming to CXL.io.

FIG. 8C illustrates an example of a TFD demonstrating translations between CXL.mem requests received from a first entity (Entity.1), such as a first host (Host.1), and CXL.io requests sent to a second entity (Entity.2), such as a second host (Host.2) or a CXL device. The translations may enable the first entity to access resources mapped to an address space utilized by the second entity. The translations may further include address translations between physical addresses carried in the CXL.mem requests received from the first entity and physical addresses carried in the CXL.io requests sent to the second entity. The first entity may initiate a CXL.mem transaction that includes a CXL.mem M2S request comprising MemOpcode(MemRd*), Tag(p.4.1), and Address(AS.4.1). The computer may translate the CXL.mem transaction to a CXL.io transaction, which may include a CXL.io Memory Read (MRd) request comprising Address(AS.3.1) and Tag(w.3.1), and may send the CXL.io MRd to the second entity. Upon receiving a response or completion from the second entity, which may include a CXL.io Completion with Data (CplD) comprising Tag(w.3.1) and DataPayload(*Data.2*), the computer may translate the CXL.io CplD to a CXL.mem S2M DRS comprising Opcode(MemData), Tag(p.4.1), and Data(*Data.2*), and may send the CXL.mem S2M DRS to the first entity. The computer may perform further translations, such as protocol translations, opcode translations, command translations, TLP type translations, or field translations, such as Tag translations, between messages conforming to CXL.mem and TLPs conforming to CXL.io.

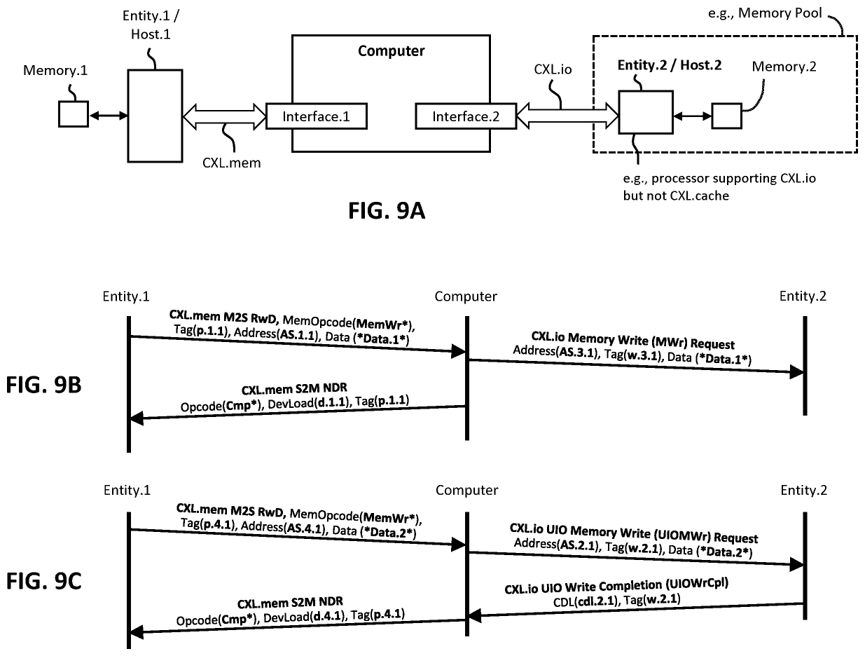

FIG. 9A illustrates an example of a system comprising a computer coupled between a first interface (Interface.1) and a second interface (Interface.2). The first interface may expose a CXL device, such as a CXL type-2 device or a CXL type-3 device, and may further communicate according to CXL.mem with a first entity (Entity.1), such as a first host (Host.1). The second interface may expose a CXL device, and may further communicate according to CXL.io with a second entity (Entity.2), such as a second host (Host.2). The computer may extract physical addresses carried within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification.

The system may further include a memory pool comprising the second entity and a second memory, wherein the computer may utilize the memory pool to expose the second memory to the first entity which may be coupled to a first memory. In some examples, the second entity may not support CXL.cache, or may be configured not to support CXL.cache, potentially preventing the computer from utilizing CXL.cache for accessing the second memory. In some examples, the second entity may include a CXL-enabled processor that does not support CXL.cache, such as an early-generation processor configured to support a subset of CXL protocols such as CXL.io and CXL.mem, but not CXL.cache, wherein the CXL-enabled processor may enable the computer to access the second memory by utilizing CXL.io.

FIG. 9B illustrates an example of a TFD demonstrating translations between CXL.mem requests received from a first entity (Entity.1), such as a first host (Host.1), and CXL.io requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the CXL.io requests sent to the second entity. The first entity may initiate a CXL.mem transaction, which may include a CXL.mem M2S request with data (RwD) comprising MemOpcode(MemWr*), Tag(p.1.1), Address(AS.1.1), and Data (*Data.1*). The computer may translate the CXL.mem M2S RwD transaction to a CXL.io transaction, which may include a CXL.io Memory Write request (MWr) comprising Address(AS.3.1), Tag(w.3.1), and Data (*Data.1*), and may send the CXL.io MWr to the second entity. In some examples, the CXL.io MWr may be a posted write that may not be followed by a response or completion from the second entity.

The computer may respond to the CXL.mem M2S RwD received from the first entity with a CXL.mem S2M NDR comprising Opcode(Cmp*), DevLoad(d.1.1), and Tag(p.1.1), wherein the computer may send the CXL.mem S2M NDR to the first entity before sending the CXL.io MWr to the second entity. Alternatively, the computer may send the CXL.mem S2M NDR to the first entity in parallel to sending the CXL.io MWr to the second entity, or the computer may send the CXL.mem S2M NDR to the first entity after sending the CXL.io MWr to the second entity. The computer may further populate the DevLoad of the CXL.mem S2M NDR with telemetry information, metadata, or other types of information collected or generated by the computer, or may utilize the DevLoad of the CXL.mem S2M NDR to throttle CXL.mem requests from the first entity. The computer may perform further translations, such as protocol translations, opcode translations, command translations, TLP type translations, or field translations, such as Tag translations, between messages conforming to CXL.mem and TLPs conforming to CXL.io.

FIG. 9C illustrates an example of a TFD demonstrating translations between CXL.mem requests received from a first entity (Entity.1), such as a first host (Host.1), and CXL.io UIO requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the CXL.io UIO requests sent to the second entity. The first entity may initiate a CXL.mem transaction that may include a CXL.mem M2S request with Data (M2S RwD) comprising MemOpcode(MemWr*), Tag(p.4.1), Address(AS.4.1), and Data (*Data.2*). The computer may translate the CXL.mem M2S RwD transaction to a CXL.io transaction, which may include a CXL.io UIO Memory Write request (UIOMWr) comprising Address(AS.2.1), Tag(w.2.1), and Data (*Data.2*). The computer may send the CXL.io UIO UIOMWr to the second entity. Upon receiving a response or completion from the second entity, which may include a CXL.io UIO Write Completion (UIOWrCpl) comprising CDL(cdl.2.1) and Tag(w.2.1), the computer may translate the CXL.io UIO UIOWrCpl to a CXL.mem S2M No Data Response (S2M NDR) comprising Opcode(Cmp*), DevLoad(d.4.1), and Tag(p.4.1), and may send the CXL.mem S2M NDR to the first entity.

The CDL in the CXL.io UIO UIOWrCpl may be populated by the second entity with information such as QoS telemetry. The computer may translate the information carried in the CDL of the CXL.io UIOWrCpl received from the second entity, and populate the translated information in the DevLoad of the CXL.mem S2M NDR sent to the first entity. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity.

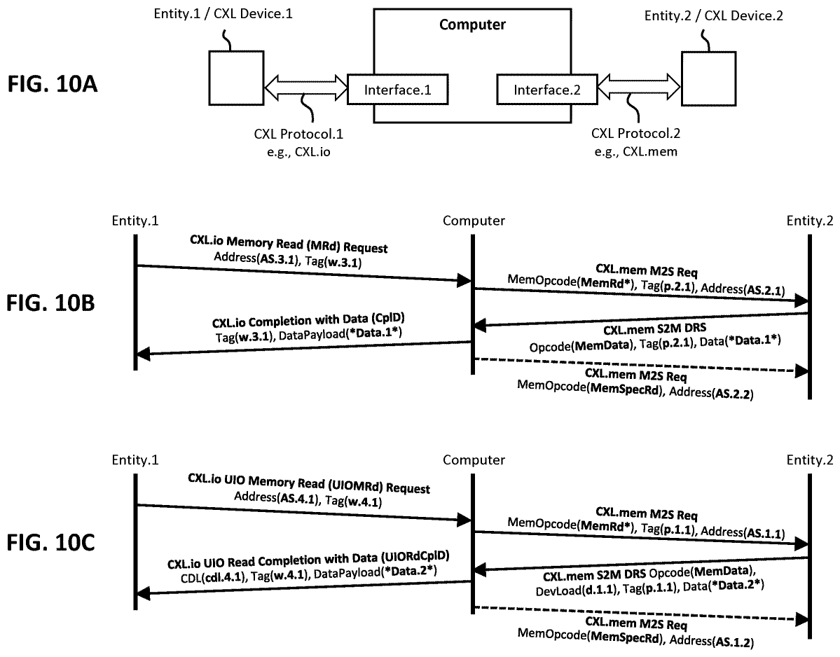

FIG. 10A illustrates an example of a system comprising a computer coupled between a first interface (Interface.1) and a second interface (Interface.2). The first interface may communicate according to a first CXL protocol, such as CXL.io, with a first entity (Entity.1), such as a first CXL device (Device.1) which may be a GPU, an RDMA NIC, an NVMe storage device, or a CXL device that may utilize DMA transfers larger than a cacheline over CXL.io. The second interface may communicate according to a second CXL protocol, such as CXL.mem, with a second entity (Entity.2), such as a second CXL device (Device.2), which may be a CXL memory expander, a CXL memory pool, a GFD, or a CXL device that may utilize cacheline-sized memory transfers over CXL.mem. The computer may be included in a switch (such as a CXL switch) or a bridge. The computer may extract physical addresses from messages received via the first interface, wherein these addresses may refer to a first Physical Address (PA) space utilized by the first entity; translate these addresses; and generate messages carrying the translated physical addresses for transmission via the second interface; wherein these translated addresses may refer to a second PA space utilized by the second entity. In some examples, the first PA space and the second PA space may be the same PA space, wherein the computer may perform address translations between addresses within the same PA space. The computer may perform further translations between the first CXL domain and the second CXL domain, such as translating between CXL.io TLP types (e.g., MRd, UIOMRd) and CXL.mem opcodes (e.g., MemRd, MemRdData, MemRdTEE). The computer may be implemented as a monolithic die, as one or more chiplets within an IC package, or as one or more components on a board. In some examples, the computer, and at least one of the first or second entities may be included within the same IC package, optionally coupled by one or more UCIe links.

FIG. 10B illustrates an example of a TFD demonstrating translations, performed by a computer, between CXL.io TLPs that may be utilized for communicating with a first entity (Entity.1), and CXL.mem messages that may be utilized for communicating with a second entity (Entity.2), possibly enabling the first entity to access resources mapped to an address space utilized by the second entity. The first entity, such as a first CXL device (Device.1) which may be a GPU, may initiate a CXL.io transaction that may include a CXL.io Memory Read (MRd) request comprising Address(AS.3.1) and Tag(w.3.1). The computer may translate the CXL.io transaction to a CXL.mem transactions that may include a CXL.mem M2S request comprising MemOpcode(MemRd*), Tag(p.2.1), and Address(AS.2.1), and may send the CXL.mem M2S request to the second entity, such as a second CXL device (Device.2) which may be a CXL memory expander. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to a CXL.io Completion with Data (CplD) comprising Tag(w.3.1) and DataPayload(*Data.1*), and send the CXL.io CplD to the first entity.

In some examples, depending on the length of the requested data payload in the CXL.io transaction, the computer may translate the CXL.io transaction to one or more CXL.mem transactions that each may carry a cacheline-sized data payload, wherein the computer may aggregate data from CXL.mem responses into one or more CXL.io completions, or may trim data carried in CXL.mem responses to match the CXL.io request. Thus, for example, the computer may translate a CXL.io transaction requesting a 256 B data payload to four CXL.mem transactions each carrying a 64 B payload, wherein the computer may aggregate the four 64 B responses into a CXL.io completion carrying 256 B. In another example, the computer may translate a CXL.io transaction requesting a data payload smaller than a cacheline size (e.g., 1 B), to a single CXL.mem transaction, and may trim the data payload returned by the CXL.mem response to the requested length in the CXL.io request, optionally aligning the data to native boundaries required by the specifications, such as aligning to DW boundaries.

Furthermore, the computer may perform translations, such as protocol translations, opcode translations, command translations, TLP translations, or PDU translations, e.g., translating between CXL.io TLPs and CXL.mem messages, wherein these translations may include field translations, such as translating between CXL.io Tags and CXL.mem Tags, translating between reserved fields, and translating between reserved and non-reserved fields. The computer may further initiate speculative memory reads targeting the second entity, wherein the speculative memory reads may include a CXL.mem M2S Req comprising MemOpcode(MemSpecRd) and Address(AS.2.2), and wherein the computer may utilize the speculative memory reads, optionally on behalf of the first entity, to facilitate data prefetches and potentially reduce read latency from the second entity.

FIG. 10C illustrates an example of a TFD demonstrating translations between CXL.io UIO TLPs that may be utilized for communicating with a first entity (Entity.1), and CXL.mem messages that may be utilized for communicating with a second entity (Entity.2), possibly enabling the first entity to access resources mapped to an address space utilized by the second entity. The first entity, such as a first CXL device (Device.1) which may be a GPU, a Network Interface Card (NIC), or a DMA engine, may initiate a CXL.io UIO transaction that may include a CXL.io UIO Memory Read (UIOMRd) request comprising Address(AS.4.1) and Tag(w.4.1). The computer may translate the CXL.io UIO transaction to a CXL.mem transaction that may include a CXL.mem M2S request comprising MemOpcode(MemRd*), Tag(p.1.1), and Address(AS.1.1), and may send the CXL.mem M2S request to the second entity, such as a second CXL device (Device.2) which may be a CXL memory expander, a memory pool, a GFD, or a CXL accelerator. Upon receiving one or more responses from the second entity, which may include a CXL.mem S2M DRS comprising Opcode(MemData), DevLoad(d.1.1), Tag(p.1.1), and Data(*Data.2*), the computer may translate the one or more responses, such as translating the CXL.mem S2M DRS to a CXL.io UIO Read Completion with Data (UIORdCplD) comprising CDL(cdl.4.1), Tag(w.4.1) and DataPayload(*Data.2*), and send the CXL.io UIORdCplD to the first entity.

The second entity may populate DevLoad of CXL.mem S2M messages, such as CXL.mem S2M DRS messages, with telemetry information, metadata, or other types of information collected or generated by the second entity, or may utilize the DevLoad of CXL.mem S2M messages to throttle CXL.mem requests from the computer, possibly enabling the second entity to control, limit, shape, or throttle the rate of data communications between the computer and the second entity. The computer may translate the information carried in DevLoad of CXL.mem S2M messages received from the second entity, and may populate the translated information in the CDL of the CXL.io UIORdCplD sent to the first entity. Additionally or alternatively, the computer may populate the CDL of the CXL.io UIORdCplD with telemetry information, metadata, or other types of information collected or generated by the computer, or may utilize the CDL to throttle requests from the first entity.

In some examples, depending on the length of the requested data payload in the CXL.io UIO transaction, the computer may translate the CXL.io UIO transaction to one or more CXL.mem transactions that each may carry a cacheline-sized data payload, wherein the computer may aggregate data from multiple CXL.mem responses into one or more CXL.io UIO completions, or may trim data carried in CXL.mem responses to match the CXL.io UIO request. Thus, for example, the computer may translate a CXL.io UIO transaction requesting a 256 B data payload to four CXL.mem transactions each carrying a 64 B payload, wherein the computer may aggregate four 64 B responses into a CXL.io UIO completion carrying 256 B. In another example, the computer may translate a CXL.io UIO transaction requesting a data payload smaller than a cacheline size (e.g., 1 B), to a single CXL.mem transaction, and may trim the data payload returned by the CXL.mem response to the requested length in the CXL.io UIO request, optionally aligning the data to native boundaries required by the specifications, such as aligning to DW boundaries. The computer may perform further translations, such as protocol translations, opcode translations, command translations, TLP translations, or PDU translations, e.g., translating between CXL.io UIO TLPs and CXL.mem messages, wherein these translations may include field translations. The computer may further initiate speculative memory reads targeting the second entity, wherein the speculative memory reads may include a CXL.mem M2S Req comprising MemOpcode(MemSpecRd) and Address(AS.1.2), and wherein the computer may utilize the speculative memory reads, optionally on behalf of the first entity, to facilitate data prefetches and potentially reduce read latency from the second entity.

Some implementations of the following apparatus relate to processor architectures that integrate an RPU with a physical layer based on IEEE 802.3 PMA for enabling CXL protocol communication with external entities across carrier protocol fabrics. Modern datacenter deployments may benefit from disaggregated and composable architectures wherein processing resources and memory resources, such as scale-up memory resources for storing KV-cache entries, are decoupled and interconnected via high-speed fabrics. By integrating an RPU with a CXL device in a processor's IC package, the processor may communicate with external entities such as accelerators, GPUs, memory expanders, storage devices, switches, or other processors utilizing CXL protocols encapsulated within carrier protocol PDUs such as ESUN, SUE, UALink, NVLink, or Ethernet transported over IEEE 802.3-based physical layers.

The RPU may serve as a translation bridge between the processor's internal CXL domain and the external carrier protocol domain, where carrier protocol PDUs carrying encapsulated CXL information are transmitted and received via the physical layer based on IEEE 802.3 PMA. The translation may include extracting CXL fields from incoming carrier protocol PDUs, translating field formats between carrier and CXL representations, reconstructing complete CXL PDUs, and performing the reverse operations for outgoing CXL traffic. The RPU may further perform address translation between different physical address spaces and Tag translation between different Tag spaces to enable interoperability across fabric boundaries.

In various implementations, an apparatus comprising: an integrated circuit package (IC package) comprising processing cores coupled to a memory controller; memory channels coupled to memory accessible via the memory controller; a physical layer based on IEEE 802.3 physical medium attachment (PMA) configured to communicate with an external entity; and a resource provisioning unit (RPU) comprising a Compute Express Link (CXL) device; wherein the RPU is coupled between the processing cores and the physical layer based on IEEE 802.3 PMA, and the RPU is configured to translate between CXL-based protocol data units (PDUs) communicated via the CXL device and carrier protocol PDUs encapsulating data indicative of CXL opcodes and physical addresses, wherein the carrier protocol PDUs are transmitted and received via the physical layer based on IEEE 802.3 PMA. The apparatus may be implemented as an SoC, a multi-chip module (MCM), a chiplet-based design, or any other form of IC that incorporates the processing cores, the memory controller, and the RPU. The processing cores may include general-purpose CPU cores, accelerator cores, or a combination thereof, and may be coupled to the memory controller through an on-chip interconnect, a coherent fabric, or a direct interface. The memory accessible via the memory controller may include DRAM, HBM, or other memory technologies coupled through one or more memory channels utilizing DDR, LPDDR, or HBM interfaces. The RPU may be integrated within the IC package or may be implemented on a separate die within the same package, coupled to the processing cores via an on-chip or inter-die interface. The CXL device within the RPU may include one or more CXL devices, CXL endpoints, or CXL ports that communicate CXL-based PDUs according to one or more CXL sub-protocols including CXL.io, CXL.mem, and CXL.cache. The carrier protocol PDUs may encapsulate CXL information in various formats, including complete CXL PDUs, subsets of CXL PDU fields, or carrier-specific encodings of CXL opcodes and physical addresses.

In some implementations of the apparatus, the processing cores are coupled to the memory controller via a coherent interconnect, and the processing cores respond to snoop requests utilizing physical addresses within a host physical address (HPA) space. The coherent interconnect may be implemented as a ring-based interconnect, a mesh-based interconnect, a crossbar, or another on-chip fabric that maintains cache coherency among the processing cores, LLC slices, home agents, and other coherent agents within the IC package. The processing cores may include cache hierarchies (such as L1, L2, and L3 caches) and may participate in a coherency protocol that handles snoop requests to maintain data consistency. When a snoop request targeting a physical address within the HPA space is received, the processing cores may respond by providing cached data, invalidating cached copies, or indicating the cacheline state, depending on the snoop type and the current coherency state of the cacheline. The HPA space defines the physical address range through which the processing cores and other agents within the IC package access memory resources.

In some implementations, the apparatus further comprises a memory management unit (MMU) coupled to the processing cores, the MMU configured to translate virtual addresses to physical addresses within the host physical address space. The MMU may be integrated within each processing core or may be shared among a group of processing cores. The MMU may utilize page tables, translation lookaside buffers (TLBs), and other address translation structures to map virtual addresses generated by software executing on the processing cores to physical addresses within the HPA space. The MMU may support multiple page sizes, multi-level page table walks, and IOMMU functionality for device-initiated address translations. The presence of the MMU in conjunction with the coherent interconnect may enable the processing cores to execute software that utilizes virtual memory while the underlying CXL transactions operate on physical addresses within the HPA space.

In some implementations of the apparatus, the RPU is further configured to translate a carrier protocol PDU received via the physical layer based on IEEE 802.3 PMA to a CXL request communicated via the CXL device, whereby the translating enables the external entity to access the memory via the physical layer based on IEEE 802.3 PMA, the RPU, the memory controller, and the memory channels. In the inbound direction, the RPU may receive carrier protocol PDUs from external entities such as remote processors, GPUs, accelerators, or memory fabric switches, and may extract and translate the encapsulated CXL information into CXL requests that are communicated via the CXL device to the internal CXL domain of the processor. The CXL requests may traverse the on-chip interconnect to reach the memory controller, which may service the requests by accessing the memory via the memory channels. This inbound path may enable remote entities to read from or write to the processor's memory without requiring a direct CXL link, instead utilizing the carrier protocol fabric and the IEEE 802.3 PMA as the transport medium. The inbound translation may include extraction of CXL.mem M2S request fields, reconstruction of omitted fields, address translation from the external entity's physical address space to the processor's HPA space, and delivery of the reconstructed CXL request via the CXL device.

In some implementations of the apparatus, the RPU is further configured to translate a CXL request originating from the processing cores to a carrier protocol PDU for transmission via the physical layer based on IEEE 802.3 PMA, whereby the translating enables the processing cores to access a resource coupled to the external entity via the RPU and the physical layer based on IEEE 802.3 PMA. In the outbound direction, the processing cores may generate CXL requests targeting resources that are accessible via external entities, such as HBM coupled to a remote GPU, storage buffers coupled to a remote storage device, MMIO registers of a remote accelerator, or memory pooled across a fabric. The CXL requests may traverse the on-chip interconnect to the CXL device within the RPU, which may translate the CXL requests into carrier protocol PDUs for transmission via the physical layer based on IEEE 802.3 PMA to the targeted external entity. The outbound translation may include converting CXL-based PDU fields into carrier protocol representations, translating physical addresses from the processor's HPA space to the external entity's physical address space, encapsulating the translated fields within carrier protocol headers and trailers, and transmitting the carrier protocol PDUs via the IEEE 802.3 PMA.

In some implementations of the apparatus, the RPU is further configured to translate a CXL request originating from the processing cores to a carrier protocol PDU for transmission via the physical layer based on IEEE 802.3 PMA, whereby the translating enables the processing cores to access a resource coupled to the external entity via the RPU and the physical layer based on IEEE 802.3 PMA. The bidirectional configuration may enable the RPU to serve as a full-duplex translation bridge, supporting concurrent inbound and outbound CXL traffic over the carrier protocol fabric. In one direction, external entities may access the processor's memory through the RPU, and in the other direction, the processing cores may access resources coupled to external entities through the same RPU. The bidirectional translation may utilize shared pipeline stages for operations common to both directions, such as carrier protocol framing and physical layer processing, while maintaining separate translation contexts for inbound and outbound traffic to handle different address spaces, Tag spaces, and protocol requirements. Bidirectional operation may be particularly beneficial in deployments where processors and accelerators maintain peer-to-peer relationships, each needing to access the other's memory or resources.

In some implementations of the apparatus, the CXL device comprises at least one of a CXL endpoint or a CXL port, and the CXL device operates as at least one of a CXL Type-2 device, a CXL Type-3 device, or a Global Fabric-Attached Memory Device (GFD). The CXL device within the RPU may take different forms depending on the types of CXL transactions to be supported and the processor architecture. A CXL device may implement the device-side CXL protocol logic, presenting itself as a CXL endpoint visible to the internal CXL fabric in the IC package. When operating as a CXL Type-2 device, it may support CXL.io, CXL.cache, and CXL.mem sub-protocols, enabling both memory access and cache coherency operations. When operating as a CXL Type-3 device, it may support CXL.io and CXL.mem sub-protocols, enabling memory access without device-initiated cache coherency. When operating as a GFD, it may support CXL.mem transactions optimized for fabric-attached memory pooling, potentially simplifying the design by omitting CXL.io handling. The selection of CXL device type may depend on the intended use case, the types of external entities to be served, and the processor's internal coherency architecture.

In some implementations, the apparatus further comprises a root port coupled to a fully coherent request node (RN-F) and a fully coherent home node (HN-F), the root port coupled to the RPU, wherein the RN-F enables the external entity to access the memory of the apparatus and the HN-F enables the processing cores to access a resource coupled to the external entity. The root port may provide a CXL or PCIe root complex interface that is coupled to both an RN-F node and an HN-F node within the processor's coherent interconnect. The RN-F node may act as a fully coherent request node that issues requests on behalf of external entities, enabling those entities to access the processor's memory through the coherent interconnect with full cache coherency. The HN-F node may act as a fully coherent home node that provides a home agent proxy for resources coupled to external entities, enabling the processing cores to issue coherent read and write requests to those resources through the coherent interconnect. This dual-node architecture may support bidirectional coherent access: the RN-F path enables an external entity, such as a GPU, to read from the processor's DRAM, while the HN-F path enables the processing cores to read from the external entity's memory, such as HBM or storage buffers. The root port may be coupled to a second RPU, or may share the RPU with the CXL device path, depending on the implementation.

In some implementations of the apparatus, the RPU is coupled to the processing cores via at least one CXL/CCIX Gateway (CCG) and a coherent interconnect. The CCG may serve as a bridge between the CXL protocol domain and the ARM AMBA CHI protocol domain utilized by the coherent interconnect.

In some implementations of the apparatus, the RPU is further coupled to the processing cores via at least one I/O-coherent Request Node (RN-I) for handling CXL.io traffic. The RN-I node may provide a path for CXL.io or PCIe-based non-coherent traffic that does not participate in the cache coherency protocol.

In some implementations, the apparatus further comprises a second RPU comprising a second CXL device and a second physical layer based on IEEE 802.3 PMA, the second RPU coupled to a root port, wherein the RPU is further configured to handle coherent CXL.mem traffic and the second RPU is configured to handle coherent CXL.mem traffic via the root port. The dual-RPU architecture may provide two distinct paths for CXL.mem traffic, each serving different roles or optimized for different access patterns. The first RPU, coupled to a CXL device and an interconnect component, may handle CXL.mem traffic through a path that is optimized for device-style memory access patterns. The second RPU, coupled to a root port with associated coherent nodes such as RN-F and HN-F, may handle CXL.mem traffic through a path that supports bidirectional coherent access between the processor and external entities. The two RPUs may operate independently, each with its own physical layer based on IEEE 802.3 PMA, enabling the processor to communicate with external entities in parallel, or to provide redundant paths to the same external entity. The two paths may serve different CXL sub-protocol combinations: the first path through the CXL device may support CXL.mem and CXL.io via the CXL-to-CHI and RN-D nodes, while the second path through the root port may support CXL.mem and CXL.cache via the RN-F and HN-F nodes.

In some implementations of the apparatus, the CXL device comprises a Global Fabric-Attached Memory Device (GFD) supporting CXL.mem transactions, the GFD coupled to the processing cores via a CXL/CCIX Gateway (CCG) optimized for handling CXL.mem traffic. The GFD may operate as a specialized CXL device optimized specifically for memory access operations, which simplifies the design. This simplified architecture may be suitable for processors or accelerators (such as xPUs or custom CPU designs) that are designed primarily for servicing external memory requests through CXL.mem fabric access, such as in memory pooling or memory disaggregation deployments.

In some implementations of the apparatus, the RPU is further configured to translate physical addresses between a first physical address space utilized by the external entity and a second physical address space utilized by the processing cores. The external entity may utilize a first physical address space, such as a first HPA space, that differs from the second physical address space, such as a second HPA space, utilized by the processing cores in the IC package. The RPU may perform address translation as part of the extraction and encapsulation processing pipeline, mapping physical addresses from incoming carrier protocol PDUs to the processor's HPA space for inbound requests, and mapping physical addresses from outgoing CXL requests to the external entity's HPA space for outbound requests. The address translation may be implemented utilizing lookup tables, base-and-offset calculations, page table structures, or other translation mechanisms. The translation may enable external entities with different physical address spaces to access the processor's memory through the RPU, and may enable the processing cores to access resources in different physical address spaces via different external entities.

In some implementations of the apparatus, a carrier protocol PDU comprises an encapsulating header comprising at least one field selected from: a PDU version field, a source node identifier, a destination node identifier, a segmentation identifier, a PDU sequence number, or a passenger protocol identifier. The encapsulating header may be placed within the carrier protocol PDU between the carrier protocol headers (such as Ethernet, IP, and UDP headers) and the passenger protocol PDU payload. The PDU version field may indicate the version or format of the encapsulation structure, enabling the processing pipeline to correctly interpret the packet. The source node identifier and the destination node identifier may carry node addresses within the fabric topology for routing purposes. The segmentation identifier may provide tenant isolation or logical network segmentation. The PDU sequence number may provide ordering information for reliable delivery or for reassembly of segmented messages across the fabric. The passenger protocol identifier may indicate the type of CXL sub-protocol (such as CXL.io, CXL.cache, or CXL. mem) encapsulated within the PDU, enabling the processing pipeline to apply appropriate extraction and translation rules.

In some implementations of the apparatus, the carrier protocol PDU further comprises an encapsulating trailer comprising at least one field selected from: an encapsulating CRC (E-CRC) field, a data poisoning (Poison) field, or a reported load (ReportedLoad) field. The encapsulating trailer may be placed after the passenger protocol PDU payload and before any carrier protocol trailer fields such as an Ethernet Frame Check Sequence (FCS). The E-CRC field may provide error detection specifically for the encapsulated portion of the packet, potentially offering additional integrity protection beyond the standard Ethernet FCS. The Poison field may propagate data poisoning indications across the carrier protocol fabric, enabling CXL poison semantics to be maintained end-to-end even when CXL traffic is encapsulated within carrier protocol PDUs. The ReportedLoad field may communicate load or congestion information from the source device or from intermediate network components along the path.

In some implementations of the apparatus, the ReportedLoad field communicates at least one of congestion or load information, wherein the congestion information is augmented with congestion information from intermediate components along a path. The ReportedLoad field may serve a function analogous to CXL DevLoad indicators, carrying information about the load or congestion state at the source device and optionally along intermediate points in the carrier protocol fabric path. Intermediate components such as switches, routers, or fabric managers may augment the ReportedLoad value with their own congestion observations as the carrier protocol PDU traverses the fabric. The receiving RPU may utilize the ReportedLoad information for load balancing decisions, quality-of-service management, congestion avoidance, or adaptive routing. The augmentation by intermediate components may provide a more comprehensive view of fabric congestion than source-only reporting, enabling more effective end-to-end congestion management.

In some implementations of the apparatus, the segmentation identifier provides isolation between different tenants or logical networks. The segmentation identifier may enable infrastructure virtualization within the carrier protocol fabric, allowing multiple tenants, virtual machines, or logical networks to share the same physical fabric infrastructure while maintaining isolation of their CXL traffic. Different segmentation identifier values may correspond to different tenants or logical domains, and the RPU or intermediate switching elements may utilize the segmentation identifier to enforce access control and traffic separation. The segmentation identifier may function similarly to VLAN identifiers in Ethernet or segment identifiers in overlay networks, applied specifically to CXL traffic transported over the carrier protocol fabric. The isolation may prevent CXL requests from one tenant from being visible to or interfering with CXL traffic of another tenant.

In some implementations of the apparatus, the carrier protocol PDU further comprises an Ethernet header, an IP header, and a UDP header suitable for Layer 3(L 3 ) switching operations. The L3 variant of the carrier protocol PDU may include standard Ethernet, IP, and UDP headers preceding the encapsulating header, enabling the carrier protocol PDU to be routed through standard L3 networking equipment, IP routers, and datacenter switches without modification. The Ethernet header may carry MAC addresses for hop-by-hop forwarding. The IP header may carry source and destination IP addresses for network-layer routing decisions across subnets. The UDP header may carry port numbers for service identification and may enable load balancing by varying port numbers across flows. The L3 variant may be suitable for deployments where CXL traffic traverses network segments, subnets, or routing domains within a datacenter fabric.

In some implementations of the apparatus, the carrier protocol PDU comprises a carrier protocol optimized header suitable for Layer 2(L 2 ) switching operations. The L2 variant of the carrier protocol PDU may utilize a condensed or optimized header structure that reduces per-packet overhead compared to the L3 variant. The optimized header may carry addressing or routing information suitable for L2 forwarding decisions based on MAC addresses or other data link layer identifiers, without the overhead of IP and UDP headers. The encapsulating header, passenger protocol PDU, and encapsulating trailer may contain similar fields and serve similar functions as in the L3 variant, adapted for the L2 switching context. The L2 variant may be suitable for deployments where CXL traffic remains within a network segment or broadcast domain, such as within a rack or a top-of-rack switch domain, where L3 routing is not required.

In some implementations, the apparatus further comprises a root port coupled to an upstream port (USP) of a switch, the switch comprising downstream ports (DSPs) coupled to CXL Type-3 devices, and the RPU coupled to the switch via the physical layer based on IEEE 802.3 PMA, wherein both the root port and the RPU access the CXL Type-3 devices via the switch. The switch-based dual-path topology may enable two distinct paths for accessing the same CXL Type-3 memory devices. The first path may connect the root port in the IC package to the USP of the switch, providing a CXL or PCIe-native path for the processing cores to access the memory within the CXL Type-3 devices through the switch's DSPs. The second path may connect external entities (such as remote processors, GPUs, or accelerators) through the carrier protocol fabric, the physical layer based on IEEE 802.3 PMA, the RPU, and then to the switch, enabling those external entities to access the same CXL Type-3 memory devices. The switch may be a Port Based Routing (PBR) switch or a fabric switch that supports multiple upstream connections. This dual-path topology may enable memory pooling or memory sharing scenarios where hosts access shared memory resources through different connectivity paths, some native CXL and some CXL-over-carrier-protocol.

In some implementations of the apparatus, the carrier protocol comprises at least one of Ethernet, Ultra Ethernet Transport (UET), Ethernet for Scale-Up Networking (ESUN), or Scale Up Ethernet (SUE), and the RPU is further configured to extract CXL PDUs from the carrier protocol PDUs and encapsulate CXL PDUs into the carrier protocol PDUs. Different carrier protocols may utilize the IEEE 802.3 PMA while employing different framing, encoding, or header structures. The RPU may support one or more of these carrier protocols and may be configurable to adapt its extraction and encapsulation behavior based on the carrier protocol in use. For Ethernet, the RPU may process standard Ethernet frames with MAC-layer framing. For UET, the RPU may process frames utilizing UET-specific framing optimized for high-performance computing workloads. For ESUN/SUE, the RPU may process frames utilizing ESUN/SUE-specific framing optimized for scale-up interconnect topologies. The extraction operation may include parsing carrier protocol headers, identifying and extracting encapsulated CXL PDU fields, and translating carrier-specific field representations to CXL-conformant formats. The encapsulation operation may include converting CXL PDU fields to carrier-specific representations, generating carrier protocol headers and trailers, and transmitting the resulting carrier protocol PDUs via the physical layer.

In some implementations of the apparatus, the RPU is further configured to translate Tags between a first Tag space utilized by the external entity and a second Tag space utilized by the processing cores. Tags may serve as transaction identifiers that enable response correlation and tracking within CXL transactions. Different entities may utilize different Tag spaces, each with its own range and allocation policies. The RPU may maintain a Tag translation table or mapping function that translates Tags from the external entity's Tag space to the processor's Tag space for inbound transactions, and from the processor's Tag space to the external entity's Tag space for outbound transactions. The Tag translation may enable the RPU to manage concurrent transactions from multiple external entities without Tag collisions, by mapping each entity's Tag values into non-overlapping ranges within the processor's Tag space. In some implementations, the RPU may not terminate the CXL protocol, in which case the Tag may pass through unchanged.

In various implementations, a method comprising: communicating, via a physical layer based on IEEE 802.3 physical medium attachment (PMA), with an external entity; and translating, by a resource provisioning unit (RPU) comprising a Compute Express Link (CXL) device, between CXL-based protocol data units (PDUs) communicated via the CXL device and carrier protocol PDUs encapsulating data indicative of CXL opcodes and physical addresses, wherein the carrier protocol PDUs are transmitted and received via the physical layer based on IEEE 802.3 PMA. The translating may occur continuously during operation, processing both inbound carrier protocol PDUs carrying CXL requests from external entities and outbound CXL requests from the processing cores directed to external entities. The method may be implemented in hardware, firmware, software, or a combination thereof within the RPU.

In some implementations of the method, the translating comprises translating a carrier protocol PDU received via the physical layer based on IEEE 802.3 PMA to a CXL request communicated via the CXL device, whereby the translating enables the external entity to access memory via the physical layer based on IEEE 802.3 PMA, the RPU, a memory controller, and memory channels. The inbound translation method may involve receiving a carrier protocol PDU from the physical layer, parsing the carrier protocol headers to identify the encapsulated CXL information, extracting CXL fields such as opcodes and physical addresses, translating fields from carrier-specific formats to CXL-conformant formats, reconstructing any omitted CXL fields, and delivering the resulting CXL request via the CXL device to the CXL domain of the processor that includes the memory channels. The CXL request may then traverse the on-chip fabric to the memory controller, which services the request by accessing the memory via the memory channels. The method may further include generating a CXL response upon completion of the memory access and translating the response back into a carrier protocol PDU for return to the external entity.

In some implementations of the method, the translating comprises translating a CXL request originating from processing cores to a carrier protocol PDU for transmission via the physical layer based on IEEE 802.3 PMA, whereby the translating enables the processing cores to access a resource coupled to the external entity via the RPU and the physical layer based on IEEE 802.3 PMA. The outbound translation method may involve receiving a CXL request from the processing cores via the on-chip fabric and the CXL device, converting CXL PDU fields to carrier-specific representations, translating physical addresses from the processor's HPA space to the external entity's physical address space, encapsulating the translated fields within a carrier protocol PDU including appropriate headers and trailers, and transmitting the carrier protocol PDU via the physical layer based on IEEE 802.3 PMA. The resource coupled to the external entity may include HBM, DRAM, storage buffers, MMIO registers, or other addressable elements. The method may further include receiving a carrier protocol PDU carrying a response from the external entity and translating the response back into a CXL response for delivery to the processing cores.

In some implementations, the method further comprises translating, by the RPU, physical addresses between a first physical address space utilized by the external entity and a second physical address space utilized by processing cores. The address translation may be performed as part of the inbound and outbound translation operations. For inbound transactions, the RPU may translate physical addresses from the external entity's address space to the processor's address space before delivering the CXL request to the internal CXL domain. For outbound transactions, the RPU may translate physical addresses from the processor's address space to the external entity's address space before encapsulating the CXL request within the carrier protocol PDU. The address translation may utilize lookup tables, base-and-offset calculations, or other programmable translation mechanisms that are configurable during system initialization or runtime.

In some implementations of the method, a carrier protocol PDU comprises an encapsulating header comprising at least one field selected from: a PDU version field, a source node identifier, a destination node identifier, a segmentation identifier, a PDU sequence number, or a passenger protocol identifier. The encapsulating header may enable routing, ordering, multi-tenancy isolation, and protocol identification across the carrier protocol fabric. During inbound translation, the RPU may parse the encapsulating header to determine the destination, identify the passenger protocol type, verify sequencing, and apply tenant isolation policies. During outbound translation, the RPU may generate the encapsulating header with appropriate field values for the target external entity, including source and destination node identifiers for fabric routing, a segmentation identifier for tenant isolation, a PDU sequence number for ordering, and a passenger protocol identifier indicating the CXL sub-protocol being transported.

In some implementations of the method, the carrier protocol comprises at least one of Ethernet, Ultra Ethernet Transport (UET), Ethernet for Scale-Up Networking (ESUN), or Scale Up Ethernet (SUE), and the translating comprises extracting CXL PDUs from the carrier protocol PDUs and encapsulating CXL PDUs into the carrier protocol PDUs. The method may be applied to various carrier protocols that utilize the IEEE 802.3 PMA, including Ethernet for general datacenter networking, UET for optimized high-performance computing fabrics, and ESUN/SUE for scale-up interconnect topologies. The extraction and encapsulation operations may be adapted to the specific framing, header, and encoding conventions of the carrier protocol in use. The method may support automatic detection of the carrier protocol type based on patterns or markers in the received data stream, or the carrier protocol type may be configured statically based on the system deployment.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

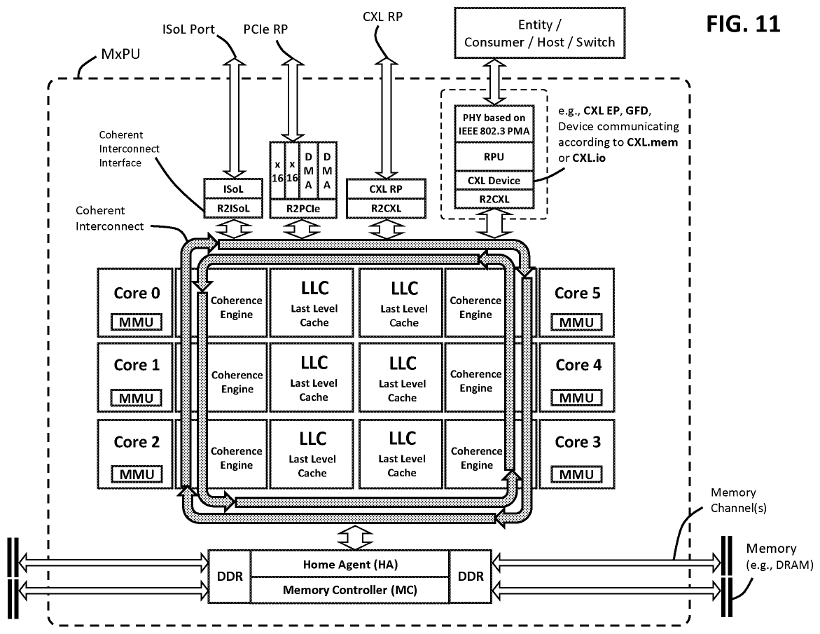

FIG. 11 illustrates an example of a system comprising a processor (such as an MxPU) comprising processing cores (Core 0 through Core 5) comprising MMUs. The cores are coupled to LLC sections and coherence engines via a coherent interconnect, which may be an on-chip processor interconnect such as Intel ring/mesh/crossbar or ARM CHI ring/mesh/crossbar. The MxPU includes external interfaces: an ISoL Port (e.g., ARM CHI C2C, or Intel UPI) coupled to the coherent interconnect via a coherent interconnect interface labeled Ring-to-ISoL (R2ISoL), a PCIe root port (RP) coupled via R2PCIe with PCIe lane configurations (such as x16 and DMA), a CXL RP coupled via R2CXL, and an RPU based interface. The RPU based interface includes a Physical Layer based on IEEE 802.3 PMA coupled to an RPU, coupled to a CXL Device, coupled to an R2CXL interface coupled to the coherent interconnect. The CXL Device may function as different device types such as a CXL EP, GFD, or other device communicating according to a protocol based on CXL, such as CXL.mem or CXL.io. An entity, shown as Entity/Consumer/Host/Switch, is coupled to the MxPU via the Physical Layer based on IEEE 802.3 PMA. The CXL Device enables communication with the external entity using encapsulated CXL protocols over a carrier protocol supported by the IEEE 802.3 PMA, while the RPU performs the applicable translations between the carrier domain and the MxPU's internal coherent interconnect domain. The MxPU further includes a Home Agent (HA) and Memory Controller (MC) coupled to memory (e.g., DRAM) via DDR memory channels.

Translations and bridging logic can enable interoperability between different communication standards while conforming to performance and coherency requirements. The IEEE 802.3 PMA layer provides a standardized physical interface that may be utilized by various protocols for data transmission, offering a well-established foundation for high-speed communication. This PMA layer and its variants may serve as the physical transport for one or more protocols such as Ethernet, UALink, NVLink, Ethernet for Scale-Up Networking (ESUN), Scale Up Ethernet (SUE), and/or other high-performance interconnect technologies.

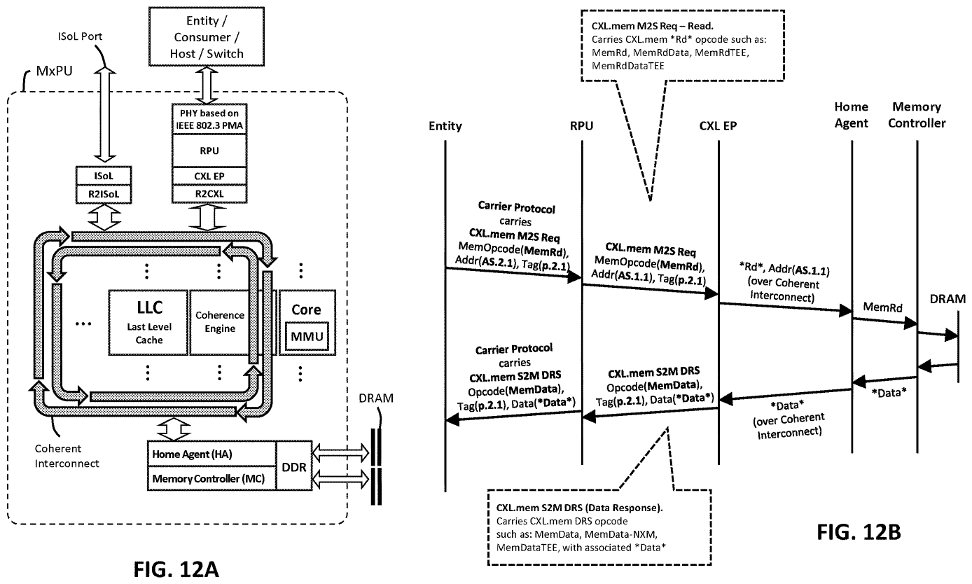

FIG. 12A illustrates an example of a system comprising a processor, such as an MxPU, comprising a PHY based on IEEE 802.3 PMA for transmitting and receiving data according to a carrier protocol. The processor comprises processing cores with MMU and LLC coupled via a coherent interconnect, such as a ring-based interconnect, to various components including a Home Agent (HA), Memory Controller (MC), and CBox (LLC Coherence Engine). The processor further includes an ISoL port, such as ARM CHI C2C or Intel UPI, coupled to the coherent interconnect via a Ring-to-ISoL (R2ISoL) interface. The memory controller is coupled via DDR memory channels to DRAM. The PHY based on IEEE 802.3 PMA enables communication with entities using carrier protocols that encapsulate CXL messages, wherein the IEEE 802.3 PMA provides the physical layer interface for transmitting and receiving frames carrying the encapsulated CXL protocol data. The processor further includes an RPU and a CXL EP associated with the PHY, wherein the RPU is coupled to the coherent interconnect via a Ring-to-CXL (R2CXL) interface. Alternatively, the RPU may be coupled to the coherent interconnect essentially directly. The CXL EP exposes a Type-3 CXL Device or a Type-2 CXL Device. The RPU extracts CXL messages from the carrier protocol frames received via the PHY, performs physical address translations between the entity's HPA space and the processor's physical address space, and encapsulates CXL responses back into the carrier protocol for transmission via the PHY.

FIG. 12B illustrates an example of a TFD demonstrating CXL.mem communications over a carrier protocol utilizing the PHY based on IEEE 802.3 PMA. An entity, such as a host or switch, transmits frames via the carrier protocol, wherein the frames encapsulate CXL.mem M2S requests. The PHY based on IEEE 802.3 PMA receives these frames and provides them to the RPU. The encapsulated request includes a CXL.mem read opcode such as MemRd, MemRdData, MemRdTEE, or MemRdDataTEE, along with a physical address (AS.2.1) from a second physical address space and optionally a Tag (p.2.1) from the entity's Tag space. The RPU extracts the CXL.mem request from the carrier protocol frame, translates the physical address (AS.2.1) to a physical address (AS.1.1) from a first physical address space utilized by the coherent interconnect, and optionally translates the Tag (p.2.1) to a Tag from the coherent interconnect's Tag space. The figure illustrates an example wherein the RPU does not terminate the protocol, and thus the Tag (p.2.1) passes through the RPU unchanged. The RPU performs translations to generate a read request conforming to the coherent interconnect protocol, which is sent to the Home Agent (also known as home node) and/or Memory Controller. The requested data is retrieved from the LLC or DRAM and returned via the coherent interconnect. The CXL EP generates CXL.mem S2M DRS messages carrying the data and optionally CXL.mem S2M NDR messages. The RPU optionally translates response Tags back from the processor's Tag space to the entity's Tag space, encapsulates the CXL.mem responses within carrier protocol frames, and transmits them via the PHY based on IEEE 802.3 PMA to the requesting entity.

Some implementations of the following apparatus relate to processor architectures that incorporate interconnects with CXL protocol interfaces coupled through interconnect components and RPUs for enabling CXL communication with external entities via a physical layer based on IEEE 802.3 PMA. The interconnect within the processor may be implemented as a mesh interconnect that routes messages among processing cores, cache controllers, home agents, memory controllers, and interface agents through crosspoints or similar routing elements. Interconnect components, such as ARM CCG, may bridge CXL protocol domains with CHI protocol domains on the interconnect, enabling CXL devices coupled to RPUs to exchange coherent and non-coherent traffic with agents on the interconnect. The CXL device may be implemented in at least one of the RPU or the interconnect component, and may serve as the CXL endpoint logic that enables CXL transactions between the external entities and the interconnect. The RPU and the interconnect component may together perform the translation between CXL transactions associated with data communicated with external entities via the physical layer based on IEEE 802.3 PMA, and interconnect transactions communicated via the interconnect. The translation may include extracting CXL information from carrier protocol PDUs, reconstructing CXL transactions, performing address and Tag translations, translating CXL transactions to interconnect transactions, and encapsulating CXL responses for transmission back to external entities.

In various implementations, an apparatus comprising: a processor comprising processing cores coupled via an interconnect; an interconnect component coupled to the interconnect; a resource provisioning unit (RPU) coupled to the interconnect component; a physical layer based on IEEE 802.3 physical medium attachment (PMA), coupled to the RPU, configured to communicate with an external entity; a Compute Express Link (CXL) device implemented in at least one of the RPU or the interconnect component; and wherein at least one of the RPU or the interconnect component is configured to translate between CXL transactions and interconnect transactions; wherein the CXL transactions are associated with data communicated with the external entity via the physical layer based on IEEE 802.3 PMA, and the interconnect transactions are communicated via the interconnect. The processor may be implemented as a SoC, a multi-chip module, or a chiplet-based design incorporating processing cores, an interconnect, and various interface agents. The interconnect may provide a scalable on-chip fabric that routes transactions among agents based on packet identifiers, node addresses, or other routing information. The interconnect component may translate between CXL transactions (such as CXL.mem M2S and S2M transactions, CXL.cache H2D and D2H transactions) and interconnect transactions (such as CHI Read, Write, Snoop, and Data transactions) for communication with agents on the interconnect. The CXL device, implemented in at least one of the RPU or the interconnect component, may present CXL endpoint functionality, implementing the CXL protocol logic for one or more CXL sub-protocols. The RPU and the interconnect component may together perform carrier-to-CXL and CXL-to-interconnect protocol translations, enabling external entities connected via the IEEE 802.3 PMA to exchange CXL traffic with the processor's interconnect-coupled agents. Multiple interconnect components may be utilized to provide ports or to handle different CXL sub-protocols.

In the context of coherent interconnects, an interconnect component may refer to various types of devices, blocks, or functional entities that participate in, terminate, bridge, gateway, aggregate, or otherwise interface with a coherent or non-coherent fabric. Non-limiting examples of interconnect components may include router modules, request nodes, home nodes, subordinate nodes, gateways, bridges, and domain bridges. For example, in certain revisions of ARM-based coherent mesh architectures, such as the ARM Neoverse and CoreLink CMN families, interconnect components may include: crosspoint (XP) router blocks; Request Nodes, such as Fully Coherent Request Node (RN-F), I/O-coherent Request Node (RN-I), or I/O-coherent Request Node with Distributed Virtual Memory support (RN-D); Home Nodes, such as Fully Coherent Home Node (HN-F) or I/O-coherent Home Node (HN-I); Gateways, such as CXL/CCIX Gateway (CCG) blocks used with Coherent Multichip Link (CML) or external CXL attachment, or CCIX Gateway (CXG) bridging between CHI and CXS interfaces; and Bridges, such as AMBA 5 CHI to ACE5-Lite bridge (SBSX), AMBA Domain Bridge (ADB), CHI Domain Bridge (CDB), or CXS Domain Bridge (CXSDB). Other revisions of ARM architectures or other coherent interconnect architectures may define different interconnect component types, classifications, or naming conventions.

In some implementations of the apparatus, the interconnect component comprises an ARM CXL/CCIX Gateway (CCG). The CCG may translate between CXL and CHI protocol domains. The CCG may be coupled to the interconnect via one or more ports at a crosspoint.

In some implementations of the apparatus, the interconnect comprises a mesh interconnect, the mesh interconnect comprising crosspoints (XPs) configured to route interconnect transactions between the processing cores, the interconnect component, and memory controllers based on packet identifiers. The crosspoints may function as routing elements at intersections within the mesh topology, examining fields within packets to determine the appropriate output port and routing path. Packet identifiers may include target node identifiers, address-based routing information, or other fields defined by the interconnect protocol for mesh routing. The crosspoints may connect to processing cores, LLC slices, home agents, memory controllers, interconnect components, RN-D nodes, SN-F nodes, and other agents on the mesh interconnect.

In some implementations, the apparatus further comprises an I/O-coherent Request Node with Distributed Virtual Memory support (RN-D) coupled to the interconnect, the RN-D configured to handle CXL.io or non-coherent traffic between the CXL device and the processing cores. The RN-D may handle CXL.io configuration reads and writes, memory-mapped I/O (MMIO) access, and other non-coherent transactions. The RN-D may support Distributed Virtual Memory (DVM) operations, which may enable synchronization of virtual memory management operations across the interconnect.

In some implementations, the apparatus further comprises Subordinate Node (SN-F) nodes coupled to memory controllers, the memory controllers coupled to DRAM via DDR PHY and memory channels. The SN-F nodes may serve as subordinate agents on the interconnect that interface between the interconnect protocol domain and the memory controllers. The SN-F nodes may include snoop filter functionality for tracking cacheline state and location across the interconnect. The memory controllers may access DRAM through DDR PHY interfaces and memory channels, supporting memory technologies such as DDR4, DDR5, LPDDR5, or HBM. When a CXL.mem request from an external entity is translated through the RPU, the request may be routed through the interconnect to a home node, which may in turn access the SN-F node and memory controller to read from or write to DRAM.

In some implementations of the apparatus, the interconnect component comprises a CXL Streaming (CXS) interface and a Coherent Multichip Link (CML) gateway or a Cache Coherent Interconnect for Accelerators (CCIX) Gateway (CXG) that utilizes the CXS interface. Utilizing the CXS interface may enable modular design where different CXL device configurations can be paired with different interconnect component implementations. The CXS interface may support flow control, credit management, and virtual channels for different CXL sub-protocols. The CML gateway or CXG may utilize the CXS interface as the streaming interface protocol for exchanging CXL transactions between the CXL device and the interconnect. The CML gateway may provide coherent multichip link functionality that extends the coherent interconnect across chip boundaries, while the CXG may provide CCIX-based gateway functionality that bridges between CXL and CHI protocol domains with CCIX compatibility. Optionally, a 32-bit cyclic-redundancy check (CRC-32) may be applied to transactions conforming to the CXS interface to detect bit errors, which may be beneficial when the CXS interface spans die-to-die boundaries within a multi-chip module or chiplet-based design where signal integrity conditions may differ from on-die interconnects.

In some implementations of the apparatus, the interconnect component is configured to initiate a CHI allocating ReadShared request to a Home Node in response to a CXL.mem request, wherein the Home Node is coupled to a memory controller. When the RPU receives a CXL.mem read request from an external entity via the physical layer based on IEEE 802.3 PMA and translates it into a CXL transaction, the interconnect component may translate the CXL.mem request into a CHI allocating ReadShared request directed to the Home Node responsible for the targeted address.

In some implementations of the apparatus, the Home Node is configured to send a ReadNoSnp request to the memory controller, and the memory controller is configured to return data to the interconnect component using a CompData response. The combined response optimization may reduce transaction latency by enabling the memory controller to send response data directly to the interconnect component as the requester, rather than routing the data back through the Home Node.

In some implementations of the apparatus, the CXL device comprises a Global Fabric-Attached Memory Device (GFD) supporting CXL.mem transactions, and the interconnect component is optimized for handling CXL.mem traffic. The GFD may operate as a specialized CXL device that supports CXL.mem transactions without supporting CXL.io or CXL.cache sub-protocols. By limiting the supported sub-protocols to CXL.mem, the GFD and the associated interconnect component may be optimized specifically for memory access operations, simplifying the design by eliminating the need for separate CXL.io handling paths that would otherwise be managed by RN-D or RN-I nodes. This simplified architecture may be suitable for processors or accelerators designed for servicing external memory requests through fabric-attached memory pooling, where CXL.io configuration and enumeration may be handled through alternative mechanisms or may not be utilized.

In some implementations of the apparatus, the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs. The carrier protocol may include Ethernet, Ultra Ethernet Transport (UET), Ethernet for Scale-Up Networking (ESUN), Scale Up Ethernet (SUE), UALink, NVLink, or other protocols that utilize the IEEE 802.3 PMA for data transmission. The carrier protocol PDUs may encapsulate CXL information within carrier protocol headers and trailers, including encapsulating headers with fields such as source and destination node identifiers, segmentation identifiers, PDU sequence numbers, and passenger protocol identifiers. The RPU may extract the encapsulated CXL PDUs by parsing the carrier protocol headers, identifying the passenger protocol type, extracting CXL fields from the carrier protocol payload, translating field formats between carrier and CXL representations, and reconstructing complete CXL PDUs conforming to the CXL specification. The extracted and reconstructed CXL transactions may then be communicated to the interconnect component for translation to interconnect transactions.

In some implementations of the apparatus, the external entity comprises at least one of a GPU, an accelerator, or a switch, and the apparatus is configured to enable the external entity to access memory coupled to memory controllers of the processor via the RPU and the interconnect component. External entities such as GPUs, accelerators (including AI/ML accelerators, FPGAs, and data processing units), or switches may communicate with the processor through a carrier protocol fabric via the physical layer based on IEEE 802.3 PMA. The RPU and the interconnect component may translate carrier protocol PDUs from these external entities into interconnect transactions that traverse the interconnect to home nodes and memory controllers, which access DRAM to service the requests. This path may enable external entities to read from or write to the processor's memory for purposes such as shared memory access in heterogeneous computing environments, memory pooling across a fabric, or remote direct memory access (RDMA) operations.

In various implementations, a method comprising: receiving, via a physical layer based on IEEE 802.3 physical medium attachment (PMA), data from an external entity; translating, utilizing a Compute Express Link (CXL) device implemented in at least one of a resource provisioning unit (RPU) or an interconnect component coupled to an interconnect of a processor, between CXL transactions and interconnect transactions communicated via the interconnect; and wherein the processor comprises processing cores coupled via the interconnect, and the CXL transactions are associated with the data received from the external entity via the physical layer based on IEEE 802.3 PMA. The receiving of data may include receiving carrier protocol PDUs from the external entity via the physical layer based on IEEE 802.3 PMA. The translating may include extracting CXL information from the received data, reconstructing CXL transactions conforming to the CXL specification, and translating the CXL transactions into interconnect transactions for routing through the interconnect. The CXL device, implemented in at least one of the RPU or the interconnect component, may provide the CXL protocol endpoint functionality utilized during the translation.

In some implementations of the method, the data comprises protocol data units (PDUs) of a carrier protocol encapsulating CXL PDUs, and the translating comprises extracting CXL PDUs from the carrier protocol PDUs and reconstructing CXL transactions from the extracted CXL PDUs. The carrier protocol PDUs may include headers and trailers specific to the carrier protocol (such as Ethernet, UET, ESUN, or SUE), encapsulating headers with routing and identification metadata, and a payload containing CXL PDU fields. The extraction may involve parsing the carrier protocol structure, identifying the CXL sub-protocol type from a passenger protocol identifier, extracting CXL fields such as opcodes, addresses, and transaction identifiers, and translating field formats where the carrier protocol utilizes different encodings than the CXL specification. Reconstruction may include assembling the extracted and translated fields into complete CXL transactions and inserting any fields that were omitted from the carrier protocol PDU for bandwidth optimization, utilizing configuration parameters or default values for the omitted fields.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

Some implementations of the following apparatus further relate to processor architectures where a CXL root port couples to an interconnect for exchanging CXL traffic with external entities via an RPU and a physical layer based on IEEE 802.3 PMA. A root port may provide root complex functionality and may couple to the interconnect through different nodes depending on the types of CXL traffic to be supported. In one configuration, the root port may couple to a fully coherent request node (RN-F) and a fully coherent home node (HN-F), enabling bidirectional coherent access where external entities access the processor's memory and the processor's cores access resources coupled to external entities. In another configuration, the root port may couple to a CXL/CCIX Gateway (CCG) and an RN-D node, providing coherent CXL.mem handling through the CCG and non-coherent CXL.io handling through the RN-D node.

In various implementations, an apparatus comprising: a processor comprising processing cores coupled via an interconnect; a Compute Express Link (CXL) root port coupled to the interconnect; a resource provisioning unit (RPU) coupled to the CXL root port; a physical layer based on IEEE 802.3 physical medium attachment (PMA), coupled to the RPU, configured to communicate with an external entity; and wherein at least one of the RPU or the CXL root port is configured to translate between CXL transactions and interconnect transactions; wherein the CXL transactions are associated with data communicated with the external entity via the physical layer based on IEEE 802.3 PMA, and the interconnect transactions are communicated via the interconnect. The CXL root port may provide root complex functionality for CXL devices and endpoints coupled to or accessed through the RPU and the IEEE 802.3 PMA. The root port may be coupled to the interconnect through one or more intermediate nodes that translate between CXL protocol transactions and interconnect protocol transactions for communication with agents on the interconnect. The specific node configuration through which the root port is coupled to the interconnect may vary depending on the types of CXL traffic to be supported and the coherency requirements of the deployment. The RPU and the CXL root port may together translate between CXL transactions associated with data from external entities (received as carrier protocol PDUs via the IEEE 802.3 PMA) and interconnect transactions communicated via the interconnect.

In some implementations of the apparatus, the CXL root port is coupled to a fully coherent request node (RN-F) and a fully coherent home node (HN-F) on the interconnect. The RN-F and HN-F may be included within a gateway or bridge node structure coupled between the root port and the interconnect. The RN-F may act as a fully coherent request node that participates in the interconnect coherency protocol, enabling it to issue fully coherent requests (such as ReadShared, ReadUnique, or MakeUnique) on behalf of external entities whose CXL traffic arrives through the RPU and root port. The HN-F may act as a fully coherent home node that manages a portion of the address space, enabling the processor's cores to issue coherent requests to resources accessible through the external entity. Together, the RN-F and HN-F may enable bidirectional coherent communication between the processor and external entities through the CXL root port path.

In some implementations of the apparatus, the RN-F enables the external entity to access memory coupled to memory controllers of the processor via the physical layer based on IEEE 802.3 PMA, the RPU, the CXL root port, and the RN-F. When the external entity, such as a GPU or a storage device, transmits a read or write request encapsulated within a carrier protocol PDU, the RPU may extract the CXL request, translate it into a CXL transaction, and deliver it via the root port to the RN-F node on the interconnect. The RN-F may issue a corresponding interconnect request (such as a ReadShared or WriteBack) to the Home Node responsible for the targeted address, which may access the memory controller and DRAM to service the request. The response data may traverse back through the interconnect to the RN-F, the root port, the RPU, and the physical layer for delivery to the external entity. This path may enable external entities to access the processor's DRAM with full cache coherency, meaning that if the targeted cacheline is present in any of the processor's caches, the coherency protocol may handle the applicable snoops and state transitions.

In some implementations of the apparatus, the HN-F enables the processing cores to access a resource coupled to the external entity via the interconnect, the CXL root port, the RPU, and the physical layer based on IEEE 802.3 PMA. The HN-F may serve as a home node proxy for an address range that maps to resources coupled to the external entity, such as HBM coupled to a GPU, storage buffers coupled to a storage device, or memory-mapped registers of a remote accelerator. When a processing core issues a coherent read or write to an address within this range, the request may be routed through the interconnect to the HN-F, which may translate the interconnect request into a CXL transaction delivered through the root port to the RPU. The RPU may encapsulate the CXL transaction within a carrier protocol PDU and transmit it via the physical layer to the external entity for servicing. The response from the external entity may traverse the reverse path back to the processing core. This outbound path may enable the processor's cores to access external resources with coherency, without requiring the cores to be aware that the resource is accessible via a carrier protocol fabric.

In some implementations of the apparatus, the CXL root port is coupled to the interconnect via a CXL/CCIX Gateway (CCG) and an I/O-coherent Request Node with Distributed Virtual Memory support (RN-D). In this configuration, the CXL root port may couple to the interconnect through a CCG for handling coherent traffic, and through an RN-D node for handling non-coherent traffic. The CCG may translate CXL.mem and CXL.cache transactions arriving through the root port into interconnect transactions for communication with agents on the interconnect. The RN-D node may handle CXL.io or PCIe traffic that does not require full cache coherency but may participate in DVM operations. This configuration may provide a different balance of functionality compared to the RN-F/HN-F configuration, potentially offering advantages for workloads that primarily utilize CXL.mem for memory access combined with CXL.io for device configuration and management.

In some implementations of the apparatus, the CCG is optimized for handling CXL.mem traffic. The CCG in this configuration may be optimized specifically for CXL.mem transactions, potentially simplifying the translation logic by focusing on memory read, memory write, and related memory operations without the overhead of supporting CXL.cache coherency operations through the root port path. The optimization may reduce the logic area, power consumption, and latency of the CXL-to-interconnect translation for CXL.mem traffic. When CXL.cache operations are not expected through the root port path (for example, when cache coherency is managed through a separate path or is not utilized), the CCG may omit or disable the CXL.cache translation logic, further simplifying the design.

In some implementations of the apparatus, the RN-D is configured to handle CXL.io or PCIe traffic communicated via the CXL root port. The RN-D may receive CXL.io or PCIe transactions from the root port and communicate them to the interconnect for routing to the appropriate agents. CXL.io traffic may include configuration reads and writes for device enumeration and management, MMIO access for device control, and other non-coherent transactions defined by the CXL.io (PCIe-based) protocol. The RN-D may support DVM operations that enable synchronization of virtual memory management across the interconnect. The separation of CXL.mem traffic (handled by the CCG) and CXL.io traffic (handled by the RN-D) through the same root port may enable the root port to support the full range of CXL sub-protocols while utilizing specialized nodes for each traffic type.

In some implementations, the apparatus further comprises Subordinate Nodes (SN-F) coupled to memory controllers, the memory controllers coupled to DRAM via DDR PHY and memory channels. The memory subsystem in the root port architecture may be similar to that in the CXL device architecture, with SN-F nodes serving as subordinate agents that interface between the interconnect protocol domain and the memory controllers. CXL traffic arriving through the root port path may ultimately be serviced by the memory controllers accessing DRAM through the DDR PHY and memory channels, after traversal through the interconnect and home node processing.

In some implementations of the apparatus, the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs. The carrier protocol PDUs may include Ethernet, UET, ESUN, SUE, or other carrier protocol frames carrying encapsulated CXL information within headers, payloads, and trailers. The RPU may parse the carrier protocol structure, extract CXL fields, translate between carrier and CXL field formats, and deliver reconstructed CXL transactions to the root port for communication with the interconnect.

In some implementations of the apparatus, the external entity comprises at least one of a GPU, an accelerator, or a switch, and the apparatus is configured to enable the external entity to access memory coupled to memory controllers of the processor via the RPU, the CXL root port, and the interconnect. External entities communicating through a carrier protocol fabric may access the processor's memory through the root port path, with the RPU and the CXL root port translating carrier protocol PDUs into interconnect transactions routed to home nodes and memory controllers. The type of external entity may influence the traffic patterns and CXL sub-protocols utilized:
GPUs may generate high-bandwidth CXL.mem read and write requests for shared memory access, accelerators may combine CXL.mem access with CXL.io for device control, and switches may aggregate and route CXL traffic from downstream entities. The root port path may provide advantages for certain entity types that benefit from root complex enumeration and management capabilities.

In some implementations of the apparatus, the interconnect comprises a mesh interconnect, the mesh interconnect comprising crosspoints (XPs) configured to route interconnect transactions between the processing cores, the CXL root port, and memory controllers based on packet identifiers. The crosspoints in the root port architecture may route interconnect transactions between agents including the processing cores, the nodes through which the root port couples to the interconnect (such as RN-F, HN-F, CCG, or RN-D nodes), home agents, SN-F nodes, memory controllers, and other agents. The routing based on packet identifiers may enable the crosspoints to direct transactions along the mesh topology from source to destination without centralized routing control. The crosspoints may support virtual channels, quality-of-service levels, and flow control mechanisms defined by the interconnect protocol.

In various implementations, a method comprising: receiving, via a physical layer based on IEEE 802.3 physical medium attachment (PMA), data from an external entity; translating, by at least one of a resource provisioning unit (RPU) or a Compute Express Link (CXL) root port coupled to an interconnect of a processor, between CXL transactions and interconnect transactions; wherein the processor comprises processing cores coupled via the interconnect, the CXL transactions are associated with the data received from the external entity via the physical layer based on IEEE 802.3 PMA, and the interconnect transactions are communicated via the interconnect. The receiving of data may include receiving carrier protocol PDUs from external entities such as GPUs, accelerators, or switches. The translating may include extracting CXL information from the received data, reconstructing CXL transactions, and translating the CXL transactions into interconnect transactions for routing to agents on the interconnect through the root port and its coupled nodes.

In some implementations of the method, the CXL root port is coupled to a fully coherent request node (RN-F) and a fully coherent home node (HN-F) on the interconnect, the RN-F enabling the external entity to access memory coupled to memory controllers of the processor, and the HN-F enabling the processing cores to access a resource coupled to the external entity. The bidirectional coherent access method may enable external entities to read from or write to the processor's memory through the RN-F path, and may enable the processor's cores to read from or write to resources coupled to external entities through the HN-F path. The inbound path through the RN-F may involve the RPU extracting and translating incoming data into CXL transactions, which the root port delivers to the RN-F for issuance as interconnect requests. The outbound path through the HN-F may involve the processing cores issuing coherent requests that the HN-F translates into CXL transactions delivered through the root port and RPU for transmission to the external entity via the physical layer. Both paths may operate simultaneously, enabling full-duplex coherent communication between the processor and external entities.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

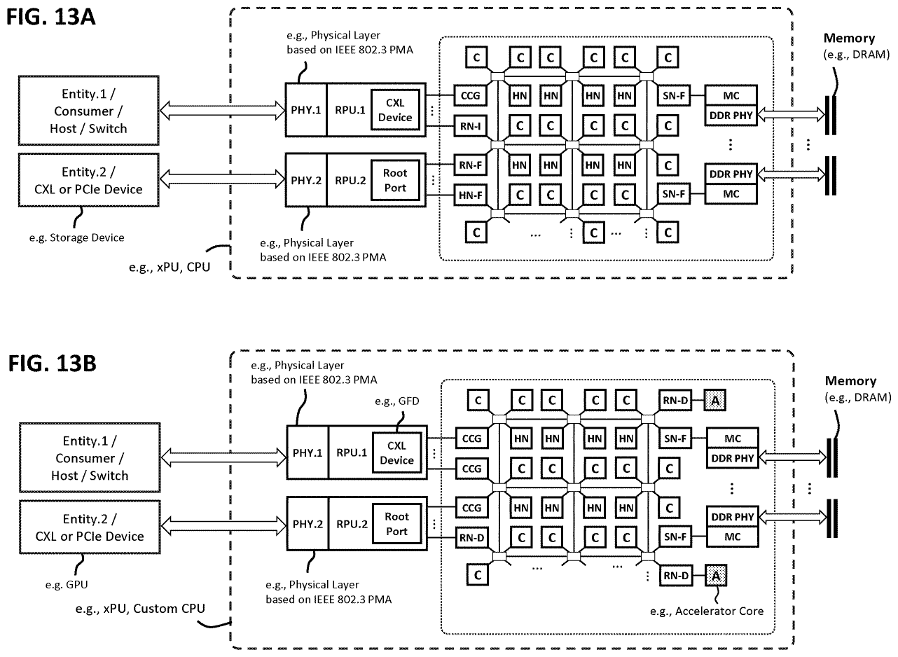

FIG. 13A illustrates an example of a system comprising a processor comprising interfaces that may utilize a physical layer based on IEEE 802.3 PMA. A first RPU includes or is coupled to a CXL device that is coupled to both a CCG node for handling coherent CXL.mem and/or CXL.cache transactions and an RN-D node for handling non-coherent CXL.io transactions, where the CXL device may be implemented in at least one of the RPU or the CCG. The system may couple the first RPU to the CCG over a CXS interface, providing a path for coherent communications. A second RPU includes or is coupled to a root port that is coupled to both a fully coherent request node (RN-F) and a fully coherent home node (HN-F) that may be included within a gateway or a bridge node structure, enabling bidirectional coherent access wherein an external entity, such as a GPU or a storage device, may read from the processor's DRAM through the RN-F node, and in the opposite direction, the processor cores may read from the GPU's HBM or from buffers in the storage device through the HN-F node.

FIG. 13B illustrates an example of a system comprising an xPU or a CPU, which may be a custom CPU design, incorporating accelerator cores and interfaces that may utilize a physical layer based on IEEE 802.3 PMA. A Global Fabric-Attached Memory Device (GFD), utilized by a first RPU, may operate as a specialized CXL device that supports only CXL.mem transactions, allowing the GFD to service external requests through CCGs that are optimized for handling CXL.mem traffic, thereby simplifying the design by eliminating the need for separate CXL.io handling paths typically managed by RN-D or RN-I nodes. The system further includes an optional second RPU that includes or is coupled to a root port, coupled to the interconnect via a CCG and an I/O-Coherent Request Node with DVM support (RN-D), wherein the RN-D may handle CXL.io or PCIe traffic.

It is noted that a line in the drawings may denote more than one port, interface, or link. For example, a single line connecting a CCG to an XP may represent two ports, such as one port for a Request Agent (RA) proxy and another port for a Home Agent (HA) proxy.

PCIe UIO is a capability that enables fabrics with multiple paths between a source and destination, more closely matching the semantics of common IO fabrics including on-die fabrics. UIO shifts the responsibility for enforcing observed ordering from the fabric to the requester, simplifying fabric elements such as switches. All UIO requests have corresponding UIO Completions, which provide the requester with the ability and responsibility to enforce ordering requirements. However, UIO may only be used when the entire path from requester to completer uses Flit Mode, supports UIO, and has UIO enabled. In environments where requesters that do not utilize UIO need to access resources via UIO-enabled paths, or where UIO requesters need to access resources via non-UIO paths, translations between PCIe UIO and PCIe non-UIO TLPs may enable access to multi-path routing benefits or may manage the transition between different ordering models. Such translations may be performed by a computer located between the requester and completer.

In various implementations, a method for enabling multi-path routing for a requester, comprising: receiving, from a first entity that does not utilize Unordered Input/Output (UIO), a Peripheral Component Interconnect Express (PCIe) memory request; translating, by a computer, the PCIe memory request to a PCIe UIO memory request; sending the PCIe UIO memory request to a second entity via a path supporting multi-path routing; receiving, from the second entity, a PCIe UIO Completion; translating, by the computer, the PCIe UIO Completion to a PCIe non-UIO Completion; and sending the PCIe non-UIO Completion to the first entity. The translation from non-UIO to UIO may enable a first entity that does not support UIO capabilities to access resources via paths that support multi-path routing. Multi-path routing may provide benefits such as higher bandwidth through utilization of parallel paths, lower latency through selection of less congested paths, and improved fault tolerance through availability of alternative paths when failures occur. The computer may perform the translation transparently, such that the first entity is unaware that the downstream path utilizes UIO. The method may be implemented in hardware, firmware, software, or combinations thereof.

In some implementations of the method, the path supporting multi-path routing comprises a fabric providing concurrent paths between the computer and the second entity. Non-UIO PCIe fabrics typically utilize tree topologies where a single path exists between any source and destination. UIO may enable fabric topologies where concurrent paths exist between a source and destination, permitting the fabric to distribute traffic across multiple paths for load balancing or to select alternative paths based on congestion or fault conditions. The fabric providing concurrent paths may include switches, bridges, or other routing elements that support UIO and implement mechanisms to manage multi-path routing while avoiding deadlocks and loops. Such topologies may include mesh interconnects, redundant link configurations, or parallel switch fabrics.

In some implementations of the method, the PCIe UIO memory request is routed via one of the concurrent paths selected based on at least one of: load balancing, congestion avoidance, or fault tolerance. Load balancing may distribute requests across available paths to maximize aggregate bandwidth utilization. Congestion avoidance may route requests away from paths experiencing high utilization or backpressure. Fault tolerance may enable continued operation when one or more paths become unavailable due to link failures, device failures, or maintenance activities. The selection mechanism may be implemented in the fabric routing elements using techniques such as adaptive routing algorithms, weighted path selection, or explicit path specification.

In some implementations of the method, the PCIe memory request comprises a non-UIO Memory Read (MRd) request comprising a first address and a first Tag, wherein the PCIe UIO memory request comprises a UIO Memory Read (UIOMRd) request comprising a second address and a second Tag, wherein the PCIe UIO Completion comprises a UIO Read Completion with Data (UIORdCplD), and wherein the PCIe non-UIO Completion comprises a non-UIO Completion with Data (CplD). The MRd from the first entity may conform to PCIe memory read with fabric-based ordering. The computer may translate the MRd to a UIOMRd for transmission to the second entity via the multi-path fabric. Upon receiving the UIORdCplD from the second entity, the computer may translate it to a CplD in the non-UIO completion format expected by the first entity.

In some implementations, the method further comprises receiving, from the first entity, a PCIe non-UIO Memory Write request (MWr) comprising write data; translating, by the computer, the PCIe MWr to a PCIe UIO Memory Write request (UIOMWr) comprising the write data; sending the PCIe UIOMWr to the second entity via the path supporting multi-path routing; and receiving, from the second entity, a PCIe UIO Write Completion (UIOWrCpl). The translation from non-UIO to UIO write may convert a posted write that does not expect a completion into a non-posted write that receives a UIOWrCpl from the second entity. The UIOWrCpl may provide end-to-end acknowledgment that the write data has been received by the second entity, which the computer may utilize for flow control, error handling, or telemetry collection. The UIOMWr may be sent to the second entity via the path supporting multi-path routing, taking advantage of load balancing or alternative routing available on that path.

In some implementations of the method, the computer translates the PCIe MWr to multiple PCIe UIO Memory Write requests, and wherein the multiple PCIe UIO Memory Write requests are sent via respective paths to multiple second entities, wherein the write data is distributed across the second entities according to a striping scheme. The striping scheme may distribute sequential portions of the write data across the second entities, enabling parallel write operations that increase aggregate write bandwidth. The computer may split the write data into stripes based on configurable stripe sizes, address ranges, or device characteristics. Each PCIe UIO Memory Write request may carry a portion of the original write data to a respective second entity. The computer may receive UIOWrCpl from each of the second entities and may use these completions for internal flow control, error tracking, or telemetry collection.

In some implementations of the method, the computer translates the PCIe MWr to multiple PCIe UIO Memory Write requests comprising essentially identical write data, and wherein the multiple PCIe UIO Memory Write requests are sent via respective paths to multiple second entities for data mirroring. Data mirroring may provide redundancy by writing essentially identical copies of the write data to second entities. The computer may generate multiple PCIe UIO Memory Write requests each carrying essentially the same write data for transmission to different second entities. The mirroring may enable fault tolerance wherein data remains accessible from surviving second entities if one or more second entities fail.

In some implementations of the method, the computer generates parity data based on the write data, translates the PCIe MWr to multiple PCIe UIO Memory Write requests comprising data chunks and parity chunks, and sends the multiple PCIe UIO Memory Write requests via respective paths to multiple second entities. Erasure coding may provide fault tolerance with improved storage efficiency compared to mirroring. The computer may compute parity chunks from the write data using erasure coding algorithms such as Reed-Solomon coding, XOR-based parity, or other error-correction schemes. The data chunks and parity chunks may be distributed across the second entities such that the original write data can be reconstructed from a subset of the chunks if one or more second entities become unavailable.

In some implementations of the method, the PCIe memory request comprises a first physical address in a first physical address space utilized by the first entity, and wherein the PCIe UIO memory request comprises a second physical address in a second physical address space utilized by the second entity. The address translation may accommodate scenarios where the first entity and the second entity utilize different physical address spaces. The translation may be implemented utilizing lookup tables, page tables, base-and-offset calculations, or programmable translation functions.

In some implementations of the method, the first entity comprises at least one of a legacy PCIe host, a legacy PCIe device, a GPU, or a NIC that does not support UIO; and wherein the second entity comprises at least one of a memory device, a memory expander, a memory pool, a Global Fabric-Attached Memory device (GFD), or a PCIe device supporting UIO. Legacy PCIe hosts and devices may not support UIO due to hardware generation, firmware limitations, or configuration choices. GPUs and NICs may benefit from multi-path routing for memory access operations even when they do not natively support UIO. Memory devices, memory expanders, memory pools, and GFDs may be deployed in fabric configurations that support multi-path routing to provide high-bandwidth, low-latency memory access to multiple requesters. The translation performed by the computer may enable these legacy or non-UIO devices to access the benefits of multi-path fabrics.

In various implementations, a system for enabling multi-path routing for a requester, comprising: a first interface configured to communicate with a first entity that does not utilize Unordered Input/Output (UIO); a second interface configured to communicate with one or more second entities via a path supporting multi-path routing; and a computer coupled between the first interface and the second interface, the computer configured to: receive, via the first interface, a Peripheral Component Interconnect Express (PCIe) memory request from the first entity; translate the PCIe memory request to a PCIe UIO memory request; send, via the second interface, the PCIe UIO memory request to at least one of the second entities; receive, via the second interface, a PCIe UIO Completion from the at least one of the second entities; translate the PCIe UIO Completion to a PCIe non-UIO Completion; and send, via the first interface, the PCIe non-UIO Completion to the first entity. The system may enable a first entity that does not support UIO capabilities to access resources via paths that support multi-path routing. The second interface may be coupled to the second entities, enabling the computer to distribute requests across devices for load balancing, fault tolerance, or data distribution schemes such as striping or mirroring. The system may be implemented as a semiconductor device, a switch, a bridge, or other suitable device positioned between the first entity and the second entities.

In some implementations of the system, the computer is configured to send the PCIe UIO memory request to one or more of the second entities based on at least one of: address mapping, load balancing, or a data distribution policy. The computer may select which of the second entities receives the PCIe UIO memory request based on address mapping that assigns address ranges to specific second entities, load balancing that distributes requests to minimize congestion, or a data distribution policy that implements striping, mirroring, or erasure coding across the second entities. The second interface may include ports or channels to communicate with the second entities concurrently.

In some implementations of the system, at least two of the second entities utilize different physical address spaces, and wherein the computer comprises address translation logic configured to translate a physical address from the first entity to respective physical addresses for each of the at least two of the second entities. The different physical address spaces may have different base addresses, different sizes, and/or different memory layouts. The address translation logic may maintain separate translation tables or mappings for each of the second entities, enabling the computer to translate an address from the first entity into different addresses for the respective second entities. This capability may enable unified addressing from the perspective of the first entity while accommodating heterogeneous memory configurations across the second entities.

In some implementations of the system, the computer is further configured to implement at least one of:
data striping across the second entities, data mirroring to the second entities, or erasure coding with parity distribution across the second entities. The computer may include logic to split write data into stripes for distribution across the second entities, to replicate write data for mirroring to the second entities, or to compute parity chunks for erasure coding distribution. The computer may also include logic to reassemble striped read data from the second entities, to select among mirrored copies for read operations, or to reconstruct data from erasure-coded chunks when one or more of the second entities are unavailable. The computer may operate transparently to the first entity, presenting a unified memory view while implementing the selected data distribution scheme.

In some implementations of the system, the second interface is coupled to a fabric comprising physical paths to the one or more of the second entities, and wherein the computer is configured to select among the physical paths based on path availability or congestion. The fabric may include redundant links, parallel switch paths, or mesh interconnect topologies that provide concurrent paths between the computer and the one or more of the second entities. The computer may monitor path availability and congestion indicators to select paths that optimize latency, bandwidth, or reliability. Path selection may be performed per-request, per-flow, or at other granularities based on system requirements.

In various implementations, a method for managing ordering in translation, comprising: receiving, from a first entity, a Peripheral Component Interconnect Express (PCIe) Unordered Input/Output (UIO) memory request, wherein the first entity is configured to enforce ordering requirements for the PCIe UIO memory request; translating, by a computer, the PCIe UIO memory request to a PCIe non-UIO memory request; sending the PCIe non-UIO memory request to a second entity via a path that enforces fabric-based ordering; receiving, from the second entity, a PCIe non-UIO Completion; translating, by the computer, the PCIe non-UIO Completion to a PCIe UIO Completion; and sending the PCIe UIO Completion to the first entity. UIO shifts the responsibility for enforcing observed ordering from the fabric to the requester, whereas non-UIO PCIe relies on fabric-based ordering rules. When translating from UIO to non-UIO, the computer may manage this transition by translating requests from a domain where the requester enforces ordering to a domain where the fabric enforces ordering. The first entity, utilizing UIO, may issue requests with the expectation that completions may arrive in various orders and that the first entity bears responsibility for ordering requirements. The non-UIO path to the second entity may enforce ordering according to non-UIO PCIe rules. The computer may bridge these different ordering models while maintaining correct transaction semantics on each side.

In some implementations of the method, the first entity is configured to accept PCIe UIO Completions without a predetermined order, and to enforce ordering requirements based on completion arrival. UIO requesters may accept UIO Completions in various orders according to PCIe UIO specifications. The first entity may implement ordering enforcement mechanisms such as completion reordering buffers, sequence number tracking, or dependency tracking to enforce required ordering based on the order in which completions arrive. This requester-based ordering may simplify fabric elements by removing the need for in-order completion delivery while placing ordering responsibility on the endpoints.

In some implementations of the method, the path that enforces fabric-based ordering enforces producer-consumer ordering rules based on PCIe specifications, and wherein the computer is configured to track pending transactions to correlate the PCIe non-UIO Completion with the PCIe UIO memory request. PCIe fabric ordering rules may include requirements such as posted requests not passing other posted requests to the same destination, completions not being blocked by requests, and non-posted requests maintaining ordering with respect to posted requests. These producer-consumer ordering rules may enable PCIe devices to operate correctly without implementing ordering enforcement logic. The computer may maintain tracker entries or pending transaction tables to associate incoming completions with their corresponding requests, enabling correct translation of completions back to the UIO domain with appropriate Tag restoration.

In some implementations of the method, the PCIe UIO memory request comprises a UIO Memory Read (UIOMRd) request comprising a first address and a first Tag, wherein the PCIe non-UIO memory request comprises a non-UIO Memory Read (MRd) request comprising a second address and a second Tag, wherein the PCIe non-UIO Completion comprises a non-UIO Completion with Data (CplD), and wherein the PCIe UIO Completion comprises a UIO Read Completion with Data (UIORdCplD). The UIOMRd from the first entity may be issued with the expectation of out-of-order completion delivery. The computer may translate the UIOMRd to an MRd for transmission to the second entity, where the fabric may enforce ordering with respect to other transactions. Upon receiving the CplD from the second entity, the computer may translate it to a UIORdCplD for delivery to the first entity.

In some implementations, the method further comprises receiving, from the first entity, a PCIe UIO Memory Write request (UIOMWr) comprising a Tag and write data, wherein the first entity expects a UIO Write Completion (UIOWrCpl) for the UIOMWr; translating, by the computer, the PCIe UIOMWr to a PCIe non-UIO Memory Write request (MWr) comprising the write data; sending the PCIe MWr to the second entity via the path that enforces fabric-based ordering; and sending, to the first entity, a PCIe UIOWrCpl comprising the Tag. The translation from UIO to non-UIO write may involve converting a non-posted write that expects a completion into a posted write that does not return a completion from the second entity. The first entity, utilizing UIOMWr, may expect a UIOWrCpl to confirm write completion and to enforce ordering requirements. The computer may generate the UIOWrCpl to satisfy the first entity's expectation, even though the MWr sent to the second entity is posted and does not receive a completion. The fabric-based ordering on the non-UIO path may provide ordering guarantees that the first entity would otherwise need to enforce based on UIOWrCpl arrival.

In some implementations of the method, the computer sends the UIOWrCpl to the first entity at one of: before sending the PCIe MWr to the second entity, in parallel with sending the PCIe MWr to the second entity, or after the computer receives acknowledgment that the PCIe MWr has been accepted by a downstream component. Sending the UIOWrCpl before sending the MWr may reduce latency observed by the first entity, enabling the first entity to proceed with subsequent operations and enforce required ordering based on early completion notification. Sending the UIOWrCpl in parallel with the MWr may balance latency and ordering considerations. Sending the UIOWrCpl after receiving downstream acknowledgment may provide stronger guarantees that the write data has progressed toward the second entity before the first entity receives completion notification. The selection between these timing options may be configurable or may be determined dynamically based on system conditions.

In some implementations of the method, the UIOWrCpl comprises a CXL DevLoad (CDL), and wherein the computer populates the CDL with Quality-of-Service (QoS) telemetry information based on at least one of: queue depth at the computer, observed latency, or congestion indicators. The computer may populate the CDL with locally generated telemetry information since the posted MWr sent to the second entity does not return a completion carrying telemetry. The first entity may utilize this telemetry to make informed decisions about subsequent write operations, such as throttling write rates or selecting alternative destinations based on observed conditions at the computer.

In some implementations of the method, the PCIe UIO memory request comprises a first physical address in a first physical address space utilized by the first entity, and wherein the PCIe non-UIO memory request comprises a second physical address in a second physical address space utilized by the second entity. The address translation may enable the first entity to access resources at the second entity utilizing physical addresses within a physical address space utilized by the first entity, while the computer translates to physical addresses appropriate for the physical address space utilized by the second entity. The translation may be implemented utilizing lookup tables, page tables, base-and-offset calculations, or programmable translation functions.

In some implementations of the method, the first entity comprises at least one of a UIO-capable host, a UIO-capable GPU, a UIO-capable NIC, or a UIO-capable accelerator, and wherein the second entity comprises at least one of a legacy PCIe device, a legacy PCIe host, a memory device, or a storage controller that does not support UIO. UIO-capable hosts, GPUs, NICs, and accelerators may implement UIO to benefit from multi-path routing, out-of-order completion handling, or simplified fabric interactions. Legacy PCIe devices and hosts may not support UIO due to hardware generation or design choices. Memory devices and storage controllers may operate using PCIe with fabric-based ordering. The translation performed by the computer may enable UIO-capable devices to access these legacy or non-UIO resources while maintaining correct ordering on each side of the translation boundary.

In various implementations, a system for managing ordering in translations, comprising: a first interface configured to communicate with a first entity that utilizes Peripheral Component Interconnect Express (PCIe) Unordered Input/Output (UIO) and is configured to enforce ordering requirements; a second interface configured to communicate with a second entity via a path that enforces fabric-based ordering; and a computer coupled between the first interface and the second interface, the computer configured to: receive, via the first interface, a PCIe UIO memory request from the first entity; translate the PCIe UIO memory request to a PCIe non-UIO memory request; send, via the second interface, the PCIe non-UIO memory request to the second entity; receive, via the second interface, a PCIe non-UIO Completion from the second entity; translate the PCIe non-UIO Completion to a PCIe UIO Completion; and send, via the first interface, the PCIe UIO Completion to the first entity. The system may bridge different ordering models, translating between UIO where the requester enforces ordering and non-UIO where the fabric enforces ordering. The system may enable UIO-capable devices to access legacy PCIe infrastructure while maintaining correct transaction semantics on each side of the translation boundary.

In some implementations of the system, the computer comprises ordering management logic configured to receive PCIe UIO memory requests arriving at the computer without fabric-based ordering, and to send corresponding PCIe non-UIO memory requests via the path that enforces fabric-based ordering according to producer-consumer ordering rules. The ordering management logic may buffer or queue incoming PCIe UIO memory requests and may release corresponding PCIe non-UIO memory requests according to the ordering constraints of the non-UIO path. The ordering management logic may implement mechanisms to prevent deadlocks that could arise from the interaction between UIO and non-UIO ordering models.

In some implementations of the system, the computer comprises tracker entries, each tracker entry configured to store state information for a pending transaction including a mapping between a first Tag from the PCIe UIO memory request and a second Tag for the PCIe non-UIO memory request. The tracker entries may enable the computer to correlate incoming PCIe non-UIO Completions with their corresponding PCIe UIO memory requests, enabling correct restoration of Tags when translating completions back to the UIO domain. The tracker entries may support concurrent transactions, with each entry tracking a separate pending operation.

In some implementations of the system, the computer comprises completion generation logic configured to generate PCIe UIO Completions for PCIe UIO Memory Write requests when the PCIe non-UIO memory request comprises a posted write that does not receive a completion from the second entity. The completion generation logic may generate UIOWrCpl to satisfy the first entity's expectation of completion acknowledgment for non-posted UIO writes, even though the translated MWr sent to the second entity is posted and does not return a completion. The completion generation logic may determine the timing of completion generation based on configuration settings, system conditions, or ordering requirements.

In some implementations of the system, the computer is further configured to translate between a first physical address belonging to a first physical address space utilized by the first entity and a second physical address belonging to a second physical address space utilized by the second entity. The computer may utilize lookup tables, translation lookaside buffers, page table walkers, or programmable translation functions for the address translation, which may enable the first entity to access resources at the second entity utilizing physical addresses within an address space utilized by the first entity, while the second entity operates utilizing physical addresses within a different address space.

In some implementations of the system, the first entity comprises at least one of a UIO-capable GPU, a UIO-capable NIC, or a UIO-capable accelerator, and wherein the second entity comprises at least one of a legacy PCIe memory device, a legacy PCIe storage controller, or a legacy PCIe host. UIO-capable GPUs, NICs, and accelerators may implement UIO to benefit from multi-path routing, out-of-order completion handling, or simplified fabric interactions in modern datacenter and high-performance computing environments. Legacy PCIe memory devices, storage controllers, and hosts may operate using PCIe with fabric-based ordering. The system may bridge these different device generations and capabilities, enabling modern UIO-capable devices to access legacy infrastructure.

To improve yield and reduce development costs, a processing unit may leverage intentional reservation of silicon area as a repurposed area (which may also be referred to as a designated area) to improve manufacturing yield and reduce time to market. Design blocks that reside in the repurposed areas are not mandatory for correct operation of the un-modified xPU, and may be replaced by other design blocks to create different types of MxPUs with different features and functional behaviors. By reserving an area in a die floorplan of an established xPU silicon design for a repurposed area, it may be possible to reuse the established silicon design, along with its core floorplan, packaging, and substrate, more rapidly compared to developing an entirely new design that removes the repurposed area from the silicon die, potentially reducing development time and associated costs while maintaining the original die size and layout. Additionally, this approach may allow for quicker adaptation of established designs to create new product variants, leveraging established manufacturing processes and potentially minimizing the need for extensive redesign and validation efforts typically associated with the development of new chip layouts, thereby streamlining the overall product development cycle.

In various implementations, a modified processing unit (MxPU) comprising: memory channels capable of communicating with memory located outside the MxPU; a silicon die comprising (i) processing cores, coupled via a coherent interconnect, configured to utilize a first physical address space to access the memory via the memory channels, and (ii) a repurposed area occupying a space equivalent to at least one processing core; a communication port, selected from a Compute Express Link (CXL) endpoint, a CXL switch port, an NVLink port, or a UALink port, configured to receive messages comprising physical addresses within a second physical address space; a resource provisioning unit (RPU) configured to translate physical addresses within the second physical address space to physical addresses within the first physical address space; and wherein the repurposed area, which was originally designed to accommodate at least one processing core, accommodates at least one of the communication port or the RPU.

In some implementations of the MxPU, the repurposed area comprises a repurposed impaired area comprising at least one electrically disabled processing core. The repurposed impaired area may be created by electrically disabling one or more processing cores that were part of the original xPU design. This electrical disabling may be accomplished utilizing various methods such as power gating, clock gating, fuse programming, or other techniques that render the core non-functional while preserving the physical silicon area. By electrically disabling one or more cores rather than physically removing them from the silicon die, the MxPU may maintain the original die dimensions and layout, potentially allowing for the reuse of established packaging, thermal solutions, and manufacturing processes while creating space for implementing alternative functional blocks such as the communication port or RPU.

In some implementations of the MxPU, the at least one of the communication port or the RPU draws operating power through a power rail originally designed to supply power to the repurposed area. The MxPU may leverage existing power distribution infrastructure by repurposing power rails that were originally designed to supply the processing cores in the repurposed area, which may enable efficient power delivery to the communication port or RPU without requiring extensive redesign of the power distribution network. The power rails may include metal layers, vias, and power delivery components that were already optimized for the original die layout, potentially reducing development time and maintaining established power integrity characteristics while supplying the newly implemented functional blocks.

In some implementations of the MxPU, the repurposed area comprises a repurposed impaired area, and wherein the at least one of the communication port or the RPU receives a clock signal through a clock distribution network originally designed to provide clock signals to the repurposed impaired area. The MxPU may utilize existing clock distribution infrastructure by tapping into clock networks that were originally designed for the processing cores in the repurposed impaired area. Clock distribution networks are typically complex structures requiring careful design to minimize skew and jitter, and redesigning these networks late in the development cycle may be costly and time-consuming. By maintaining the existing clock distribution segments and inserting appropriate buffers or clock receivers, the communication port or RPU may obtain necessary clock signals without requiring extensive clock tree re-synthesis or re-layout, potentially preserving timing closure achievements from the original design while reducing development complexity.

In some implementations of the MxPU, the at least one of the communication port or the RPU is coupled to the coherent interconnect via an interconnect port originally designed for coupling the repurposed area to the coherent interconnect. The MxPU may reuse existing interconnect infrastructure by electrically reassigning interconnect fabric ports that were originally allocated to processing cores in the repurposed area. The coherent interconnect typically includes ports for coupling various components, wherein the ports may have associated routing, arbitration circuits, and protocol interfaces. By reusing an existing interconnect port for the communication port or RPU, the MxPU design may minimize changes to global routing and interconnect topology, potentially preserving timing closure margins and reducing verification complexity. This approach may enable the new functional blocks to communicate with other system components through established interconnect pathways without requiring extensive modifications to the interconnect fabric architecture.

In some implementations, the MxPU further comprises a memory management unit (MMU); wherein the memory located outside the MxPU comprises at least 64 GB of dynamic random-access memory (DRAM) coupled via the memory channels, wherein the first physical address space is a Host Physical Address (HPA) space, and the MMU is configured to map addresses within a virtual address space, utilized by an operating system of the MxPU, to physical addresses within the first physical address space. The MMU may enable the operating system running on the MxPU to utilize virtual addressing, which may provide memory protection, process isolation, and flexible memory allocation. The coupling of at least 64 GB of DRAM via the memory channels may provide sufficient memory capacity for memory pooling applications, wherein the MxPU may serve as a memory resource for external entities. The first physical address space being an HPA space may enable coherent memory access across system components and may establish a unified addressing scheme for the MxPU's resources.

In some implementations of the MxPU, the processing cores are configured to execute instructions compatible with an x86 instruction set architecture; and further comprising at least three levels of in-package cache memory coupled to the coherent interconnect, and wherein a third level of the in-package cache memory has a capacity of at least 4 MB. The MxPU may be based on x86 architecture, which may provide compatibility with a wide range of existing software and operating systems. The inclusion of at least three levels of in-package cache memory, with the third level (typically the last level cache or LLC) having at least 4MB capacity, may provide a cache hierarchy that can improve memory access performance. This cache hierarchy may be beneficial when the MxPU serves as a CXL memory device, as the LLC may cache frequently accessed data from external entities, potentially reducing access latency compared to direct DRAM access.

In some implementations of the MxPU, the processing cores are configured to execute instructions compatible with a RISC-based instruction set architecture selected from ARM instruction set architecture or RISC-V instruction set architecture, and further comprising at least two levels of in-package cache memory coupled to the coherent interconnect, and wherein a last level of the in-package cache memory has a capacity of at least 4 MB. The MxPU may be based on RISC architectures such as ARM or RISC-V, which may provide power efficiency and scalability advantages for memory pooling applications. The inclusion of at least two levels of in-package cache memory, with the last level having substantial capacity of at least 4 MB, may help reduce memory access latency and improve overall system performance. The cache hierarchy may work in conjunction with the coherent interconnect to maintain data consistency across the processing cores and external accesses through the communication port.

In some implementations of the MxPU, the processing cores comprise streaming multiprocessors (SM) configured to execute instructions compatible with NVIDIA's Compute Unified Device Architecture (CUDA) parallel computing platform, and wherein a number of the streaming multiprocessors exceeds 50. The MxPU may be based on GPU architecture utilizing NVIDIA's CUDA platform, wherein the processing cores are implemented as streaming multiprocessors (SM) optimized for parallel computation. Having more than 50 streaming multiprocessors may provide substantial parallel processing capability, which may be beneficial for certain memory access patterns and workloads. This GPU-based MxPU architecture may be suitable for applications that benefit from high memory bandwidth and parallel memory access capabilities, while the repurposed area may accommodate the communication port and RPU functionality needed for CXL-based or UALink-based memory pooling.

In some implementations of the MxPU, a design of the MxPU was derived from an established CPU or GPU design comprising a second silicon die, and wherein the silicon die of the MxPU has a die size within ±9 % of the die size of the second silicon die of the established CPU or GPU design. The MxPU may be manufactured with one or more repurposed impaired areas while retaining a comparable die size of an established CPU or GPU design. This approach may improve the effective manufacturing yield of silicon dies comprising the MxPU devices because the repurposed impaired areas may not be required to pass the stringent functional correctness testing during the production phases of the MxPU, as they were originally required during the production phases of the established CPU or GPU design. Consequently, the impact of defects may be mitigated, leading to a higher effective manufacturing yield, which may contribute to reducing the manufacturing costs associated with the production of such MxPU devices. Additionally or alternatively, utilizing such repurposing and impairment techniques may reduce design and manufacturing costs associated with creating additional product variants, by identifying die areas associated with functionalities that are deemed unnecessary (hence functionally impaired) for specific product variants, and basing those MxPU variants on changes made in the repurposed impaired areas of an established CPU or GPU design. In this context, “established” refers to a design that exists at the time of making the modification, which may be well after the date of filing this patent application, and indicates a pre-existing design without implying a specific timeframe relative to the date of filing this patent application. Alternative words that could convey a similar meaning include current, pre-designed, previously developed, legacy, available, already-designed, in-use, or prevailing. These terms aim to describe a silicon die design that is already in existence and potentially in use at the time the modification, the impairment, and/or the chopping-out is implemented, regardless of when the design was originally created or when this patent application was filed.

In some implementations of the MxPU, a design of the MxPU was derived from an established CPU or GPU design, and the MxPU retains memory controllers of the established CPU or GPU design. The MxPU may be derived from an established CPU/GPU design such that it is manufactured with one or more repurposed areas while retaining the memory controllers supported by the established design. By repurposing one or more processing cores as impaired areas without affecting the memory controller operation, the design may be optimized for its intended purpose in scenarios that require retaining maximum memory capacity. Non-limiting examples of intended purposes include memory pool, memory switch, memory processor, or protocol translator. This modification may allow for more cost-effective production of the MxPU while preserving its ability to provision a larger memory capacity, a capability inherent to the established CPU/GPU design and beneficial for memory-intensive applications and workloads.

In some implementations of the MxPU, a design of the MxPU was derived from an established CPU or GPU design that included CXL root ports, and the MxPU retains the CXL root ports of the established CPU or GPU design. For the purpose of designing and manufacturing a memory processor or a memory switch, repurposing processing cores as impaired areas without affecting the CXL ports of the established CPU/GPU design may enable creating additional stock keeping units (SKUs) with minimal or no redesign of the floorplan and with minimal changes to the masks used during manufacturing. This approach may allow manufacturers to obtain additional product variants without incurring the full costs associated with rebuilding the floorplan layout, potentially reducing time-to-market and development expenses while maintaining the connectivity capabilities of the original design.

In some implementations, the MxPU further comprises an inter-socket link (ISoL) configured to utilize addresses within the first physical address space, wherein the ISoL couples the MxPU to a second MxPU and enables the processing cores to access a second memory coupled via second memory channels to the second MxPU. The MxPU may include an ISoL to support scaling from a single MxPU to a cluster of interconnected homogeneous or heterogeneous MxPUs. An ISoL may enable scaling across multiple MxPU instances, coherent shared memory across sockets, low-latency atomic operations, and workload migration. It may expose remote high-bandwidth memory and I/O, support composable disaggregation, and/or provide redundant paths for RAS features such as fail-over and hot-service. Partitioning target functionality across xPU instances may improve manufacturing yield, allow mixed process nodes, and lower power per bit.

In some implementations of the MxPU, the ISoL is selected from an interconnect based on: AMD Infinity Fabric, NVIDIA NVLink-C2C, ARM CHI C2C, or Intel UPI. The ISoL may be implemented utilizing various industry interconnect technologies, wherein the selection of ISoL technology may depend on the processor architecture of the MxPU and the desired system topology.

In some implementations of the MxPU, the communication port comprises the CXL endpoint, and further comprising a second CXL endpoint configured to communicate with a second entity, wherein the second entity utilizes addresses within a third physical address space, and the RPU is further configured to translate physical addresses within the third physical address space to physical addresses within the first physical address space to enable the second entity to access at least a portion of the memory. The MxPU may include CXL endpoints to support multi-headed configurations wherein external entities can simultaneously access the MxPU's memory resources. The RPU may maintain separate translation contexts for the coupled entities, performing physical address translations from the entities'physical address spaces to the MxPU's first physical address space. This multi-headed capability may enable the MxPU to function as a memory pool resource, providing memory services to hosts while maintaining proper isolation and access control between different entities.

In some implementations of the MxPU, the repurposed area comprises the at least one of the communication port or the RPU and a remaining unassigned area, and wherein the remaining unassigned area is utilized for at least one of on-die decoupling capacitors or spare standard cells. The repurposed area may include not only functional blocks such as the communication port or RPU but also remaining unassigned silicon area. This remaining unassigned area may be utilized for on-die decoupling capacitors, which may help improve power delivery stability and reduce noise in the power distribution network. Alternatively or additionally, the remaining unassigned area may be reserved for spare standard cells or Engineering Change Order (ECO) cells, providing flexibility for late-stage design fixes or modifications without requiring substantial layout changes, and thereby increasing the utility of the repurposed area while maintaining design flexibility.

In some implementations of the MxPU, the communication port comprises an NVLink port, and the second physical address space comprises a network address space. When the MxPU is configured with an NVLink port, the second physical address space may include a network address space utilized by NVLink-connected devices. The network address space may enable NVLink-based devices to address memory resources across the NVLink fabric, wherein the RPU may translate between the network address space and the MxPU's first physical address space.

In some implementations of the MxPU, the first physical address space comprises a GPU physical address space, and the RPU is further configured to translate physical addresses within the network address space to physical addresses within the GPU physical address space. In MxPUs that are based on GPUs, the RPU may function similarly to a link translation lookaside buffer (TLB), translating between network addresses utilized by remote NVLink devices and local GPU physical addresses utilized by the MxPU's processing cores and memory controllers. This translation may enable remote NVLink peers to access the MxPU's GPU memory resources.

In some implementations of the MxPU, the MxPU further comprises a second silicon die coupled to the silicon die within an integrated circuit package of the MxPU, and wherein the second silicon die comprises an NVLink Fusion chiplet that includes the NVLink port and at least a portion of the RPU. The NVLink Fusion chiplet may provide a dedicated die implementing the NVLink port, the RPU, and associated translation logic, coupled to the processor die within the same integrated circuit package. This chiplet-based approach may enable the MxPU to incorporate NVLink connectivity and address translation capabilities without modifying the processor die's floorplan beyond the repurposed area's interconnect interface. In some examples, the NVLink Fusion chiplet may be fabricated utilizing a different process node than the processor die, potentially allowing optimization of the NVLink interface for power or performance independently of the processor die's process technology. Alternatively, the RPU, the NVLink port, and associated CXL interface logic may be implemented as functional blocks on the same die as the processor, or split between silicon dies or chiplets inside the integrated circuit package of the MxPU.

In some implementations, the MxPU further comprises a CXL root port coupled to the coherent interconnect, wherein the RPU is configured to translate messages received via the NVLink port into messages based on CXL, and to forward the translated messages to the coherent interconnect via the CXL root port. The RPU may utilize CXL as an intermediate protocol to bridge between the NVLink domain and the protocol utilized by the coherent interconnect. The RPU may expose a CXL device, such as a CXL endpoint (CXL EP) implementing a Type-1 or a Type-2 CXL device, to the processor via the CXL root port. The CXL root port may be coupled to the coherent interconnect via a coherent interconnect interface, such as a ring-to-CXL (R2CXL) interface, that may communicate with the coherent interconnect according to a protocol utilized by the coherent interconnect. This intermediate translation approach may enable the RPU to leverage existing CXL protocol infrastructure and interfaces already present in the processor design, potentially reducing the complexity of integrating NVLink connectivity into the MxPU. In some examples, the R2CXL interconnect interface may reside within the RPU, complementing the translation path from NVLink, via CXL, to traffic conforming to the protocol utilized by the coherent interconnect.

In some implementations of the MxPU, the MxPU comprises NVLink ports, and the repurposed area accommodates at least some of the NVLink ports. When the MxPU is configured as a processor or a switch with NVLink ports, the repurposed area may accommodate NVLink ports rather than a single port. This multi-port configuration may enable the MxPU to function as a multi-port GPU or an NVLink-based switch device, facilitating interconnection between NVLink-enabled devices in a fabric topology. The NVLink ports may share the RPU resources for address translation and protocol handling.

In some implementations of the MxPU, the second physical address space comprises a Network Physical Address (NPA) space, and the messages comprise UALink-based messages. When the MxPU includes a UALink port, the second physical address space may include an NPA space as defined by the UALink address model. UALink-based messages may conform to UPLI and may include read, write, and atomic operations that carry NPA addresses. The RPU may translate between the NPA space and the MxPU's first physical address space to enable UALink-connected accelerators to access the MxPU's memory resources.

In some implementations of the MxPU, the second physical address space comprises a Network Physical Address (NPA) space, the first physical address space comprises a System Physical Address (SPA) space, and wherein the RPU is further configured to translate physical addresses within the NPA space to physical addresses within the SPA space. In MxPUs that are based on UALink accelerators, the RPU may function as a link MMU that translates NPAs received from remote UALink accelerators to local SPAs utilized by the MxPU's processing cores and memory controllers. This NPA-to-SPA translation may enable the MxPU to participate in a UALink fabric while maintaining its local SPA-based memory addressing scheme.

In some implementations of the MxPU, the second physical address space comprises a Network Physical Address (NPA) space, the first physical address space comprises a Host Physical Address (HPA) space, and wherein the RPU is configured to translate physical addresses within the NPA space to physical addresses within the HPA space. In MxPUs that are based on CPUs, the RPU may translate NPAs received from UALink-connected accelerators to HPAs utilized by the MxPU's processing cores and memory controllers. This configuration may enable a CPU-based MxPU to serve as a UALink switch or a UALink-attached memory resource, providing UALink accelerators with access to the MxPU's host memory via NPA-to-HPA translations.

In some implementations of the MxPU, the MxPU comprises UALink ports, and the repurposed area accommodates at least some of the UALink ports. When the MxPU is configured to operate similarly to a UALink switch, the repurposed area may accommodate UALink ports rather than a single port, which may facilitate interconnection between UALink-enabled devices in a fabric topology. UALink ports may share the RPU resources for address translation and protocol handling.

In some implementations of the MxPU, the memory located outside the MxPU comprises at least 8 GB of dynamic random-access memory (DRAM) coupled via the memory channels, and the communication port comprises CXL endpoints located in the repurposed area, enabling the MxPU to function as a CXL Multi-Headed Device (MHD). The MxPU may be configured as a CXL Multi-Headed Device (MHD) by incorporating CXL endpoints within the repurposed area. This MHD configuration may allow external hosts to simultaneously access the MxPU's memory resources through different CXL connections. Different CXL endpoints may have different address translation contexts managed by the RPU, enabling isolated access to different portions of the DRAM or shared access with appropriate coherency mechanisms. Additionally or alternatively, the repurposed area may be sufficiently large to accommodate both the communication port and the RPU, rather than just one or the other. This configuration may enable the MxPU to implement CXL or UALink functionality within the repurposed silicon area, potentially enabling and/or enhancing memory pooling or switching capabilities while maintaining the original footprint of the silicon die.

The following method claim describes a design and manufacturing approach for creating processor device variants with improved yield by repurposing silicon die areas previously allocated to processing cores. By identifying areas of a processor design for repurposing, manufacturers may create new processor variants that accommodate communication ports and address translation units within the repurposed areas, without requiring a full redesign of the processor die.

In various implementations, a method for improving manufacturing yield of processor devices, comprising: identifying at least one processing core area in a processor design for repurposing as an impaired area; configuring the processor design to exclude the at least one processing core area from functional testing requirements while retaining a same die size; implementing at least one of a communication port or a resource provisioning unit (RPU) in the impaired area, wherein the communication port is selected from a Compute Express Link (CXL) endpoint, a CXL switch port, an NVLink port, or a UALink port, and the RPU is configured to translate between physical addresses associated with different physical address spaces; and manufacturing processor devices based on the configured processor design, whereby defects occurring within the impaired area do not cause rejection of the processor devices during production testing. This method may enable improved manufacturing yield by identifying and repurposing certain areas of a processor die as potential impaired areas that are excluded from stringent functional testing requirements. By implementing alternative functional blocks such as communication ports or RPUs within these repurposed impaired areas, the method may create valuable product variants while reducing the silicon area that must pass stringent functional tests. For example, processing cores are typically tested to operate correctly at high clock rates that significantly exceed the typical clock rates required for communication ports and RPUs. Defects that would normally cause die rejection if they occur in processing cores may be tolerated when they occur in alternative functional blocks in the repurposed impaired area, potentially increasing the percentage of usable dies from the wafers.

The implementations of the following method describe operational aspects of an MxPU derived from an established processor design. During operation, the MxPU utilizes processing cores and a coherent interconnect to access memory via memory channels, while a communication port receives messages from external entities utilizing a different physical address space. A resource provisioning unit (RPU) performs the translations between the external address space and the MxPU's internal address space, enabling the MxPU to serve as a memory resource, a protocol translator, or a switch for externally coupled devices. At least one of the communication port or the RPU operates from a silicon die area that was originally designed for processing cores in the established processor design, thereby leveraging the repurposed area for alternative functionality.

In various implementations, a method for operating a modified processing unit (MxPU), comprising: utilizing, by processing cores of the MxPU coupled via a coherent interconnect, a first physical address space to access memory located outside the MxPU via memory channels; receiving, via a communication port selected from a Compute Express Link (CXL) endpoint, a CXL switch port, an NVLink port, or a UALink port, messages comprising physical addresses within a second physical address space; translating, by a resource provisioning unit (RPU), physical addresses within the second physical address space to physical addresses within the first physical address space; and operating at least one of the communication port or the RPU from a silicon die area that excludes at least one processing core present in an established processor design from which the MxPU was derived. In some implementations, the RPU may dynamically translate between the address spaces during operation, enabling the MxPU to simultaneously serve its local processing workloads and provide memory services or connectivity to externally coupled devices. The silicon die area from which the communication port or RPU operates may correspond to a repurposed area or a repurposed impaired area, wherein processing cores from the established processor design have been excluded, replaced, or electrically disabled to accommodate the alternative functional blocks.

In some implementations of the method, the communication port comprises the CXL endpoint configured to communicate with an entity according to a protocol based on CXL, the first physical address space is a first Host Physical Address (HPA) space utilized by the processing cores, the second physical address space is a second Host Physical Address (HPA) space utilized by the entity, and the translating comprises performing host-to-host physical address translations from the second HPA space to the first HPA space. The method may include performing host-to-host physical address translations that enable external entities to access the MxPU's memory resources utilizing protocols based on CXL. These translations may dynamically map between different HPA spaces during operation, allowing the MxPU to serve memory access requests from external hosts while maintaining physical address space isolation and proper access control.

In some implementations, the method further comprises receiving, via a second communication port, second messages comprising physical addresses within a third physical address space utilized by a second entity; and translating, by the RPU, physical addresses within the third physical address space to physical addresses within the first physical address space to enable the second entity to access at least a portion of the memory. The method may include supporting multi-headed operations wherein external entities simultaneously access the MxPU's memory resources. The RPU may maintain separate translation contexts and perform different address translations for different coupled entities during operation, enabling the MxPU to function as a memory pool resource with concurrent access capabilities while maintaining isolation between different entities'memory accesses.

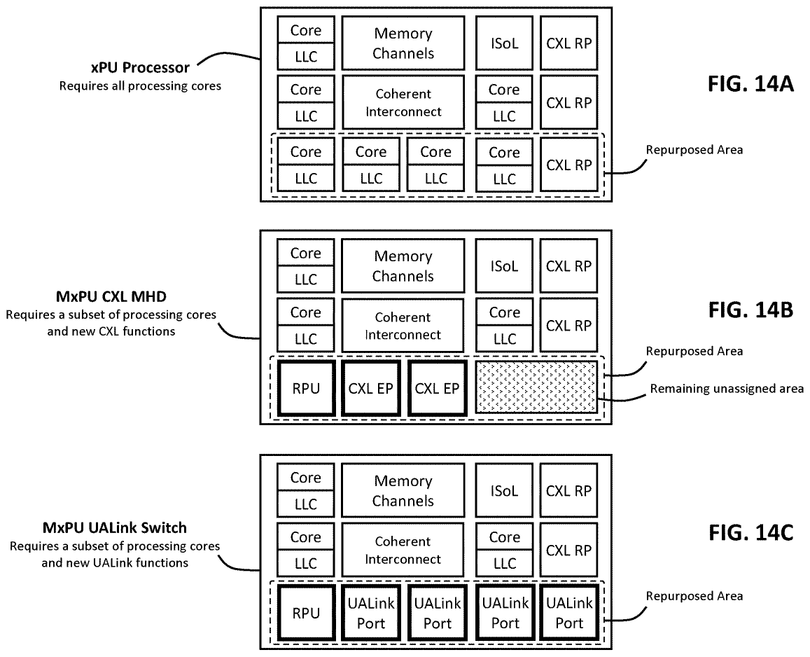

FIG. 14A illustrates an example of a silicon device functioning as an established xPU design before modification, which may include processing cores associated with Last Level Caches (LLCs), coupled through a cache coherent interconnect. The device may also include memory channels for external memory access, an inter-socket link (ISoL) for multi-processor configurations, and CXL root ports (RPs) for peripheral connectivity. The area identified as the repurposed area shown contains four processing cores with their associated LLC and one CXL RP, representing silicon area that may be repurposed in modified designs while maintaining the original die dimensions. The repurposed area may be used to create MxPU derivatives of the original xPU design, or may serve other purposes such as improving manufacturing yield.

FIG. 14B illustrates an example of a silicon device capable of providing the functionality of a CXL Multi-Headed Device (MHD) when coupled to memory, wherein the repurposed area may accommodate an RPU and CXL endpoints instead of the processing cores and optionally CXL root ports that originally resided in the repurposed area as illustrated in FIG. 14A. The RPU performs physical address translations that enable hosts coupled to the CXL MHD MxPU to access memory via the MxPU memory channels. The remaining silicon area within the repurposed area may be utilized for on-die decoupling capacitors or spare/ECO standard cells, maximizing the utility of the repurposed space, which may enable the device to serve as a CXL-attached memory resource for external hosts while maintaining compatibility with the original die size and package.

FIG. 14C illustrates an example of a silicon device (MxPU) capable of providing the functionality of a UALink Switch, wherein the repurposed area may accommodate an RPU and UALink ports instead of the processing cores and the CXL root port that originally resided in the repurposed area. The four UALink ports shown may provide connectivity to UALink-enabled devices, with the RPU performing physical address translations, such as from UALink Network Physical Addresses (NPAs) to MxPU Host Physical Addresses (HPAs) that enable UALink Accelerators coupled to the MxPU to access memory via the MxPU memory channels. The RPU may further enable UALink Accelerators to communicate with each other by translating UALink messages to MxPU interconnect messages and relaying the translated messages between UALink ports. The MHD MxPU example and the Switch MxPU example demonstrate how the same base silicon design may be adapted for different connectivity standards by implementing appropriate functional blocks within the repurposed area.

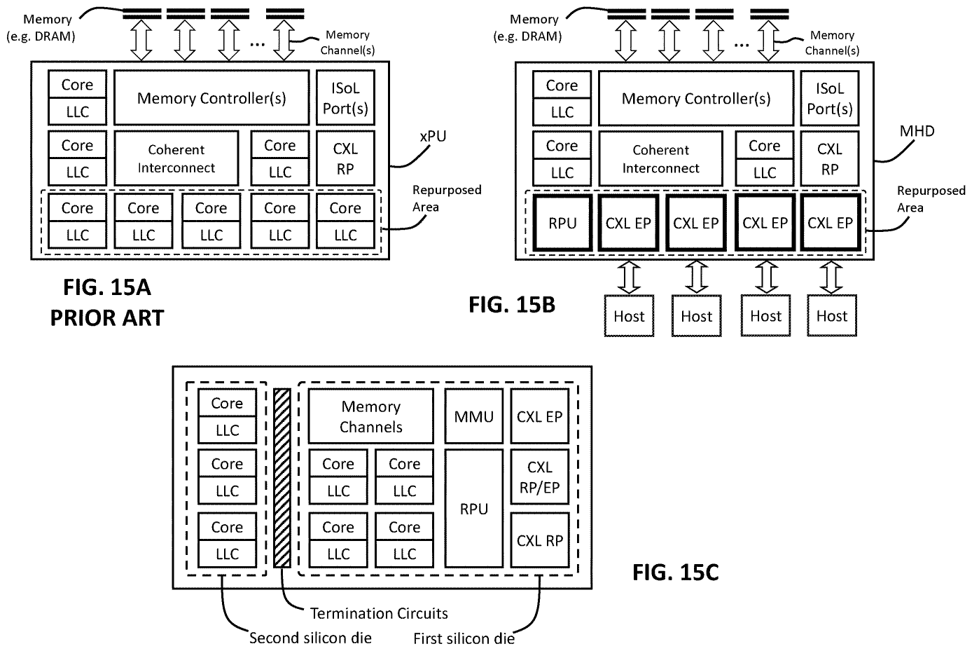

FIG. 15A illustrates a system comprising a prior art xPU design, such as a processor design (e.g., CPU or GPU), that includes a repurposed area (which may also be referred to as a designated area). The xPU may be based on an established xPU design, such as an established processor design, with memory controller(s) coupled to memory channels and to memory such as DRAM, ISoL port(s) such as Intel UPI port(s), a CXL root port (RP), a coherent interconnect, processing cores, and last level cache (LLC) slices, wherein at least some of the processing cores and/or the LLC slices may reside in a repurposed area of the xPU. The repurposed area may represent an intentional reservation of silicon area, such as in a die floorplan of an established xPU design, that may be intentionally disabled for product binning/segmentation, such as for creating different types of MxPUs, or utilized for different purposes, such as in different product Stock Keeping Units (SKUs), wherein different product SKUs may vary by the number of processing cores in the repurposed area, may vary by the type and mix of processing cores in the repurposed area (e.g., combinations of performance cores and efficiency cores, such as P-cores and E-cores, or big/little cores), or may vary by the operating frequency of the processing cores in the repurposed area. The repurposed area may be a repurposed impaired area of an xPU silicon die that may be limited in performance, e.g., limited in operating frequency that may fit slower processing cores, or may fit other functions of an xPU with lower performance requirements, such as communication ports (e.g., CXL ports) or miscellaneous non-core (e.g., uncore) functions.

FIG. 15B illustrates an example of a Multi-Headed Device (MHD) implementation that may be based on an xPU or an MxPU design, such as a processor design (e.g., CPU or GPU), that includes a repurposed area. The MHD may include processing cores, last level cache (LLC) slices, memory controller(s) coupled to memory channels and to memory such as DRAM, ISoL port(s) such as Intel UPI port(s), a CXL root port (RP), a coherent interconnect, and a repurposed area where processing cores of the original xPU may be replaced with one or more CXL endpoint ports, creating an MHD. The repurposed area may also include a Resource Provisioning Unit (RPU) that may enable physical address translations between physical address spaces, such as between Host Physical Address (HPA) spaces. The repurposed area may be modified to accommodate CXL endpoints that may replace processing cores, enabling MHD functionality based on a processor architecture. In some examples, the xPU may be based on an established xPU design, such as an established processor design (e.g., established CPU design or established GPU design).

FIG. 15C illustrates an example of a processor derived from an established CPU design, wherein termination circuits are implemented at interfaces between different silicon die areas. The processor may be manufactured using one of two exemplary approaches. A first approach is to remove a portion of the silicon design during the floorplan partitioning stage, resulting in a chip design that excludes the unnecessary part. A second approach is to physically chop the unnecessary part at the dicing stage, which includes physically cutting away a portion of the manufactured chip. The illustrated processor includes a first silicon die area comprising Memory Channels, an MMU, one or more CXL EPs, one or more CXL RPs, processing cores with LLCs, and an RPU. A second silicon die area comprises additional processing cores with their associated LLCs. To preserve the integrity of the remaining components (whether the portion is removed at the floorplan partitioning stage or at the dicing stage), termination circuits are added between the first and second silicon die areas to block signal propagation beyond specific physical points. The termination circuits are used to properly end signal paths, preventing reflections or unintended signal propagation. By adding the termination circuits at potential cut points, the design becomes more tolerant to variations in the physical dicing process, as signals are cleanly terminated regardless of the exact cut location within a certain range. Therefore, adding the termination circuits may also increase the permissible variance in the dicing process compared to an alternative solution that does not add such termination circuits.

The termination circuits may be implemented during the floorplan partitioning stage, which includes the systematic division of the integrated circuit design to large functional blocks. This implementation of termination circuits enables the creation of one or more chip versions with distinct cutting locations. For example, a first version of the integrated circuit may be designed with termination circuits positioned for cutting at a first predetermined location between the first and second silicon die areas, and a second version of the integrated circuit may be designed with termination circuits positioned for cutting at a second predetermined location. The termination circuits may be added adjacent to the connection or cutting points between the silicon die areas so that signals are properly terminated close to where they may be interrupted. This adjacency minimizes the length of unterminated signal paths, thereby mitigating risks associated with signal integrity issues and unintended electromagnetic coupling effects. In the illustrated example, the termination circuits form an interface region between the first silicon die area containing the communication ports (CXL EP, CXL RP/EP, CXL RP) and the second silicon die area containing the additional processing cores.

Optionally, at least some of the termination circuits incorporate an “enable” input that controls their operation when activated. The functionality of the termination circuits is such that when the enable input is activated, the termination circuit effectively blocks signal propagation between the first and second silicon die areas, whereas when the enable input is deactivated, the circuit allows signals to pass through unimpeded. This “enable” functionality that controls the chip's behavior allows for the selective activation or deactivation of certain signal paths depending on which version of the chip is being produced or utilized. For example, if there is a need to chop-out the second silicon die area containing optional processing cores coupled to the coherent interconnect, then the interconnect loops must be closed such that data can still circulate through the remaining portions of the coherent interconnect in the first silicon die area, maintaining the chip's functionality despite the removal of the second silicon die area. Thus, in this example the termination circuits operate in two modes: either allowing signal passage to the second silicon die area that exists after it, or performing a turnaround for the data arriving on the interconnect paths, effectively shortening the path logically. Additionally, the length of the conductors connecting the termination circuits to the optional logic in the second silicon die area (that may be chopped from a certain version of the chip) may be changed according to the required tolerance and properties of the dicing stage. Typically, signal ends are not left floating, especially not inputs that can lead to unstable or metastable states. Therefore, pullup or pulldown termination circuits are placed on the inputs so that the input is in a defined logical state. These circuits are designed such that they handle input signals even if they are floating due to the second silicon die area being cut. On the output, the termination circuits block the signals to prevent antennas or to prevent short circuits when the signals themselves were blocked already in the logical termination block.

One of the possible goals during the modification of an established CPU design to create the processor illustrated in FIG. 15C may be to modify the RTL as little as possible. RTL is a design abstraction representing the registers of a digital circuit and the operations performed on signals as they pass between these registers. Modifying RTL can have far-reaching effects on the chip's functionality and timing, and changes typically require re-verification of the entire design and re-synthesis of the affected portions. Thus, modifying the RTL can be time-consuming and may introduce new issues. By minimizing RTL changes, the design process becomes more efficient and less prone to errors. Additionally, large chip designs are often divided to smaller, manageable blocks that can be designed and synthesized separately, which allows for parallel development and easier management of complex designs. By implementing the chopping at the floorplan partitioning stage between the first and second silicon die areas, it is possible to isolate the effects to specific blocks, leaving others unchanged, which minimizes the scope of modifications and reduces the overall impact on the design and verification process. In the illustrated example, the first silicon die area retains the communication ports (CXL EP, CXL RP/EP, CXL RP) and the RPU for the processor's operation, while the second silicon die area containing additional processing cores may be optionally removed based on product requirements.

The CPU's market is significantly larger than a memory pool controller's market (such as an MxPU in this context), which would probably result in a greater variety of CPU configurations compared to MxPUs. CPU variations may include differences in cache sizes, number of cores, number and type of ports, clock speeds (e.g., higher frequency for enhanced performance for a busy host, and a lower frequency for improved power efficiency for a station with a low load), and/or support for specialized instructions (e.g., Advanced Vector Extensions (AVX), TensorFlow operations). Additionally, some CPUs may integrate accelerators like GPUs, Tensor Processing Units (TPUs), or FPGAs to further enhance computational capabilities. This diversity in CPU configurations allows for various combinations of essentially the same MxPU with different types of CPUs to address a wide range of use cases. In large data centers, such combinations may improve HPC tasks, virtualized environments, and/or storage and data management. For AI model training and utilization, these combinations can support tasks such as distributed training, AI inference services, model optimization, or model fine-tuning. As a result, the flexibility provided by the MxPU in managing address translations and resource provisioning can enhance the efficiency and performance of systems leveraging diverse CPU configurations.

The MxPU enables the provisioning of CXL memory to other hosts via CXL endpoints, a capability not present in the currently available CPUs. The quantity of MxPUs required in the system can be determined by the number of ports required to establish the connections with the hosts, while the remaining processors may be CPUs or GPUs lacking CXL endpoints. However, in scenarios necessitating a high-fanout, multi-tier memory pool, the system may incorporate multiple MxPUs to increase the number of CXL EPs through which additional hosts can be coupled to the memory pool. This configuration allows for the expansion of the memory pool's connectivity and facilitates efficient memory sharing among a larger number of coupled hosts.

The following examples are three use-cases of combining an MxPU with multiple CPUs for large data centers: In a first example, combining one MxPU with multiple CPUs, such as seven CPUs, can leverage the high parallel processing capabilities required for HPC tasks; the MxPU can handle intensive resource management and address translations between multiple CPUs, optimizing performance for simulations, scientific computations, and data analysis. In a second example, combining one MxPU with three CPUs can be useful for data centers running multiple virtual machines; the MxPU can manage memory and resource allocation efficiently, facilitating isolation and performance stability across virtualized workloads. And in a third example, combining one MxPU with one CPU may be suitable for tasks like data indexing, search, and/or retrieval in large storage systems; the MxPU can facilitate quick address translations and resource allocation, improving data access speeds.

The following are three use case examples of combining an MxPU with multiple CPUs for AI model training and utilization: In a first example, combining one or few MxPUs with multiple CPUs, such as one MxPU with seven CPUs can support distributed training of large AI models, wherein multiple CPUs handle different portions of the dataset; the MxPU may manage memory coherence and data flow between CPUs, facilitating efficient training. In a second example, combining one MxPU with three CPUs may be suitable for deploying AI models for inference in real-time applications; the MxPU can balance the load across multiple CPUs, improving response times and throughput for inference requests. And in a third example, combining one MxPU with one CPU may be useful for tasks like model pruning, quantization, and/or fine-tuning on specific datasets; the MxPU may provide efficient memory management and computational resource allocation, speeding up the optimization process.

In various implementations, a system comprising: a first apparatus comprising: memory channels, a first Compute Express Link (CXL) endpoint (EP), a first resource provisioning unit (RPU), and a first inter-socket link (ISoL) port; memory having a capacity of at least 8 GB, coupled via the memory channels; a second apparatus comprising: a second CXL EP, a second RPU, and a second ISoL port; wherein the first ISoL port is coupled to the second ISoL port, and the first and second apparatuses utilize a first host physical address (HPA) space; wherein the first RPU is configured to perform first host-to-host physical address translations (HHPAT) to enable a first host, coupled to the first CXL EP via a first CXL.mem interface, to utilize a first portion of the memory; and wherein the second RPU is configured to perform second HHPAT to enable a second host, coupled to the second CXL EP via a second CXL.mem interface, to utilize a second portion of the memory.

In some implementations of the system, the first and second hosts utilize second and third HPA spaces, respectively, the first HHPAT translate physical addresses within the second HPA space to physical addresses within the first HPA space, and the second HHPAT translate physical addresses within the third HPA space to physical addresses within the first HPA space.

In some implementations of the system, the system functions as a memory pool, the memory comprises dynamic random-access memory (DRAM), the second MxPU further comprises second memory channels, the second memory channels are coupled to at least 8 GB of second DRAM; and wherein the second and third address translations enable the first and second hosts, respectively, to utilize the second DRAM.

In some implementations, the system further comprises third and fourth MxPUs coupled to the first and second MxPUs over additional ISoLs; the third and fourth MxPUs comprise third and fourth CXL EPs and third and fourth RPUs, respectively; the third and fourth CXL EPs are configured to be coupled to third and fourth hosts via third and fourth CXL.mem interfaces; and wherein the system enables the third and fourth hosts to utilize at least a portion of the memory.

In some implementations, the system further comprises third and fourth MxPUs coupled to the first and second MxPUs over additional ISoLs, wherein the ISoL and the additional ISoLs are interconnected by at least one Node Controller.

In some implementations of the system, the first and second MxPUs are selected from one of (a) modified Intel CPUs, and the first and second ISoLs are based on Intel's Ultra Path Interconnect (UPI), (b) modified AMD CPUs, and the first and second ISoLs are Infinity Fabric or External Global Memory Interconnect (xGMI), or (c) modified Nvidia GPUs, and the first and second ISoLs are Nvidia NVLink.

In some implementations of the system, the first MxPU further comprises a first memory management unit (MMU) configured to map virtual addresses, utilized by an operating system of the first MxPU, to physical addresses within the first HPA space; and the second MxPU further comprises a second MMU configured to map virtual addresses, utilized by an operating system of the second MxPU, to physical addresses within the second HPA space.

In some implementations of the system, the system is configured to support training of a Mixture-of-Experts (MoE) AI model; and wherein the first and second portions of the memory are allocated to different experts of the MoE model.

In some implementations of the system, the first and second RPUs are further configured to create secure memory enclaves within the memory, thereby providing confidential computing environments for the first and second hosts.

In various implementations, a method comprising: utilizing a first host physical address (HPA) space, by first and second apparatuses coupled over an inter-socket link (ISoL), to access memory having a capacity of at least 8 GB via memory channels of the first apparatus; performing first host-to-host physical address translations (HHPAT) to enable a first application host, coupled to a first Compute Express Link (CXL) endpoint (EP) of the first apparatus via a first CXL.mem interface, to utilize a first portion the memory; and performing second HHPAT to enable a second application host, coupled to a second CXL EP of the second apparatus via a second CXL.mem interface, to utilize a second portion the memory. An application host may refer to a host that executes workloads or applications that utilize one or more CXL protocols to support the application host's computational tasks. The executed workloads or applications may access memory, maintain cache coherency, offload computations, or perform other operations over one or more CXL links.

In some implementations of the method, the first application host utilizes a second HPA space, the second application host utilizes a third HPA space, the first HHPAT is translating physical addresses within the second HPA space to physical addresses within the first HPA space, and the second HHPAT is translating physical addresses within the third HPA space to physical addresses within the first HPA space.

In some implementations, the method further comprises monitoring power consumption of the memory and dynamically adjusting the first and second portions of the memory allocated to the first and second application hosts to optimize power efficiency.

In some implementations of the method, the first HPA space is further utilized to access Storage Class Memory (SCM); and further comprising utilizing a tiered memory solution, based on the DRAM coupled to the memory channels and the SCM, to accelerate training of a Large Language Model (LLM).

In various implementations, a system comprising: a processing unit (xPU) comprising: processing cores, a first inter-socket link (ISoL) port, and first memory channels; wherein the first memory channels are coupled to a first memory having a capacity of at least 8 GB; an apparatus comprising: a Compute Express Link (CXL) endpoint (EP), a resource provisioning unit (RPU), a second ISoL port, and second memory channels; wherein the second memory channels are coupled to a second memory having a capacity of at least 8 GB, the first ISoL port is coupled to the second ISoL port, and the apparatus and the xPU utilize a first host physical address (HPA) space; and wherein the RPU is configured to perform host-to-host physical address translations (HHPAT) to enable an application host, communicating with the CXL EP based on CXL.mem, to utilize portions of the first memory and the second memory.

In some implementations of the system, the first and second memories are dynamic random-access memory (DRAM), the application host utilizes a second HPA space, and the HHPAT translate physical addresses within the second HPA space to physical addresses within the first HPA space.

In some implementations of the system, the system functions as a memory pool; and further comprising second and third xPUs coupled to the apparatus and the xPU over additional inter-socket links; the second and third xPUs comprise memory channels coupled to at least 8 GB of third DRAM and fourth DRAM, respectively; and whereby the HHPAT further enables the application host to utilize the third DRAM and the fourth DRAM.

In some implementations of the system, the apparatus further comprises a CXL RP configured to be coupled to a CXL memory expander utilizing another CXL.mem interface; and wherein the HHPAT further enables the application host to utilize memory of the memory expander.

In some implementations of the system, the xPU further comprises a CXL root port (RP), and further comprising a CXL memory expander coupled to the CXL RP of the xPU; and wherein the HHPAT enable the application host to utilize memory of the memory expander while communicating based on the CXL.mem and via the first and second ISoLs.

In some implementations of the system, the apparatus and the xPU further comprise memory management units (MMUs) configured to translate virtual addresses within virtual address spaces, utilized by at least one operating system of the xPU, to physical addresses within the first HPA space.

In some implementations of the system, the system is configured to support training of a Mixture-of-Experts (MoE) AI model; and wherein the first and second portions of the memory are allocated to different experts of the MoE model.

In some implementations of the system, the RPU is further configured to create a secure memory enclave within the memory, thereby providing confidential computing environments for the application host.

In various implementations, a method comprising: utilizing a first host physical address (HPA) space by an apparatus and a processing unit (xPU) coupled over an inter-socket link (ISoL); communicating, via first memory channels of the xPU, with a first memory having a capacity of at least 8 GB; communicating, via second memory channels of the apparatus, with a second memory having a capacity of at least 8 GB; communicating with an application host via a Compute Express Link (CXL) endpoint (EP) of the apparatus based on CXL.mem, whereby the application host utilizes a second HPA space; and enabling the application host to utilize the first memory and the second memory based on host-to-host physical address translations (HHPAT) performed by a resource provisioning unit (RPU) associated with the apparatus.

In some implementations of the method, the HHPAT translate physical addresses within the second HPA space to physical addresses within the first HPA space; and further comprising utilizing machine learning-based controller to dynamically allocate portions of the first memory and the second memory to the application host based on real-time analysis of the application host's memory access patterns. Additionally or alternatively, the ISoL is tunneled over an Ultra Ethernet fabric, and further comprising providing a disaggregated memory solution in a hyperscale data center.

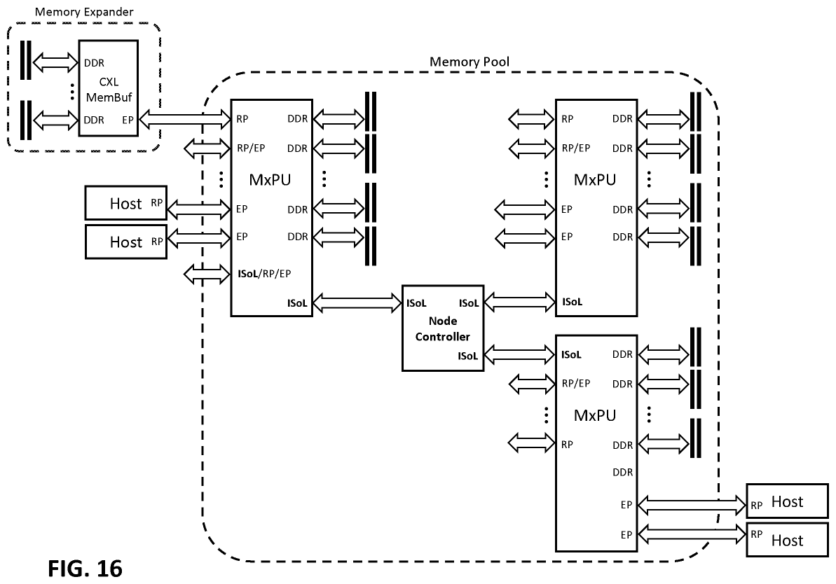

FIG. 16 illustrates an example of connecting at least some of the xPUs and/or MxPUs in the memory pool utilizing a node controller. Utilizing one or more node controllers enables scaling a single server to larger topologies than what is possible with just meshing processors to each other. When using a node controller, the xPUs are not necessarily connected directly to each other. In some examples, node controller refers to a hardware component in a multi-socket computing system that manages communication and coherency between sockets, where each socket typically holds or houses one or more CPUs or GPUs. The node controller primarily interfaces with ISoL, such as UPI, NVLink, or similar proprietary or standardized interconnects designed for high-bandwidth, low-latency communication between processors. Key functions of the node controller may include one or more of: facilitating data transfer and communication between sockets using ISoL protocols; maintaining cache coherency across CPUs or GPUs in different sockets; managing distributed memory access and coherency across the system's memory hierarchy; routing memory and I/O requests between local and remote sockets; implementing various cache coherency protocols suitable for multi-socket architectures; supporting different memory coherency models, including hardware-managed and software-managed approaches; providing address translation and memory mapping services across sockets; enabling scalability of multi-socket systems beyond typical two or four-socket configurations; optimizing data movement and reducing latency between sockets; supporting advanced features such as cache directory management or snoop filtering to improve system performance; facilitating load balancing and resource allocation across sockets; providing mechanisms for partitioning and isolation in multi-socket environments; and/or implementing security and access control features for inter-socket communication. The node controller may be integrated into the package of a CPU or GPU, implemented as a separate chip on the system board, or implemented utilizing a combination of on-die and off-die components. It may be designed to support various processor architectures and may incorporate programmable elements to allow for flexibility and feature updates.

In heterogeneous computing architectures, NVLink-based entities such as GPUs, accelerators, and NVLink switches may need to access resources coupled to CXL-based entities such as CXL hosts, CXL devices, CXL switches, or CXL-attached memory pools. NVLink-based protocols and CXL.io utilize different message formats, addressing schemes, and transaction semantics. NVLink-based requests may carry NVLink-based network addresses or GPU physical addresses within a first address space, while CXL.io requests may carry Host Physical Addresses (HPAs) within a second address space. A computer, which may be implemented as a processor, a switch, an RPU, a semiconductor device, a chiplet, an active cable, or other suitable device, may be positioned between an NVLink-based interface and a CXL.io interface to translate between these incompatible protocol domains. The computer may translate addresses, Tags, opcodes, and other fields, and may propagate QoS telemetry information carried in CDL fields of CXL.io UIO completions. The translation may be performed in one direction from NVLink to CXL.io, in the reverse direction from CXL.io to NVLink, or bidirectionally. In the reverse direction, the computer may generate CDL values in CXL.io UIO completions based on load or congestion information observed at the NVLink domain, even when the NVLink-based protocol does not natively carry CDL. Such CDL generation by a host-side entity may extend QoS telemetry capabilities beyond what CXL specifications define for CXL devices alone.

In various implementations, a method comprising: receiving, by a computer from a first entity via a first interface, an NVLink-based request comprising a first physical address; translating, by the computer, the NVLink-based request to a CXL.io request comprising a read-class Transaction Layer Packet (TLP) type and a second physical address, wherein CXL denotes Compute Express Link; sending, by the computer via a second interface, the CXL.io request to a second entity; receiving, by the computer from the second entity, a CXL.io completion comprising data and a Tag; translating, by the computer, the CXL.io completion to an NVLink-based response; and sending the NVLink-based response comprising the data to the first entity. The method may enable an NVLink-based entity, such as a GPU, an accelerator, or an NVLink switch, to access resources coupled to a CXL-based entity, such as a CXL host, a CXL device, a CXL switch, or a CXL-attached memory pool, by translating NVLink-based requests to CXL.io requests and translating CXL.io completions to NVLink-based responses. The computer may be a processor, a switch, an RPU, an active cable, or a semiconductor device positioned between the first entity and the second entity. The first interface may communicate according to an NVLink-based protocol, and the second interface may communicate according to CXL.io. The NVLink-based request may be an NVLink read request comprising fields such as SourceID, DestinationID, Address, Tag, and Length. The computer may translate the NVLink-based request to a CXL.io request comprising a read-class TLP type, which may be either a standard Memory Read (MRd) or a UIO Memory Read (UIOMRd). The CXL.io completion may be a CplD or a UIORdCplD, and may carry a CDL field when the UIO path is utilized. The computer may translate the data and Tag from the CXL.io completion into the NVLink-based response, reconstructing the NVLink response fields such as SourceID, DestinationID, and Tag for delivery to the first entity. In some examples, the computer may issue one or more CXL.io requests in response to an NVLink-based request, such as when splitting a large NVLink read into smaller CXL.io reads, or when prefetching data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCplD). UIO may be utilized when the path between the computer and the second entity supports Flit Mode and has UIO enabled. The UIOMRd may provide multi-path routing and out-of-order completion delivery capabilities. The UIORdCplD may include a CDL that carries QoS telemetry populated by the second entity or intermediate components.

In some implementations of the method, the CXL.io UIORdCplD comprises a CXL DevLoad (CDL) field, and wherein the computer performs at least one of: (i) translating information carried in the CDL to one or more fields of the NVLink-based response, or (ii) utilizing information carried in the CDL for at least one of throttling subsequent requests to the second entity or collecting Quality-of-Service (QoS) telemetry. The CDL may carry device load indicators such as light load, optimal load, moderate overload, or severe overload encodings. The computer may translate CDL information to reserved fields, vendor-defined fields, or custom fields of the NVLink-based response, or may collect CDL values over time to build a telemetry profile of the second entity. When utilizing CDL for throttling, the computer may reduce or modulate the rate of subsequent CXL.io requests based on the observed loading state.

In some implementations of the method, the CXL.io request comprises a CXL.io Memory Read (MRd) request, and the CXL.io completion comprises a CXL.io Completion with Data (CplD). The standard MRd and CplD types may be utilized when the second entity does not support UIO, when UIO is not enabled along the path, or when the path between the computer and the second entity does not utilize Flit Mode. The CplD does not include a CDL, and the computer may populate any QoS-related fields in the NVLink-based response with locally generated information or default values.

In some implementations of the method, the first physical address refers to an NVLink-based network address or a GPU physical address belonging to a first address space, the second physical address refers to a Host Physical Address (HPA) belonging to a second address space, wherein the NVLink-based request further comprises a first Tag, the computer assigns a second Tag to the CXL.io request, and the computer maintains a mapping between the first Tag and the second Tag to correlate the CXL.io completion with the NVLink-based request. The address translation may be implemented utilizing lookup tables, page tables, base-and-offset calculations, or programmable translation functions. The Tag mapping may be maintained in tracker entries, content-addressable memory, or translation tables. Upon receiving the CXL.io completion comprising the Tag, the computer may look up the corresponding first Tag and include it in the NVLink-based response for proper correlation at the first entity.

In some implementations of the method, the computer translates an NVLink-based request to CXL.io requests, the computer prefetches data from the second entity into a cache coupled to the computer, the first entity comprises at least one of a GPU, an accelerator, or an NVLink switch, and the second entity comprises at least one of a CXL host, a CXL device, or a CXL switch. The computer may split a large NVLink read request, such as a 256-byte read, to smaller CXL.io read requests, such as 64-byte or 128-byte reads, to accommodate differences in maximum payload sizes between the NVLink-based protocol and CXL.io. The computer may additionally prefetch data from addresses adjacent to or following the requested address, storing the prefetched data in the cache for servicing anticipated subsequent requests from the first entity with reduced latency.

In some implementations of the method, the computer translates error indications between the CXL.io completion and the NVLink-based response, comprising translating at least one of a poison indication or a data corruption indication. The poison indication in CXL.io may indicate that the data payload has been corrupted or is otherwise invalid. The computer may translate this indication to a corresponding error indication in the NVLink-based response, enabling the first entity to handle the error accordingly.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system, which may be configured for translation from NVLink-based traffic to CXL.io traffic, may include a semiconductor device, a bridge, a switch, or another apparatus that includes a first interface configured to communicate according to an NVLink-based protocol and a second interface configured to communicate according to CXL.io. A computer coupled between the interfaces may translate physical addresses between a first address space, such as an NVLink-based network address space or a GPU physical address space, and a second address space, such as an HPA space, associated with CXL.io. The computer may additionally translate between NVLink-based requests and other CXL sub-protocols such as CXL.mem or CXL.cache. The system may include optional switches on one or both sides of the computer, and the computer may be implemented in various form factors including a retimer BGA package. Such systems may serve heterogeneous AI computing architectures where NVLink-based accelerators need to access CXL-attached resources including memory expansion devices, coherent memory pools, or host-managed device memory.

In various implementations, a system comprising: a first interface configured to communicate according to an NVLink-based protocol with a first entity; a second interface configured to communicate according to CXL.io with a second entity, wherein CXL denotes Compute Express Link; and a computer coupled between the first and second interfaces, configured to translate between NVLink-based requests received via the first interface and CXL.io requests transmitted via the second interface; wherein the computer is further configured to translate physical addresses between a first address space associated with the NVLink-based protocol and a second address space associated with CXL.io. The system may enable an NVLink-based entity, such as a GPU or an accelerator, to access resources coupled to a CXL-based entity, such as a CXL host, a CXL device, or a CXL-attached memory device, through the translating computer. The first interface may be coupled to the first entity directly or through one or more NVLink switches, and the second interface may be coupled to the second entity directly or through one or more CXL switches. The computer may be implemented as a processor, a switch, an RPU, a semiconductor device, or an active cable. The first address space may include an NVLink-based network address space or a GPU physical address space, and the second address space may include an HPA space. The computer may translate addresses utilizing lookup tables, page tables, base-and-offset calculations, or programmable translation functions. In some examples, the computer may additionally translate between NVLink-based requests and CXL.mem requests or CXL.cache requests, enabling access to different types of CXL-attached resources through the same system.

In some implementations of the system, the computer is further configured to translate between NVLink-based requests and at least one of CXL.mem requests or CXL.cache requests via the second interface; and wherein the NVLink-based requests comprise requests associated with an artificial intelligence (AI) model, comprising at least one of: requests for AI model parameters stored in a CXL-attached memory device accessible via CXL.mem, or requests for AI model data maintained in a cache coherency domain accessible via CXL.cache. The multi-channel CXL translation may enable AI accelerators to access model parameters from CXL-attached memory expansion devices via CXL.mem, while simultaneously accessing coherent data structures via CXL.cache. The computer may select the appropriate CXL sub-protocol based on the address range, transaction type, or memory attributes of each NVLink-based request.

In some implementations of the system, the computer is implemented in an integrated circuit (IC) package having high-speed differential I/O balls positioned according to a ball grid array (BGA) layout defined by a retimer specification. The retimer BGA form factor may enable the computer to be deployed in existing retimer sockets within server platforms, utilizing a standardized physical footprint such as the PCIe 5.0, 6.0, or 7.0 Retimer Supplemental Features and Standard BGA Footprint Specification.

In some implementations of the system, the computer comprises a cache configured to store prefetched data received via the second interface, the prefetched data comprising data associated with an artificial intelligence (AI) model comprising at least one of model weights, activation tensors, or embedding tables, and the computer comprises at least one of a processor, a switch, or a Request Processing Unit (RPU). The cache may store prefetched AI model data to reduce latency for subsequent NVLink-based requests from the first entity. AI model weights, activation tensors, and embedding tables may exhibit predictable sequential access patterns that benefit from prefetching. The RPU, processor, or switch may manage the prefetch scheduling and cache allocation policies.

In some implementations of the system, one or more NVLink switches are positioned between the first interface and the first entity, one or more CXL switches are positioned between the second interface and the second entity, and the first entity comprises an AI accelerator that processes an artificial intelligence (AI) model distributed across AI accelerators coupled via the one or more NVLink switches. The NVLink switches may couple AI accelerators that collectively process a distributed AI model, such as when model parameters or activations are partitioned across accelerators using model parallelism, tensor parallelism, or pipeline parallelism. The CXL switches may couple the second interface to one or more CXL-attached memory devices, memory pools, or hosts that store portions of the AI model data.

In some implementations, translation may be performed from CXL.io traffic to NVLink-based traffic. A first entity, such as a CXL host, may initiate CXL.io read requests targeting resources coupled to a second entity, such as a GPU, that communicates according to an NVLink-based protocol. The computer may translate CXL.io requests to NVLink-based requests and translate NVLink-based responses to CXL.io completions. The computer may determine NVLink routing fields such as SourceID and DestinationID based on routing information, since CXL.io requests do not natively carry NVLink routing fields. Additionally, when translating to CXL.io UIO completions such as UIORdCplD, the computer may populate a CDL field with QoS telemetry information derived from the NVLink domain, from locally observed load or congestion conditions, or from information carried in the NVLink-based response. This CDL generation by a host-side or bridge-side entity extends the telemetry model beyond the CXL specification, which defines CDL population for CXL devices under specific conditions. Such translation may enable CXL hosts to access GPU memory storing AI model data, intermediate computations, or inference results.

In various implementations, a method comprising: receiving, by a computer from a first entity via a first interface, a CXL.io request comprising a read-class Transaction Layer Packet (TLP) type and a first physical address, wherein CXL denotes Compute Express Link; translating, by the computer, the CXL.io request to an NVLink-based request comprising a second physical address; sending, by the computer via a second interface that communicates according to an NVLink-based protocol, the NVLink-based request to a second entity; receiving, by the computer from the second entity, an NVLink-based response comprising data; translating, by the computer, the NVLink-based response to a CXL.io completion comprising the data; and sending the CXL.io completion to the first entity. The method may enable a CXL-based entity, such as a CXL host or a CXL device, to access resources coupled to an NVLink-based entity, such as a GPU, by translating CXL.io requests to NVLink-based requests and translating NVLink-based responses to CXL.io completions. The computer may be a processor, a switch, an RPU, a bridge, an active cable, or a semiconductor device positioned between the first entity and the second entity. The first interface may communicate according to CXL.io, and the second interface may communicate according to an NVLink-based protocol. The CXL.io request may be a CXL.io MRd or a CXL.io UIOMRd, and the CXL.io completion may be a CplD or a UIORdCplD, respectively. The computer may translate the first physical address, which may be an HPA or an address within a CXL address space, to the second physical address, which may be an NVLink-based network address or a GPU physical address. The computer may additionally determine NVLink routing fields such as SourceID and DestinationID for the outgoing NVLink-based request based on routing information, address mapping tables, or configuration maintained by the computer. The NVLink-based response may include fields such as SourceID, DestinationID, Tag, and data, and the computer may translate these to the corresponding CXL.io completion fields. In some examples, the computer may aggregate CXL.io requests into an NVLink-based request, or may prefetch additional data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCplD). The UIO path may be utilized when the first entity supports UIO capabilities and the path between the first entity and the computer has UIO enabled. The UIORdCplD may include a CDL that the computer may populate with telemetry information derived from the NVLink domain.

In some implementations of the method, the computer populates a CXL DevLoad (CDL) field in the CXL.io UIORdCplD with information based on at least one of: load information observed by the computer, congestion information associated with the second entity, or Quality-of-Service (QoS) telemetry derived from the NVLink-based response. The CDL generation by the computer may extend the CXL DevLoad telemetry model to the NVLink domain, where the NVLink-based protocol does not natively carry CDL. The computer may derive load or congestion information from the response latency, queue depth, or other observable characteristics of the second entity. The computer may populate the CDL utilizing the same encoding as defined for CXL devices, such as light load, optimal load, moderate overload, or severe overload, enabling the first entity to make informed scheduling or resource allocation decisions based on conditions at the second entity.

In some implementations of the method, the CXL.io request comprises a CXL.io Memory Read (MRd) request, and the CXL.io completion comprises a CXL.io Completion with Data (CplD). The standard MRd and CplD types may be utilized when the first entity does not support UIO or when UIO is not enabled along the path. The CplD does not include a CDL, and the computer may utilize any QoS or load information internally for traffic management or monitoring rather than propagating it to the first entity.

In some implementations of the method, the CXL.io request further comprises a first Tag, the NVLink-based request further comprises a second Tag assigned by the computer, the computer maintains a mapping between the first Tag and the second Tag, and translating the CXL.io request to the NVLink-based request comprises determining a SourceID and a DestinationID for the NVLink-based request based on routing information maintained by the computer. The computer may assign the second Tag from a pool of available NVLink Tags and store the mapping in a tracker entry. The SourceID and DestinationID may be determined based on routing tables, address range configurations, or forwarding information maintained by the computer, since CXL.io requests do not natively carry NVLink routing fields. Upon receiving the NVLink-based response comprising the second Tag, the computer may retrieve the corresponding first Tag for inclusion in the CXL.io completion.

In some implementations of the method, the computer aggregates CXL.io requests received from the first entity, and translates the aggregated CXL.io requests to an NVLink-based request. The computer may aggregate smaller CXL.io read requests targeting adjacent or contiguous addresses into a larger NVLink-based read request, leveraging the NVLink-based protocol's support for larger payload sizes to improve bandwidth utilization and reduce the number of transactions on the NVLink-based interface.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system may be configured to translate from CXL.io traffic to NVLink-based traffic. The system may include a computer coupled between a first interface configured to communicate according to CXL.io and a second interface configured to communicate according to an NVLink-based protocol. The computer may translate CXL.io requests received from a first entity, such as a CXL host, to NVLink-based requests transmitted to a second entity, such as a GPU. The computer may include an RPU with a cache, and may be implemented as a bridge, a switch, a standalone translation device, or a chiplet. The system may include optional NVLink switches or CXL switches on either side of the computer. Such systems may enable CXL hosts to access GPU memory resources, such as memory storing AI model data, intermediate computation results, or inference outputs, through the CXL.io interface.

In various implementations, a system comprising: a first interface configured to communicate according to CXL.io with a first entity, wherein CXL denotes Compute Express Link; a second interface configured to communicate according to an NVLink-based protocol with a second entity; and a computer coupled between the first and second interfaces, configured to translate between CXL.io requests received via the first interface and NVLink-based requests transmitted via the second interface. The system may enable a CXL-based entity, such as a CXL host, a CXL device, or a CXL switch, to access resources coupled to an NVLink-based entity, such as a GPU, an accelerator, or an NVLink switch, through the computer that performs translation between the CXL.io and NVLink-based protocol domains. The computer may translate addresses, Tags, routing fields, error indications, and other protocol-specific fields. The computer may additionally determine NVLink routing fields such as SourceID and DestinationID for outgoing NVLink-based requests, since CXL.io requests do not carry NVLink routing information. In some examples, the computer may include an RPU coupled to a cache, and may be coupled to a memory. The first interface may be coupled to the first entity directly or through one or more CXL switches, and the second interface may be coupled to the second entity directly or through one or more NVLink switches. The computer may be implemented as a bridge, a switch, a standalone translation device, a semiconductor device, or a chiplet.

In some implementations of the system, the computer is configured to determine a SourceID and a DestinationID for NVLink-based requests transmitted via the second interface based on routing information maintained by the computer. The routing information may include routing tables, address-to-destination mappings, forwarding information, or configuration data programmed by a management entity. The SourceID and DestinationID may be utilized by NVLink switches or the second entity to route and deliver the NVLink-based requests.

In some implementations of the system, the computer is further configured to translate at least one of poison indications or data corruption indications between messages communicated via the first interface and messages communicated via the second interface. The poison indication in CXL.io may be propagated to or from corresponding error fields in NVLink-based messages, enabling end-to-end error visibility across the protocol boundary.

In some implementations of the system, the computer comprises a Request Processing Unit (RPU) coupled to a cache configured to store data associated with translations between the CXL.io requests and the NVLink-based requests, and wherein the computer is further configured to translate between fields of the CXL.io requests and fields of the NVLink-based requests, comprising at least one of: Traffic Class (TC) to QoS priority, Tag to Tag, or length to length translations. The RPU may manage the translation state and orchestrate the protocol conversions. The cache may store data retrieved from the second entity to reduce latency for repeated or adjacent accesses. The cross-field translations may include mapping CXL.io Traffic Class values to NVLink QoS priority levels, mapping CXL.io Tags to NVLink Tags, and translating length fields to accommodate differences in granularity or maximum transfer sizes between the protocols.

In some implementations of the system, the computer is included in at least one of a bridge, a switch, or a standalone translation device, which enables the first entity to access, via CXL.io, GPU memory of the second entity storing data associated with an artificial intelligence (AI) model. The bridge, switch, or standalone translation device may be deployed in AI inference or training systems where CXL hosts need to read intermediate results, model outputs, or gradient data from GPU memory. The translation device may enable such access without requiring the GPU to natively support CXL.io.

In some implementations of the system, the computer comprises an NVLink Fusion chiplet coupled to a processing die via an NVLink Chip-to-Chip (NVLink-C2C) coherent interface; and wherein at least one of: one or more NVLink switches are positioned between the second interface and the second entity, or one or more CXL switches are positioned between the first interface and the first entity. The NVLink Fusion chiplet may implement the translation logic as a separate die within a multi-die package, communicating with the processing die via the NVLink-C2C coherent interface. The NVLink switches or CXL switches may extend the system topology to include multiple NVLink-based entities or multiple CXL-based entities, respectively.

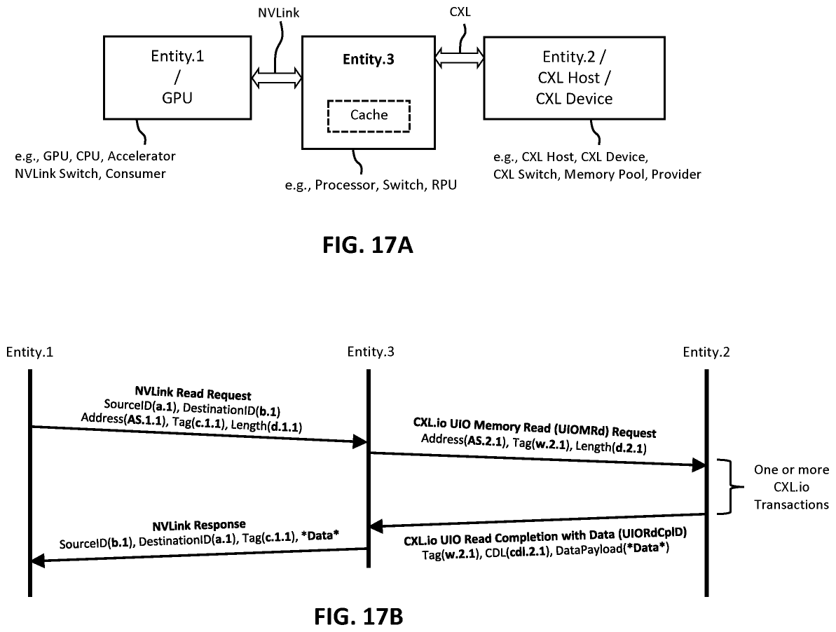

FIG. 17A illustrates an example of a system comprising a third entity (Entity.3), such as a processor, a switch, or an RPU, optionally comprising a cache, that may enable NVLink-based resource consumers to access resources coupled to CXL-based entities. The third entity is coupled to a first entity (Entity.1), which may be a GPU, a CPU, an accelerator, an NVLink switch, or a consumer, wherein the third entity may communicate with the first entity according to an NVLink-based protocol. The third entity is further coupled to a second entity (Entity.2), which may be a CXL host, a CXL device, a CXL switch, a CXL-based memory pool, or a resource provider, wherein the third entity may communicate with the second entity according to a CXL-based protocol, such as at least one of CXL.io, CXL.mem, or CXL.cache. In some examples, messages conforming to the NVLink-based protocol may be associated with a first address space, such as an NVLink-based address space, an NVLink-based network address space, or a GPU address space; and messages conforming to the CXL-based protocol, such as CXL.io, may be associated with a second address space, such as a System Physical Address (SPA) space or a Host Physical Address (HPA) space; wherein the third entity may perform address translations between addresses within the first and second address spaces, respectively. In other examples, messages conforming to the NVLink-based protocol and messages conforming to the CXL-based protocol may be associated with the same physical address space, such as a global address space, a pod address space, or a fabric address space; wherein the third entity may perform address translations between addresses within the same address space. The third entity may perform further translations, such as protocol translations, opcode translations, command translations, request translations, or TLP translations, such as when translating between NVLink requests and CXL.io requests. The third entity may further translate between PDUs of the NVLink-based protocol and PDUs of the CXL protocol, translate Tags, and/or translate error indications, such as data corruption indications or poison. The optional cache within the third entity, shown in dashed outline, may store prefetched data or data retrieved from the second entity to reduce latency for subsequent requests from the first entity. Optionally, the first entity may be a GPU, CPU, accelerator, NVLink switch, or consumer; the third entity may be a processor, switch, or RPU; and the second entity may be a CXL host, CXL device, CXL switch, memory pool, or provider.

FIG. 17B illustrates an example of a transaction flow diagram (TFD) demonstrating a third entity (Entity.3), such as a processor, a switch, or an RPU, that may translate between NVLink-based traffic and CXL-based traffic, such as CXL.io traffic. The third entity may receive from a first entity (Entity.1), which may be a GPU, an NVLink read request that may include SourceID(a.1), DestinationID(b.1), Address(AS.1.1), Tag(c.1.1), and Length(d.1.1), wherein SourceID(a.1) may denote the NVLink interconnect address utilized by the requesting entity, such as a source GPU, and wherein DestinationID(b.1) may denote the NVLink interconnect address utilized by the target of the NVLink request, and may be utilized for routing or forwarding the NVLink request to its destination. The third entity may translate the NVLink request to a CXL.io request that may include a CXL.io UIO Memory Read (UIOMRd) request comprising Address(AS.2.1), Tag(w.2.1), and Length(d.2.1), and may send the CXL.io UIOMRd to a second entity (Entity.2), which may be a CXL host or a CXL device. The third entity may further translate between other values of the NVLink request and the CXL.io request, such as between addresses, Tags, QoS-related values, or identifications (IDs), which may serve to route or forward the NVLink request to its destination. In some examples, the third entity may translate an NVLink request to multiple CXL.io request, such as in order to split a large data read request (e.g., splitting a large 256 B NVLink read request to smaller 64 B CXL.io read requests), or in order to prefetch data, optionally into a cache that may be included in or coupled to the third entity. Upon receiving a response from the second entity (Entity.2), which may include a CXL.io UIORdCplD comprising Tag(w.2.1), CDL(cdl.2.1), and DataPayload(*Data*), the third entity may translate the CXL.io UIORdCplD to an NVLink response comprising SourceID(b.1), DestinationID(a.1), Tag(c.1.1), and *Data*. The CDL that may be included in the CXL.io UIORdCplD may be populated with information related to QoS, such as QoS telemetry value or values. The third entity may translate information carried in the CDL and send it via one or more fields of the NVLink response, such as via reserved fields, vendor-defined fields, or custom fields. Alternatively or additionally, the third entity may collect QoS information, telemetry, or statistics from UIORdCplD completions.

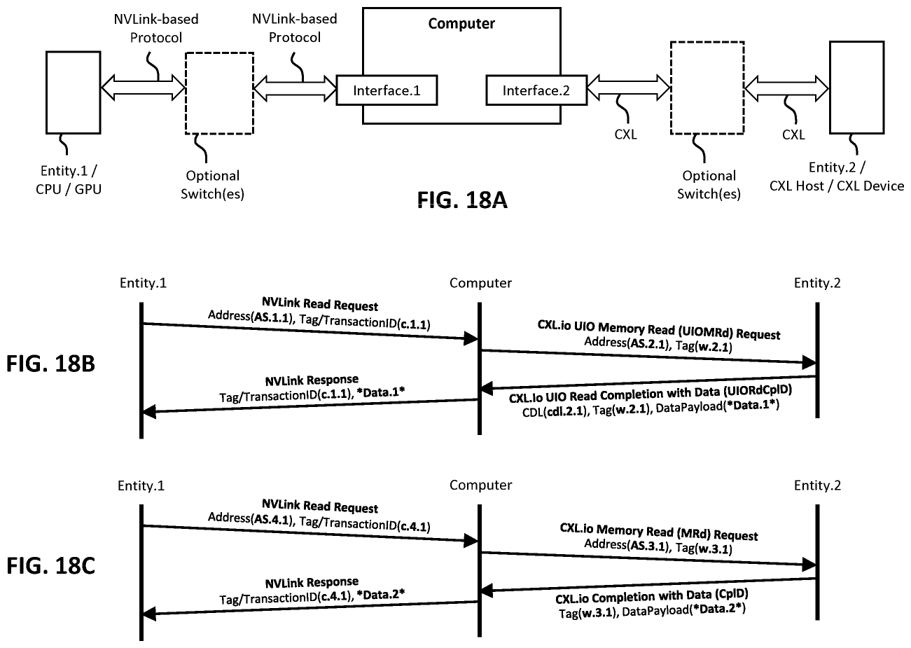

FIG. 18A illustrates an example of a system comprising a computer coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a CXL-based protocol, such as CXL.io, with a second entity (Entity.2), which may be a CXL host or a CXL device. Optionally, the computer may be implemented in a semiconductor device package. The computer may extract physical addresses from requests received via the first interface, wherein these addresses may refer to an NVLink-based address space, an NVLink-based network address space, or a GPU address space utilized by the first entity. The computer may further translate these addresses, and generate requests carrying the translated physical addresses for transmission via the second interface; wherein these translated addresses may correspond to an HPA space utilized by the second entity. Optional switch(es), such as NVLink switches, may be positioned between the first interface and the first entity, as shown in dashed outline on the left side of the figure. Similarly, optional switch(es), such as CXL switches, may be positioned between the second interface and the second entity, as shown in dashed outline on the right side of the figure. The NVLink-based protocol labels on the connections between the first entity, the optional switches, and the first interface indicate that NVLink-based traffic traverses the left side of the illustrated system. The CXL labels on the connections between the second interface, the optional switches, and the second entity indicate that CXL-based traffic traverses the right side of the illustrated system. Optionally, the computer may be included in a switch or a bridge. In some examples, the computer may be implemented in an IC package having high-speed differential I/O balls positioned according to a ball grid array layout defined by a retimer specification, such as the PCIe 5.0, 6.0, or 7.0 Retimer Supplemental Features and Standard BGA Footprint Specification.

FIG. 18B illustrates an example of a TFD demonstrating translations between NVLink-based requests, such as NVLink read requests, received from a first entity (Entity.1), which may be a CPU or a GPU, and CXL.io UIO TLPs sent to a second entity (Entity.2), which may be a CXL host or a CXL device, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.1.1), and Tag/TransactionID(c.1.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io UIO Memory Read (UIOMRd) request comprising a physical address, such as HPAs Address(AS.2.1), and Tag(w.2.1), and may send the CXL.io UIOMRd to the second entity. Upon receiving the CXL.io UIOMRd, the second entity may respond with a completion, which may include a CXL.io UIO Read Completion with Data (UIORdCplD) comprising CDL(cdl.2.1), Tag(w.2.1), and DataPayload(*Data.1*), wherein the CDL may be populated by the CXL device (or alternatively by the CXL host) with information related to QoS, such as QoS telemetry value or values. The computer may translate the CXL.io UIORdCplD to an NVLink response comprising Tag/TransactionID(c.1.1) and *Data.1*, and may send the NVLink response to the first entity. In some examples, the computer may issue multiple CXL.io UIO memory read requests in response to receiving an NVLink request from the first entity, such as when splitting an NVLink request for a large block of data to smaller CXL.io UIO memory read requests, or when prefetching data from the second entity. The computer may translate requests or transactions initiated from the NVLink-based domain to the CXL domain, or may translate requests or transactions initiated from the CXL domain to the NVLink-based domain.

FIG. 18C illustrates an example of a TFD demonstrating translations between NVLink-based requests, such as NVLink read requests, received from a first entity (Entity.1), which may be a CPU or a GPU, and CXL.io TLPs sent to a second entity (Entity.2), which may be a CXL host or a CXL device. The translation is performed by a computer, which may be a semiconductor device. The first entity may initiate an NVLink request, which may be an NVLink read request, comprising physical address Address(AS.4.1), and Tag/TransactionID(c.4.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io Memory Read (MRd) request comprising physical address Address(AS.3.1) and Tag(w.3.1), and may send the CXL.io MRd to the second entity. Upon receiving a completion from the second entity, which may include a CXL.io Completion with Data (CplD) comprising Tag(w.3.1) and DataPayload(*Data.2*), the computer may translate the CXL.io CplD to an NVLink response comprising Tag/TransactionID(c.4.1) and *Data.2*, and may send the NVLink response to the first entity. In some examples, the computer may issue multiple CXL.io memory read requests in response to receiving an NVLink request from the first entity, such as when splitting an NVLink request for a large block of data to smaller CXL.io memory read requests, or when prefetching data from the second entity.

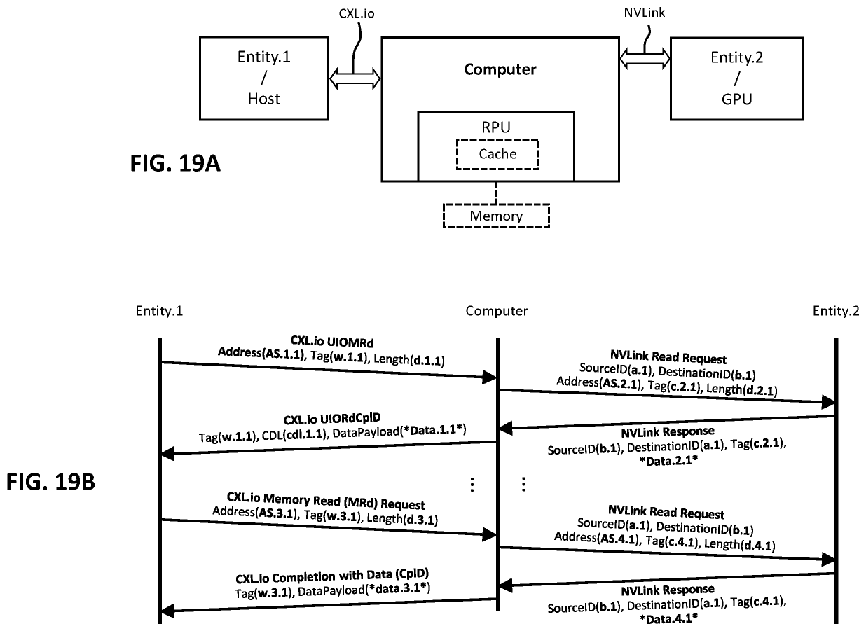

FIG. 19A illustrates an example of a system comprising a computer configured to translate between CXL.io traffic and NVLink-based traffic. A first entity (Entity.1), which may be a host, is coupled to the computer via a CXL.io interface. A second entity (Entity.2), which may be a GPU, is coupled to the computer via an NVLink interface. The computer includes an RPU that may orchestrate the protocol translation logic. The RPU may include an optional cache, which may store data associated with translations between CXL.io requests and NVLink-based requests, such as prefetched data, cached responses, or translation state. The computer is further coupled to an optional memory, shown in dashed outline below the computer, that may store routing tables, address translation tables, Tag mapping entries, or other state information utilized by the RPU during translation. The system enables the first entity (Host) to access resources coupled to the second entity (GPU) through the computer by translating CXL.io requests to NVLink-based requests and translating NVLink-based responses to CXL.io completions. The computer may determine NVLink routing fields such as SourceID and DestinationID for outgoing NVLink-based requests, since CXL.io requests do not natively carry NVLink routing fields. When translating NVLink-based responses to CXL.io UIO completions, the computer may populate a CDL field with QoS telemetry information derived from the NVLink domain, from load or congestion information observed by the computer, or from information carried in the NVLink-based response.

FIG. 19B illustrates an example of a TFD demonstrating translations between CXL.io read requests received from a first entity (Entity.1) and NVLink-based read requests sent to a second entity (Entity.2), with the translation performed by a computer positioned between the first and second entities. The figure shows two separate transaction flows separated by a vertical ellipsis, representing two alternative translation paths: an upper UIO path and a lower non-UIO path. In the upper UIO path, the first entity sends a CXL.io UIOMRd comprising Address(AS.1.1), Tag(w.1.1), and Length(d.1.1) to the computer. The computer translates the CXL.io UIOMRd to an NVLink read request comprising SourceID(a.1), DestinationID(b.1), Address(AS.2.1), Tag(c.2.1), and Length(d.2.1), and sends the NVLink read request to the second entity. The computer determines the SourceID(a.1) and DestinationID(b.1) based on routing information maintained by the computer, since the CXL.io UIOMRd does not carry NVLink routing fields. Upon receiving an NVLink Response from the second entity comprising SourceID(b.1), DestinationID(a.1), Tag(c.2.1), and *Data.2.1*, the computer translates the NVLink Response to a CXL.io UIORdCplD comprising Tag(w.1.1), CDL(cdl.1.1), and DataPayload(*Data.1.1*), and sends the CXL.io UIORdCplD to the first entity. The CDL(cdl.1.1) may be populated by the computer with QoS telemetry information based on load information observed by the computer, congestion information associated with the second entity, or information derived from the NVLink Response, since the NVLink-based protocol does not natively carry a CDL field.

In the lower non-UIO path, the first entity sends a CXL.io Memory Read (MRd) request comprising Address(AS.3.1), Tag(w.3.1), and Length(d.3.1) to the computer. The computer translates the CXL.io MRd to an NVLink read request comprising SourceID(a.1), DestinationID(b.1), Address(AS.4.1), Tag(c.4.1), and Length(d.4.1), and sends the NVLink read request to the second entity. Upon receiving an NVLink Response from the second entity comprising SourceID(b.1), DestinationID(a.1), Tag(c.4.1), and *Data.4.1*, the computer translates the NVLink Response to a CXL.io Completion with Data (CplD) comprising Tag(w.3.1) and DataPayload(*Data.3.1*), and sends the CXL.io CplD to the first entity. Unlike the upper UIO path, the CplD in the lower non-UIO path does not include a CDL. In both paths, the computer translates addresses between the CXL.io domain (Address AS.1.1 and AS.3.1) and the NVLink domain (Address AS.2.1 and AS.4.1), translates Tags between the CXL.io domain (Tag w.1.1 and w.3.1) and the NVLink domain (Tag c.2.1 and c.4.1), and determines NVLink SourceID and DestinationID routing fields for the outgoing NVLink read requests.

In environments where entities may utilize different protocols while requiring coordinated access to shared resources, there may be scenarios where a first entity communicating based on PCIe, such as a GPU, needs to access memory resources coupled to a second entity communicating based on CXL.mem, such as a CXL memory expander or a CXL memory pool. Translations between PCIe TLPs and CXL.mem messages may facilitate memory operations, data transfers, and resource sharing across different domains while maintaining the requirements of each protocol. Such translations may be performed by a computer, an apparatus, a cable, a Fabric Processing Unit (FPU), a Fabric NIC, or other suitable devices positioned between the first entity and the second entity. This translation may enable PCIe devices that do not natively support CXL protocols to access large-capacity CXL-attached memory resources. For example, GPUs designed with PCIe interfaces may access CXL memory pools that provide memory capacity exceeding the HBM integrated within the GPUs, thereby extending the effective memory available for AI/ML workloads, graphics rendering, or general-purpose GPU computing possibly without requiring hardware modifications to existing GPU designs. The computer may perform address translations between different physical address spaces, opcode translations between PCIe and CXL.mem, and Tag translations between PCIe Tag formats and CXL.mem Tag formats.

In various implementations, a method for translating between Peripheral Component Interconnect Express (PCIe) Transaction Layer Packets (TLPs) and Compute Express Link (CXL) messages, comprising: receiving a PCIe memory request by a computer from a first entity; translating, by the computer, the PCIe memory request to a CXL.mem Master-to-Subordinate (M2S) request; sending, by the computer to a second entity, the CXL.mem M2S request; receiving, by the computer from the second entity, a CXL.mem Subordinate-to-Master Data Response (S2M DRS) corresponding to the CXL.mem M2S request; translating, by the computer, the CXL.mem S2M DRS to a PCIe Completion; and sending the PCIe Completion by the computer to the first entity. The translation may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, switches, bridges, or active cables. The computer may maintain state information, such as pending transaction tables or tracker entries, to correlate CXL.mem S2M DRS responses with previously transmitted CXL.mem M2S requests and with pending PCIe transactions. Additionally, the elements may communicate through one or more intermediary components, such as a switch, a retimer, or other suitable entity that facilitates information transfer. The first entity may include devices such as GPUs, NICs, DMA engines, accelerators, or other PCIe endpoints, while the second entity may include CXL memory expanders, CXL memory pools, GFDs, or other CXL.mem-capable devices.

In some implementations of the method, the PCIe memory request comprises a first physical address belonging to a first physical address space utilized by the first entity, and wherein translating the PCIe memory request to the CXL.mem M2S request comprises generating the CXL.mem M2S request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an address space utilized by the first entity for PCIe memory-mapped I/O (MMIO) operations, and the second physical address space may include a Host Physical Address (HPA) space utilized by a CXL host coupled to a CXL device of the second entity. The computer may maintain translation tables that map regions of the first physical address space to corresponding regions of the second physical address space, enabling the first entity to access CXL-attached memory resources using addresses within its native address space.

In some implementations of the method, the first entity comprises a GPU that does not support CXL.mem, wherein the second entity comprises a CXL memory pool, and wherein the computer exposes memory resources of the CXL memory pool to the GPU via a PCIe memory address space. The computer may expose the CXL memory pool to the GPU by configuring Base Address Registers (BARs) or other PCIe mechanisms to advertise a memory region that the GPU can access using standard PCIe memory read and write operations. The GPU may utilize this exposed memory region for various purposes, such as storing intermediate computation results, model parameters for AI/ML inference, texture data for graphics rendering, or working data sets that exceed the GPU's local HBM capacity. The computer may handle the translation transparently, such that the GPU may operate without awareness that the underlying memory is accessed utilizing CXL.mem rather than standard PCIe memory, which may enable existing GPU designs with PCIe interfaces to benefit from CXL-attached memory resources.

In some implementations of the method, the computer communicates with GPUs via interfaces, and wherein the computer translates PCIe memory requests from the GPUs to CXL.mem M2S requests targeting a shared memory resource of the CXL memory pool. The shared memory region of the CXL memory pool may be accessible by multiple GPUs, enabling data sharing, inter-GPU communication, or load balancing across the GPUs. The computer may implement arbitration logic to manage concurrent memory requests from the GPUs, and may utilize QoS mechanisms to allocate bandwidth or prioritize requests from different GPUs. The shared memory architecture may be beneficial in multi-GPU computing environments, such as AI/ML training clusters, where GPUs may need to access common datasets, model parameters, or intermediate results. The interfaces may include separate PCIe links, lanes within a shared PCIe link, or virtual channels within a PCIe fabric.

In some implementations of the method, the computer maintains memory allocation information associating portions of the CXL memory pool with certain respective GPUs of the GPUs, and wherein translating the PCIe memory request comprises selecting a portion of the CXL memory pool based on an identity of a requesting GPU. The memory allocation information may include address range tables, partition descriptors, or access control lists that define which portions of the CXL memory pool are accessible by each GPU. The computer may identify the requesting GPU based on the Requester ID in the PCIe memory request, a source port identifier, or other identification mechanisms. The partitioning may enable isolation between GPUs for security or fault containment purposes, or may enable dynamic memory allocation wherein portions of the CXL memory pool are assigned to GPUs based on workload requirements. The computer may support exclusive partitions (accessible by a single GPU) and/or shared regions (accessible by multiple GPUs) within the CXL memory pool.

In some implementations of the method, the first entity comprises at least one of a GPU, a Network Interface Card (NIC), or a Direct Memory Access (DMA) engine; wherein the second entity comprises at least one of a CXL memory expander, a CXL memory pool, or a Global Fabric-Attached Memory device (GFD); wherein the PCIe memory request comprises a PCIe Memory Read (MRd) request comprising a first Tag; wherein the CXL.mem M2S request comprises MemRd* and a second Tag; wherein the CXL.mem S2M DRS comprises MemData and data; wherein the PCIe Completion comprises a Completion with Data (CplD) comprising the data and the first Tag; and wherein the computer maintains a mapping between the first Tag and the second Tag. The computer may maintain the mapping between the first Tag and the second Tag in a tracker entry, a translation table, or another relevant data structure. Upon receiving the CXL.mem S2M DRS from the second entity, the computer may utilize the second Tag to identify the corresponding pending transaction and retrieve the first Tag for inclusion in the PCIe CplD. GPUs may utilize PCIe memory reads to access large memory pools for workloads such as graphics rendering, machine learning inference, or general-purpose GPU computing workloads. NICs may utilize PCIe memory reads to access memory buffers for network packet processing, RDMA, or storage traffic handling. DMA engines may utilize PCIe memory reads to transfer data between memory regions on behalf of other system components. The second entity may expose memory resources that are implemented using various memory technologies such as DDR5, DDR4, HBM, persistent memory, or combinations thereof.

In some implementations, the method further comprises receiving, by the computer from the first entity, a PCIe Memory Write request (MWr) comprising write data; translating the PCIe MWr to a CXL.mem M2S request with Data (M2S RwD) comprising a MemWr* and the write data; sending the CXL.mem M2S RwD to the second entity; and receiving, from the second entity, a CXL.mem S2M No Data Response (S2M NDR) comprising Cmp*. The PCIe MWr may be a posted write that does not require a completion to be returned to the first entity. However, CXL.mem may return an S2M NDR with Cmp* to acknowledge receipt of the write data by the second entity. The computer may absorb the S2M NDR without forwarding the acknowledgment to the first entity, or may utilize the S2M NDR to update internal state or flow control mechanisms. The write data may be transferred from the PCIe domain to the CXL.mem domain with optional format conversion, alignment adjustment, or byte enable manipulation as appropriate for the respective protocol specifications. The computer may buffer the write data internally and may implement mechanisms to handle scenarios where the CXL.mem M2S RwD encounters errors or back-pressure from the second entity.

In some implementations of the method, the computer is included in a switch, and wherein the PCIe memory request is selected from: a UIO Memory Read (UIOMRd) request, a UIO Memory Write request (UIOMWr), a Memory Read (MRd) request, or a Memory Write request (MWr). The selection among UIOMRd, UIOMWr, MRd, or MWr may depend on the capabilities of the first entity and the configuration of the path between the first entity and the computer.

In some implementations of the method, the PCIe memory request comprises a PCIe Unordered Input/Output (UIO) Memory Read (UIOMRd) request, and wherein the PCIe Completion comprises a PCIe UIO Read Completion with Data (UIORdCplD). The UIO transaction types may be utilized when the first entity supports UIO capabilities and when the path between the first entity and the computer has UIO enabled. The UIOMRd request type may provide ordering flexibility that enables more efficient utilization of fabric bandwidth in topologies with multiple paths between source and destination. UIO transactions may allow out-of-order completion delivery, which may reduce head-of-line blocking and improve overall system throughput in heavily loaded systems. The UIORdCplD completion may include a CDL that the computer may populate with information collected from the CXL.mem domain, from the computer itself, or from intermediate components.

In some implementations, the method further comprises receiving, by the computer from the first entity, a PCIe UIO Memory Write request (UIOMWr) comprising write data; translating the PCIe UIOMWr to a CXL.mem M2S request with Data (M2S RwD) comprising a MemWr* and the write data; sending the CXL.mem M2S RwD to the second entity; receiving, from the second entity, a CXL.mem S2M No Data Response (S2M NDR); translating the CXL.mem S2M NDR to a PCIe UIO Write Completion (UIOWrCpl); and sending the PCIe UIOWrCpl to the first entity. The UIO Memory Write request may be a non-posted transaction for which the first entity expects a UIOWrCpl, and the computer may translate the CXL.mem S2M NDR to the PCIe UIOWrCpl, thereby providing end-to-end acknowledgment that the write data has been received by the second entity. This non-posted write may be beneficial for maintaining ordering guarantees or for implementing synchronization mechanisms. The UIOWrCpl may include a CDL that the computer may populate based on the DevLoad from the CXL.mem S2M NDR or based on locally generated information.

In some implementations of the method, the CXL.mem S2M DRS comprises a DevLoad, and wherein the PCIe Completion comprises a CXL DevLoad (CDL) populated based on the DevLoad. The DevLoad in the CXL.mem S2M DRS may carry QoS telemetry information indicating the loading or congestion state of the second entity or intermediate components in the CXL.mem path. The computer may translate this telemetry information to the CDL in the PCIe UIORdCplD, thereby propagating QoS information back to the first entity. The first entity may utilize this information to make informed decisions about subsequent memory operations, such as throttling request rates, adjusting request priorities, or selecting alternative memory resources based on observed loading conditions. This end-to-end propagation of telemetry information may enable more efficient resource utilization in heterogeneous computing systems.

In some implementations, the method further comprises sending, by the computer to the second entity, a CXL.mem M2S request comprising MemSpecRd. The speculative memory read may be initiated by the computer to fetch data from the second entity in advance of, or without, the first entity explicitly requesting that data. The CXL.mem MemSpecRd opcode provides a mechanism for speculative memory access that does not have a direct equivalent in PCIe, enabling the computer to leverage CXL.mem-specific capabilities to improve performance for PCIe devices. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. Data returned in response to speculative reads may be buffered by the computer and may be utilized to satisfy subsequent requests from the first entity, potentially reducing observed read latency.

In some implementations, the method further comprises receiving, by the computer from the second entity, a CXL.mem S2M DRS comprising data responsive to the CXL.mem M2S request comprising MemSpecRd; buffering, by the computer, the data; receiving a subsequent PCIe memory request from the first entity targeting an address corresponding to the buffered data; and populating a subsequent PCIe Completion with at least some of the buffered data responsive to the subsequent PCIe memory request. The computer may maintain a prefetch buffer or cache structure to store data received in response to speculative read requests. When a subsequent PCIe memory request from the first entity targets an address for which speculative data has been buffered, the computer may service the request from the buffer without initiating a new CXL.mem transaction, thereby reducing the observed read latency. The buffered data may be invalidated or refreshed based on coherency requirements, timeout policies, or subsequent write operations to the same address. The computer may implement address matching logic to determine whether incoming PCIe memory requests can be satisfied from buffered speculative data.

In some implementations, the method further comprises detecting sequential access patterns in physical addresses of prior PCIe memory requests received from the first entity, and initiating the CXL.mem M2S request comprising MemSpecRd targeting a next sequential physical address. The computer may track physical addresses from consecutive PCIe memory requests received from the first entity to identify sequential access patterns indicative of linear memory traversal. Upon detecting that the first entity has accessed certain addresses in sequence, the computer may speculatively facilitate the readiness of the data from subsequent addresses before the first entity explicitly requests them. The sequential pattern detection may account for cacheline boundaries, page boundaries, or other memory organization units to optimize prefetch granularity.

In some implementations, the method further comprises detecting strided access patterns in physical addresses of prior PCIe memory requests received from the first entity, calculating a stride distance between accessed addresses, and initiating the CXL.mem M2S request comprising MemSpecRd targeting a physical address offset by the stride distance. The computer may identify non-sequential but regular access patterns wherein the first entity accesses memory locations separated by a consistent stride distance, such as when processing array elements or matrix columns. For example, if the computer observes accesses to addresses A, A+S, A+2S, where S represents the stride, it may speculatively prefetch from address A+3S. The stride detection algorithm may maintain a history buffer of recent addresses and compute stride patterns using difference calculations or pattern matching algorithms.

In some implementations of the method, the PCIe memory request comprises a first Tag having a first bit width selected from 5 bits, 8 bits, 10 bits, or 14 bits; wherein the CXL.mem M2S request comprises a second Tag having a 16-bit width; and wherein the computer translates between the first Tag and the second Tag. PCIe supports variable Tag widths depending on device capabilities and negotiated settings, including 5-bit Tags (default), 8-bit extended Tags, 10-bit Tags (for high-speed links), and 14-bit Tags (for flit mode and UIO). CXL.mem utilizes a fixed 16-bit Tag for transaction identification. The computer may translate between these different Tag formats by allocating CXL.mem Tags from a Tag pool, maintaining a mapping table between PCIe Tags and CXL.mem Tags, or implementing algorithmic Tag generation based on the PCIe Tag and additional context. The translation may also accommodate scenarios where the computer needs to maintain more outstanding CXL.mem transactions than the PCIe Tag space allows (for example, when issuing speculative CXL.mem reads independently of PCIe demand requests) by drawing from the larger CXL.mem Tag space for those additional transactions.

In some implementations of the method, the PCIe memory request specifies a requested data length larger than a cacheline size, wherein translating the PCIe memory request comprises generating CXL.mem M2S requests each targeting a cacheline-sized data portion, and wherein the method further comprises: receiving CXL.mem S2M DRS responses from the second entity, and aggregating data from the CXL.mem S2M DRS responses into the PCIe Completion. CXL.mem transactions are typically cacheline-sized (64 bytes), while PCIe memory requests may specify data lengths up to 4 KB using the Length field and byte enables. When a PCIe memory request specifies a data length exceeding the cacheline size, the computer may split the request into CXL.mem M2S requests, each targeting a 64-byte cacheline. The computer may track the outstanding CXL.mem requests and may aggregate the returned data into a single PCIe Completion or into multiple PCIe Completions as permitted by PCIe. The aggregation may involve buffering data from responses, ordering the data according to address sequence, and formatting the aggregated data according to PCIe Completion requirements.

In some implementations of the method, the PCIe memory request specifies a requested data length smaller than a cacheline size, wherein the CXL.mem S2M DRS comprises cacheline-sized data, and wherein the method further comprises trimming the cacheline-sized data to match the requested data length prior to populating the PCIe Completion. PCIe memory requests may specify data lengths smaller than a cacheline using byte enables, requesting as little as a single doubleword (4 bytes) or even individual bytes. CXL.mem responses return cacheline-sized data regardless of the requested length. The computer may trim the returned data to the bytes requested by the first entity, aligning the data to native boundaries such as doubleword boundaries as specified by the PCIe specifications. The trimming operation may reduce the data payload size in the PCIe Completion, potentially improving bandwidth efficiency on the path between the computer and the first entity.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus for translating between Peripheral Component Interconnect Express (PCIe) Transaction Layer Packets (TLPs) and Compute Express Link (CXL) messages, comprising: a first interface configured to communicate with a first entity based on PCIe; a second interface configured to communicate with a second entity based on CXL.mem; and a computer coupled to the first interface and the second interface, wherein the computer is configured to: receive a PCIe memory request from the first entity via the first interface; translate the PCIe memory request to a CXL.mem Master-to-Subordinate (M2S) request; send, to the second entity via the second interface, the CXL.mem M2S request; receive, from the second entity via the second interface, a CXL.mem Subordinate-to-Master Data Response (S2M DRS) corresponding to the CXL.mem M2S request; translate the CXL.mem S2M DRS to a PCIe Completion; and send the PCIe Completion to the first entity via the first interface. The apparatus may be implemented as a switch, a bridge, a semiconductor device, a chiplet within an IC package, or other suitable form factor. The first interface may include PCIe physical layer components, link layer components, and transaction layer logic configured to communicate according to PCIe specifications. The second interface may include CXL physical layer components (which may share physical layer characteristics with PCIe), link layer components, and CXL.mem transaction layer logic. The computer may include translation logic, address translation tables, Tag mapping structures, and pending transaction trackers. In some examples, the apparatus and at least one of the first entity or the second entity may be included within the same IC package, optionally coupled by UCIe links or other die-to-die interconnects.

In some implementations of the apparatus, the PCIe memory request comprises a first physical address belonging to a first physical address space, the CXL.mem M2S request comprises a second physical address belonging to a second physical address space, and wherein the computer is further configured to translate between the first physical address and the second physical address. The apparatus may include address translation logic, which may be implemented using lookup tables, content-addressable memory (CAM), translation lookaside buffers (TLBs), or programmable translation functions. The translation may enable the first entity to access CXL-attached memory using addresses within its native address space while the second entity operates within its own address space. The address translation may be configured by system software, firmware, or hardware during system initialization or dynamically during operation.

In some implementations of the apparatus, the first entity comprises a GPU that does not support CXL.mem, the second entity comprises a CXL memory pool, and wherein the computer is configured to expose memory resources of the CXL memory pool to the GPU as a PCIe memory-mapped region. The apparatus may function as a bridge enabling GPUs designed with PCIe interfaces to access CXL-attached memory resources. The apparatus may expose the CXL memory pool as one or more PCIe BARs that the GPU can access using PCIe memory transactions, which may enable GPU-based AI/ML workloads to utilize memory capacities exceeding the HBM integrated within the GPU.

In some implementations of the apparatus, the computer is further configured to send, to the second entity via the second interface, a CXL.mem M2S request comprising MemSpecRd. The apparatus may include logic configured to initiate speculative memory reads to the second entity based on observed access patterns from the first entity. The speculative reads may utilize the CXL.mem MemSpecRd, which provides speculative access not available in PCIe. Data returned in response to speculative reads may be stored in a buffer within the apparatus for rapid delivery when subsequently requested by the first entity.

In some implementations of the apparatus, the apparatus is located in an active cable. The active cable may include the first interface at one end configured to connect to a PCIe device such as a GPU, and the second interface at the other end configured to connect to a CXL device such as a memory expander or memory pool. The computer may be implemented within the cable housing utilizing embedded logic. The active cable form factor may enable translation to be added to existing systems by replacing passive cables with active translation cables, possibly without requiring modifications to the connected devices.

In various implementations, a system comprising: Graphics Processing Units (GPUs), wherein at least one GPU of the GPUs does not support Compute Express Link (CXL) communications; a CXL device coupled to memory having a capacity greater than a capacity of high-bandwidth memory (HBM) of any one of the GPUs; and a computer coupled between the GPUs and the CXL device, the computer comprising: a first interface configured to communicate with the GPUs based on PCIe; and a second interface configured to communicate with the CXL device based on CXL.mem; wherein the computer is configured to: receive, from a GPU of the GPUs via the first interface, a PCIe memory request; translate the PCIe memory request to a CXL.mem Master-to-Subordinate (M2S) request; send, to the CXL device via the second interface, the CXL.mem M2S request; receive, from the CXL device via the second interface, a CXL.mem Subordinate-to-Master Data Response (S2M DRS); translate the CXL.mem S2M DRS to a PCIe Completion; and send the PCIe Completion to the GPU via the first interface. The system may enable GPUs that do not natively support CXL to access memory resources that exceed their local HBM capacity, such as for storing model parameters, intermediate computation results, KV-cache entries, or working data sets for AI/ML inference and training workloads. The CXL device may include a CXL memory expander, a CXL memory pool, a Global Fabric-Attached Memory device (GFD), or a CXL Type 2 device with device-attached memory. The memory coupled to the CXL device may be implemented using DDR5, DDR4, LPDDR, persistent memory, or combinations thereof, and may provide memory capacity and bandwidth characteristics that complement the high-bandwidth but limited-capacity HBM integrated within the GPUs. The computer may be implemented as a semiconductor device, an ASIC, a chiplet, a switch, an active cable, or other suitable form factor positioned between the PCIe domain of the GPUs and the CXL.mem domain of the CXL device. The computer may maintain per-GPU tracking structures, address translation tables, and Tag mapping resources to support concurrent translations from GPUs. In some examples, the computer and the CXL device may be included within a same IC package, optionally coupled by UCIe links or other die-to-die interconnects.

In some implementations of the system, the memory is accessible by the GPUs as a shared memory region, and wherein the computer is configured to translate PCIe memory requests from the GPUs to CXL.mem M2S requests targeting the shared memory region. The shared memory region may enable GPUs to access common data, such as model parameters, training datasets, or intermediate computation results, without requiring explicit data copying between GPUs. The computer may implement arbitration and flow control mechanisms to manage concurrent access from GPUs. The shared memory architecture may reduce total memory requirements and inter-GPU communication latency in multi-GPU systems.

In some implementations of the system, the computer maintains memory allocation information associating portions of the memory with respective GPUs, and wherein translating the PCIe memory request comprises selecting a target address within the memory based on an identity of a requesting GPU of the GPUs. The memory allocation information may enable partitioned access wherein each GPU is assigned a dedicated portion of the memory for private use. The computer may identify the requesting GPU based on the Requester ID in the PCIe memory request or other identification mechanisms, and may direct the CXL.mem M2S request to the appropriate memory partition. The partitioning may provide isolation between GPU workloads for security, fault containment, or resource management purposes.

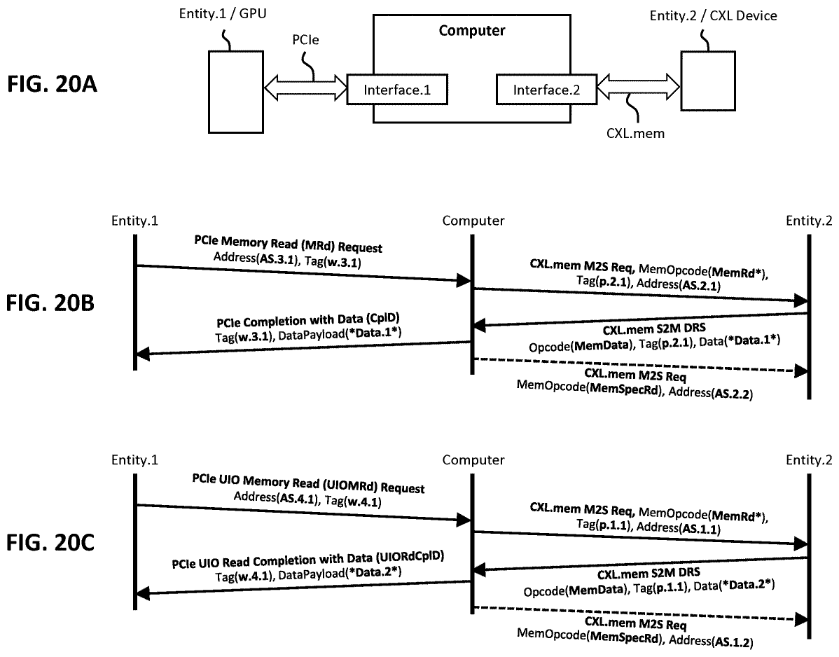

FIG. 20A illustrates an example of a system comprising a switch (e.g., a CXL switch), a processor, or a bridge, which comprises a computer coupled between a first interface (Interface.1) and a second interface (Interface.2). The first interface may communicate according to PCIe with a first entity (Entity.1), such as a GPU. The second interface may communicate according to a CXL protocol, such as CXL.mem, with a second entity (Entity.2), such as a CXL device, which may be a CXL memory expander, a CXL memory pool, or a GFD. The computer may extract physical addresses from messages received via the first interface, wherein these addresses may refer to a first Physical Address (PA) space utilized by the first entity; translate these addresses; and generate messages carrying the translated physical addresses for transmission via the second interface; wherein these translated addresses may refer to a second PA space utilized by the second entity. In some examples, the first PA space and the second PA space may be the same PA space, wherein the computer may perform address translations between addresses within the same PA space. The computer may perform further translations between the PCIe domain and the CXL domain, such as translating between PCIe TLP types (e.g., MRd, UIOMRd) and CXL.mem opcodes (e.g., MemRd, MemRdData, MemRdTEE). The computer may be implemented as a monolithic die, as one or more chiplets within an IC package, or as one or more components on a board. In some examples, the computer and at least one of the first entity or the second entity may be included within the same IC package, optionally coupled by one or more UCIe links.

FIG. 20B illustrates an example of a TFD demonstrating translations, performed by a computer, between PCIe TLPs received from a first entity (Entity.1), which may be a GPU, and CXL.mem messages sent to a second entity (Entity.2), which may be a CXL device, possibly enabling the first entity to access resources mapped to an address space utilized by the second entity. The first entity may initiate a PCIe transaction that includes a PCIe Memory Read (MRd) request comprising Address(AS.3.1) and Tag(w.3.1). The computer may translate the PCIe transaction to a CXL.mem transaction that includes a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses such as translating the CXL.mem S2M DRS to a PCIe Completion with Data (CplD) comprising Tag(w.3.1) and DataPayload(*Data.1*), and may send the CplD to the first entity. The computer may perform further translations, such as protocol translations, opcode translations, command translations, or TLP translations, e.g., translating between PCIe TLPs and CXL.mem messages, wherein these translations may include field translations, such as translating between PCIe Tags and CXL.mem Tags, translating between reserved fields, and translating between reserved and non-reserved fields. The computer may further initiate speculative memory reads targeting the second entity, wherein the speculative memory reads may include a CXL.mem M2S Req comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

FIG. 20C illustrates an example of a TFD demonstrating translations between PCIe UIO TLPs received from a first entity (Entity.1), which may be a GPU, and CXL.mem messages sent to a second entity (Entity.2) which may be a CXL device, possibly enabling the first entity to access resources mapped to an address space utilized by the second entity (Entity.2). The first entity may initiate a PCIe UIO transaction that may include a PCIe UIO Memory Read (UIOMRd) request comprising Address(AS.4.1) and Tag(w.4.1). The computer may translate the PCIe UIO transaction to a CXL.mem transaction that may include a CXL.mem M2S request comprising MemOpcode(MemRd*), Tag(p.1.1), and Address(AS.1.1), and may send the CXL.mem M2S request to the second entity. Upon receiving one or more responses from the second entity, which may include a CXL.mem S2M DRS comprising Opcode(MemData), Tag(p.1.1), and Data(*Data.2*), the computer may translate the one or more responses, such as translating the CXL.mem S2M DRS to a PCIe UIO Read Completion with Data (UIORdCplD) comprising Tag(w.4.1) and DataPayload(*Data.2*); and may send the UIORdCplD to the first entity. The computer may perform further translations, such as protocol translations, opcode translations, command translations, or TLP translations, e.g., translating between PCIe UIO TLPs and CXL.mem messages, wherein these translations may include field translations. The computer may further initiate speculative memory reads targeting the second entity, wherein the speculative memory reads may include a CXL.mem M2S Req comprising MemOpcode(MemSpecRd) and Address(AS.1.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

In heterogeneous computing architectures, entities may utilize different PCIe revisions while requiring coordinated access to shared resources. PCIe Unordered IO (UIO) is an optional capability that addresses limitations of PCI/PCIe fabric-based ordering rules, enabling multi-path routing, improved performance, and simplified fabric elements. However, PCIe specifications define UIO for Flit Mode (FM), and require that the entire path from requester to completer uses FM, supports UIO, and has UIO enabled. In environments where a first entity utilizing one PCIe revision needs to access resources coupled to a second entity utilizing a different PCIe revision, translations between PCIe UIO TLPs and PCIe non-UIO TLPs may facilitate memory operations and data transfers across different domains. Such translations may be performed by a computer, an apparatus, a cable, or other suitable devices positioned between the first entity and the second entity. The translations may further enable communication over split flit-mode/non-flit-mode paths, wherein the UIO portion utilizes flit-based encoding while the non-UIO portion may utilize non-flit-based encoding.

In various implementations, a method for translating between Peripheral Component Interconnect Express (PCIe) Transaction Layer Packets (TLPs), comprising: receiving, from a first entity, a first PCIe Memory Read request comprising a first address and a first Tag; translating, by a computer, the first PCIe Memory Read request to a second PCIe Memory Read request comprising a second address and a second Tag; wherein one of the first PCIe Memory Read request and the second PCIe Memory Read request comprises an Unordered Input/Output (UIO) Memory Read (UIOMRd) request, and the other comprises a non-UIO Memory Read (MRd) request; sending, to a second entity, the second PCIe Memory Read request; receiving, from the second entity, a second PCIe Completion comprising the second Tag and a data payload; translating, by the computer, the second PCIe Completion to a first PCIe Completion comprising the first Tag and the data payload; and sending, to the first entity, the first PCIe Completion. The translation process may encompass various aspects of the protocol messages, including opcodes, addresses, Tags, and other TLP fields, thereby enabling communication between entities that utilize different PCIe revisions. The computer may maintain state information, such as pending transaction tables or tracker entries, to correlate incoming PCIe Completions with previously transmitted PCIe Memory Read requests and with pending transactions. The method may be implemented in hardware, firmware, software, or combinations thereof, and may be performed by various types of devices, such as semiconductor devices, switches, bridges, or active cables. Additionally, the elements may communicate through one or more intermediary components, such as a switch, a retimer, or other suitable entity that facilitates information transfer.

In some implementations of the method, the first PCIe Memory Read request comprises the non-UIO MRd, the second PCIe Memory Read request comprises the UIO Memory Read (UIOMRd) request, the second PCIe Completion comprises a UIO Read Completion with Data (UIORdCplD), and the first PCIe Completion comprises a non-UIO Completion with Data (CplD). The non-UIO to UIO translation may enable a first entity that does not support UIO capabilities to access resources coupled to a second entity via a UIO-enabled path. The computer may translate the MRd to a UIOMRd, which may traverse a path supporting multi-path routing or out-of-order completion delivery. Upon receiving the UIORdCplD from the second entity, the computer may translate it to a CplD conforming to non-UIO PCIe completion expected by the first entity.

In some implementations of the method, the UIORdCplD comprises a CXL DevLoad (CDL), and wherein the computer extracts information from the CDL for at least one of: populating a CDL in a response to another entity, throttling subsequent requests, or storing Quality-of-Service (QoS) telemetry. The CDL in the UIORdCplD may carry telemetry information such as device load indicators, queue depth information, or latency metrics populated by the second entity or intermediate components. The computer may extract this information and utilize it for various purposes, such as propagating QoS telemetry to upstream components, implementing adaptive flow control by throttling the rate of subsequent requests, or storing the telemetry for monitoring and analysis. This extraction may enable the computer to make informed decisions regarding request pacing, load balancing, or resource allocation based on conditions observed at the second entity.

In some implementations of the method, the first PCIe Memory Read request comprises the UIO Memory Read (UIOMRd) request, the second PCIe Memory Read request comprises the non-UIO MRd, the second PCIe Completion comprises a non-UIO Completion with Data (CplD), and the first PCIe Completion comprises a UIO Read Completion with Data (UIORdCplD). The UIO to non-UIO translation may enable a first entity utilizing PCIe UIO to access resources coupled to a second entity that does not support UIO capabilities. The computer may translate the UIOMRd to a PCIe MRd, which may extend the reach of UIO-capable devices to legacy PCIe infrastructure or to devices that have not implemented UIO support.

In some implementations of the method, the UIORdCplD comprises a CXL DevLoad (CDL), and wherein the computer populates the CDL with Quality-of-Service (QoS) telemetry information based on at least one of: queue depth at the computer, observed latency, congestion indicators, or bandwidth utilization metrics. When translating from PCIe non-UIO completions that do not include a CDL, the computer may populate the CDL in the UIORdCplD to provide telemetry information to the first entity. The QoS telemetry information may be generated by the computer based on locally observed conditions. Queue depth may indicate the number of pending transactions awaiting completion. Observed latency may reflect the time elapsed between sending requests and receiving completions. Congestion indicators may signal backpressure conditions in downstream paths. Bandwidth utilization metrics may indicate the degree to which available bandwidth is being consumed. The first entity may utilize this telemetry information to make informed decisions about subsequent memory operations, such as throttling request rates, adjusting request priorities, or selecting alternative resources based on observed loading conditions. The computer may thus provide telemetry to the first entity even when the second entity does not support telemetry reporting.

In some implementations of the method, the first address is associated with a first physical address space utilized by the first entity, and wherein the second address is associated with a second physical address space utilized by the second entity. The address translation may be implemented utilizing lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations, the method further comprises receiving, from the first entity, a PCIe non-UIO Memory Write request (MWr) comprising a third address and write data; translating, by the computer, the PCIe MWr to a PCIe UIO Memory Write request (UIOMWr) comprising a fourth address and the write data; sending, to the second entity, the PCIe UIOMWr; and receiving, from the second entity, a PCIe UIO Write Completion (UIOWrCpl). The translation from non-UIO to UIO write may involve converting a posted write (MWr) that does not expect a completion into a non-posted write (UIOMWr) that receives a UIOWrCpl from the second entity. The UIOMWr may traverse a path supporting multi-path routing, potentially improving write performance in fabric topologies with multiple paths between source and destination. The computer may utilize the UIOWrCpl for flow control, error recovery, transaction ordering, or as a basis for generating a write acknowledgment to the first entity, as described in dependent claims.

In some implementations of the method, the computer buffers the write data prior to sending the PCIe UIOMWr, and wherein the computer utilizes the UIOWrCpl for at least one of: flow control, error recovery, or transaction ordering. The computer may buffer the write data internally to decouple the timing of receiving the MWr from the first entity and sending the UIOMWr to the second entity. The UIOWrCpl received from the second entity may provide confirmation that the write data has been accepted, which the computer may utilize for flow control by releasing buffer space, for error recovery by detecting and handling failed writes, or for transaction ordering by confirming completion of writes before allowing subsequent dependent operations.

In some implementations, the method further comprises receiving, from the first entity, a PCIe UIO Memory Write request (UIOMWr) comprising a third address, a third Tag, and write data; translating, by the computer, the PCIe UIOMWr to a PCIe non-UIO Memory Write request (MWr) comprising a fourth address and the write data; sending, to the second entity, the PCIe MWr; and sending, to the first entity, a PCIe UIO Write Completion (UIOWrCpl) comprising the third Tag. The translation from UIO to non-UIO write may involve converting a non-posted write (UIOMWr) that expects a completion into a posted write (MWr) that does not return a completion from the second entity. The computer may generate the UIOWrCpl to acknowledge receipt of the write data to the first entity, even though the second entity does not provide a completion for the posted MWr. This translation may enable UIO-capable devices to write to legacy PCIe devices while maintaining the non-posted write semantics expected by the first entity.

In some implementations of the method, the computer sends the UIOWrCpl to the first entity at one of: before sending the PCIe MWr to the second entity, in parallel with sending the PCIe MWr to the second entity, or after sending the PCIe MWr to the second entity; and wherein the UIOWrCpl comprises a CXL DevLoad (CDL) populated by the computer. The timing of the UIOWrCpl may provide different trade-offs between latency and ordering guarantees. Sending the UIOWrCpl before sending the MWr may reduce latency observed by the first entity and may allow the first entity to proceed with subsequent operations without waiting for the write to propagate to the second entity. Sending the UIOWrCpl in parallel with or after sending the MWr may provide stronger ordering guarantees at the cost of increased latency. The computer may populate the CDL with QoS telemetry information based on locally observed conditions, providing telemetry to the first entity even though the second entity does not return a completion.

In some implementations of the method, the computer buffers the write data, and wherein the computer is configured to retry sending the PCIe MWr to the second entity upon detecting a transmission error. The computer may retain the write data in a buffer after generating the UIOWrCpl to the first entity, enabling error recovery if the posted MWr encounters transmission errors on the path to the second entity. The computer may implement retry logic that re-sends the MWr upon detecting errors, thereby providing reliability guarantees to the first entity even though the posted write on the non-UIO path does not inherently provide acknowledgment. The buffer may be released after the computer determines that the MWr has been successfully transmitted or accepted by downstream components.

In some implementations of the method, communication between the computer and the first entity utilizes a first encoding mode, communication between the computer and the second entity utilizes a second encoding mode different from the first encoding mode, one of the first encoding mode and the second encoding mode comprises flit-based encoding and the other comprises non-flit-based encoding, the first entity comprises at least one of a PCIe host or a PCIe device, and the second entity comprises at least one of a PCIe host or a PCIe device. The split flit/non-flit path may enable communication between entities operating in different encoding modes. PCIe specifications define UIO for flit-based encoding, and do not permit direct translation of UIO TLPs to non-flit-based encoding. By performing TLP type translation, the computer may bridge these incompatible modes, enabling PCIe UIO transactions to reach PCIe devices operating in non-flit mode, or enabling non-flit PCIe devices to access resources via UIO-enabled paths. The first entity and second entity may include various types of hosts and devices, such as servers, processors, GPUs, NICs, storage controllers, memory expanders, or accelerators.

In various implementations, a system for translating between Peripheral Component Interconnect Express (PCIe) Transaction Layer Packets (TLPs), comprising: a first interface configured to communicate with a first entity; a second interface configured to communicate with a second entity; and a computer coupled between the first interface and the second interface, the computer configured to: receive, via the first interface, a first PCIe Memory Read request comprising a first address and a first Tag; translate the first PCIe Memory Read request to a second PCIe Memory Read request comprising a second address and a second Tag; wherein one of the first PCIe Memory Read request and the second PCIe Memory Read request comprises an Unordered Input/Output (UIO) Memory Read (UIOMRd) request, and the other comprises a non-UIO Memory Read (MRd) request; send, via the second interface, the second PCIe Memory Read request; receive, via the second interface, a second PCIe Completion comprising the second Tag and a data payload; translate the second PCIe Completion to a first PCIe Completion comprising the first Tag and the data payload; and send, via the first interface, the first PCIe Completion. The system may be implemented as a semiconductor device, a switch, a bridge, an active cable, or other suitable device positioned between the first entity and the second entity. The first interface and second interface may include physical layer components, link layer components, and transaction layer components configured based on PCIe specifications. The computer may include translation logic, address translation tables, Tag mapping structures, and pending transaction trackers to perform the translation between PCIe UIO and non-UIO TLPs.

In some implementations of the system, the first interface is configured to operate in a first encoding mode, wherein the second interface is configured to operate in a second encoding mode different from the first encoding mode, and wherein one of the first encoding mode and the second encoding mode comprises flit-based encoding and the other comprises non-flit-based encoding. The system may bridge flit-based and non-flit-based encoding modes, enabling UIO transactions originating from or destined to entities operating in Flit Mode to traverse paths operating in Non-Flit Mode, or vice versa. The first interface and second interface may each include encoding and decoding logic appropriate for their respective encoding modes, and the computer may handle the conversion between the different TLP header formats associated with each mode.

In some implementations of the system, the computer comprises: translation logic configured to translate between the UIOMRd and the MRd, and tracker entries, each configured to store a mapping between the first Tag and the second Tag for a pending transaction. The translation logic may include opcode mapping tables, address translation units, and field manipulation circuits to convert between UIO and non-UIO TLP formats. The tracker entries may be implemented as registers, memory structures, or content-addressable memory entries that associate incoming Tags with outgoing Tags and with other transaction state information. The tracker entries may enable the computer to handle concurrent transactions, with each entry tracking a separate pending read or write operation.

In some implementations of the system, the computer is configured to translate between a first physical address belonging to a first physical address space utilized by the first entity and a second physical address belonging to a second physical address space utilized by the second entity; wherein the first entity comprises at least one of a GPU, a Network Interface Card (NIC), a DMA engine, an accelerator, or a PCIe host; and wherein the second entity comprises at least one of a memory device, a memory expander, a memory pool, a storage controller, or a PCIe device. The address translation may be implemented utilizing lookup tables, translation lookaside buffers, page table walkers, or programmable translation functions. The address translation functionality may be configured by system software, firmware, or hardware configuration to establish mappings between the first and second physical address spaces. The computer may support various address space configurations, including identity mapping, offset-based translation, or arbitrary mapping based on page tables or similar structures.

In some implementations of the system, the first interface exposes a first endpoint to the first entity; wherein the second interface exposes a second endpoint to the second entity; and wherein the computer is implemented in an integrated circuit package comprising high-speed differential input/output (I/O) connections positioned according to a ball grid array (BGA) layout. The first endpoint may appear to the first entity as a PCIe device or a PCIe root port, depending on the system configuration. The second endpoint may similarly appear to the second entity as a PCIe device or a PCIe root port. The endpoints may implement capability structures, configuration space registers, and link management functions based on PCIe specifications, enabling the first entity and second entity to discover and communicate with the system using standard PCIe enumeration and configuration mechanisms. Additionally or alternatively, the IC package may conform to PCIe Retimer Supplemental Features and Standard BGA Footprint Specification or similar industry specifications. The BGA layout may facilitate integration of the system into standard PCIe card edge connector configurations, add-in card designs, or motherboard layouts. The high-speed differential I/O connections may support data rates such as 32.0 GT/s or higher as specified by PCIe Revision 6.0 or later specifications.

In various implementations, a method for enabling Unordered Input/Output (UIO) transactions over a split flit-mode/non-flit-mode path, comprising: receiving, via a first interface operating in a first data stream mode, a first Peripheral Component Interconnect Express (PCIe) Transaction Layer Packet (TLP); translating, by a computer, the first PCIe TLP to a second PCIe TLP, wherein the first PCIe TLP comprises a UIO TLP and the second PCIe TLP comprises a non-UIO TLP, or wherein the first PCIe TLP comprises a non-UIO TLP and the second PCIe TLP comprises a UIO TLP; and sending, via a second interface operating in a second data stream mode different from the first data stream mode, the second PCIe TLP; wherein one of the first data stream mode and the second data stream mode comprises Flit Mode (FM), and the other comprises Non-Flit Mode (NFM). PCIe specifications define UIO for Flit Mode, and no translations of UIO TLPs to Non-Flit Mode are permitted according to the PCIe Revision 6.2 specification. The method may enable communication between a first entity and a second entity utilizing UIO over a split FM/NFM path, wherein the UIO TLPs may traverse a path that utilizes FM, whereas the non-UIO TLPs may traverse a path that utilizes NFM. Such split FM/NFM path setup is not permitted in standard PCIe Revision 6.2 environments, and may be enabled by the translation capabilities of the computer. The Data Stream mode may be determined during initial Link training, wherein each PCIe Link is set up following a negotiation of Link width, data rate, and Flit mode by the two agents at each end of the Link.

In some implementations of the method, the first data stream mode comprises FM, the second data stream mode comprises NFM, the first PCIe TLP comprises a UIO TLP, and the second PCIe TLP comprises a non-UIO TLP. The FM-to-NFM direction may enable a first entity operating in Flit Mode with UIO capabilities to access resources coupled to a second entity operating in Non-Flit Mode. The computer may translate the UIO TLP received via the FM interface to a non-UIO TLP for transmission via the NFM interface, thereby bridging the encoding mode boundary while adapting the TLP type to conform to the capabilities of the NFM path.

In some implementations of the method, the first data stream mode comprises NFM, the second data stream mode comprises FM, the first PCIe TLP comprises a non-UIO TLP, and the second PCIe TLP comprises a UIO TLP. The NFM-to-FM direction may enable a first entity operating in Non-Flit Mode to access resources coupled to a second entity via a Flit Mode path that supports UIO. The computer may translate the non-UIO TLP received via the NFM interface to a UIO TLP for transmission via the FM interface, thereby enabling the first entity to benefit from UIO capabilities such as multi-path routing even though the first entity operates in NFM.

In some implementations, the method further comprises receiving, via the second interface, a third PCIe TLP comprising a PCIe Completion corresponding to the second PCIe TLP; translating, by the computer, the third PCIe TLP to a fourth PCIe TLP; and sending, via the first interface, the fourth PCIe TLP to a first entity. The completion flow may complete the transaction initiated by the first PCIe TLP. The third PCIe TLP may include a UIO completion or a non-UIO completion depending on the TLP type of the second PCIe TLP. The computer may translate the third PCIe TLP to the fourth PCIe TLP, which may include a UIO completion or a non-UIO completion corresponding to the TLP type of the first PCIe TLP, thereby maintaining protocol consistency on each side of the computer.

In some implementations of the method, the first PCIe TLP comprises a UIO Memory Read (UIOMRd) request, the second PCIe TLP comprises a non-UIO Memory Read (MRd) request, the third PCIe TLP comprises a non-UIO Completion with Data (CplD), the fourth PCIe TLP comprises a UIO Read Completion with Data (UIORdCplD) comprising a CXL DevLoad (CDL), and wherein the computer populates the CDL. When translating from a CplD that does not include a CDL to a UIORdCplD that includes a CDL, the computer may populate the CDL with QoS telemetry information based on locally observed conditions. This population may enable the first entity to receive telemetry feedback even when the second entity does not support UIO or telemetry reporting.

In some implementations of the method, the first PCIe TLP comprises a non-UIO Memory Read (MRd) request, the second PCIe TLP comprises a UIO Memory Read (UIOMRd) request, the third PCIe TLP comprises a UIO Read Completion with Data (UIORdCplD) comprising a CXL DevLoad (CDL), and the fourth PCIe TLP comprises a non-UIO Completion with Data (CplD). When translating from a UIORdCplD that includes a CDL to a CplD that does not include a CDL, the computer may extract the information from the CDL and utilize it for purposes such as throttling subsequent requests, implementing adaptive flow control, or storing the telemetry for monitoring and analysis.

In some implementations of the method, the first PCIe TLP comprises a PCIe Memory Write request, and wherein the method further comprises: receiving, via the second interface, a third PCIe TLP comprising a PCIe UIO Write Completion (UIOWrCpl) when the second PCIe TLP comprises a UIO Memory Write request (UIOMWr); translating, by the computer, the third PCIe TLP to a fourth PCIe TLP; and sending, via the first interface, the fourth PCIe TLP. When the first PCIe TLP comprises a UIOMWr transmitted via an FM interface, the second PCIe TLP may include a MWr transmitted via an NFM interface as a posted write. The computer may generate a UIOWrCpl to send to the first entity even though the second entity does not return a completion for the posted MWr. Conversely, when the first PCIe TLP comprises a MWr, the computer may translate it to a UIOMWr and receive a UIOWrCpl from the second entity.

In some implementations of the method, the first PCIe TLP comprises a first physical address in a first physical address space, the second PCIe TLP comprises a second physical address in a second physical address space, a first entity coupled to the first interface comprises at least one of a GPU, a Network Interface Card (NIC), a DMA engine, or an accelerator, and wherein a second entity coupled to the second interface comprises at least one of a memory device, a memory expander, a memory pool, a storage controller, or a PCIe host. GPUs may utilize PCIe memory transactions to access large memory pools for graphics rendering, machine learning inference, or general-purpose GPU computing workloads. NICs may utilize PCIe memory transactions to access memory buffers for network packet processing, RDMA, or storage traffic handling. DMA engines may utilize PCIe memory transactions to transfer data between memory regions on behalf of other system components. The address translation may enable these devices to access resources utilizing addresses within their native address space while the second entity operates within its own address space.

In some implementations of the method, the first interface exposes a first endpoint to a first entity, wherein the second interface exposes a second endpoint to a second entity, wherein the first PCIe TLP comprises a first physical address in a first physical address space utilized by the first entity, and wherein the second PCIe TLP comprises a second physical address in a second physical address space utilized by the second entity. The first endpoint may be configured as a PCIe endpoint that appears to the first entity as a PCIe device operating in the first data stream mode. The second endpoint may be configured as a PCIe endpoint that appears to the second entity as a PCIe device operating in the second data stream mode. The endpoints may handle link training, flow control initialization, and capability negotiation according to their respective data stream modes. The address translation between the first physical address space and the second physical address space may be implemented utilizing lookup tables, page tables, base-and-offset calculations, or programmable translation functions.

In various implementations, a system for enabling Unordered Input/Output (UIO) transactions over a split flit-mode/non-flit-mode path, comprising: a first interface configured to operate in a first data stream mode and to communicate with a first entity; a second interface configured to operate in a second data stream mode different from the first data stream mode and to communicate with a second entity; wherein one of the first data stream mode and the second data stream mode comprises Flit Mode (FM), and the other comprises Non-Flit Mode (NFM); and a computer coupled between the first interface and the second interface, the computer configured to: receive, via the first interface, a first Peripheral Component Interconnect Express (PCIe) Transaction Layer Packet (TLP); translate the first PCIe TLP to a second PCIe TLP, wherein the first PCIe TLP comprises a UIO TLP and the second PCIe TLP comprises a non-UIO TLP, or wherein the first PCIe TLP comprises a non-UIO TLP and the second PCIe TLP comprises a UIO TLP; and send, via the second interface, the second PCIe TLP. The system may bridge Flit Mode and Non-Flit Mode encoding boundaries while performing TLP type translation between UIO and non-UIO formats. The first interface and second interface may each include physical layer components configured for their respective data stream modes, including different scrambling, encoding, and framing mechanisms. The computer may include translation logic to convert between the different TLP header formats and field arrangements associated with FM and NFM operation.

In some implementations of the system, the first interface is configured to perform link training to establish the first data stream mode with the first entity, and wherein the first entity comprises at least one of a legacy PCIe device operating in NFM, a GPU, or a NIC; and wherein the second interface is configured to perform link training to establish the second data stream mode with the second entity, and wherein the second entity comprises at least one of a UIO-capable memory device, a memory pool operating in FM, or a fabric switch. The link training may include negotiation of Link width, data rate, and Flit mode between each interface and its respective entity. The first interface may negotiate FM with the first entity if both support FM, or may fall back to NFM otherwise. The second interface may independently negotiate FM or NFM with the second entity. The system may thus establish different data stream modes on each interface based on the capabilities of the connected entities. Additionally, legacy PCIe devices may operate in NFM due to hardware generation or design choices, and may benefit from access to UIO-enabled paths through the system's translation capabilities. GPUs and NICs may operate in either FM or NFM depending on their capabilities and may utilize the system to access memory resources across encoding mode boundaries. Memory pools and fabric switches operating in FM with UIO support may provide high-bandwidth, low-latency memory access that becomes accessible to NFM devices through the system.

In some implementations of the system, the first interface supports a first data rate, wherein the second interface supports a second data rate different from the first data rate, and wherein FM is selected when a data rate exceeds a threshold data rate. PCIe specifications may require FM for data rates exceeding 32.0 GT/s. The system may support different data rates on each interface, with the first interface potentially operating at a higher data rate in FM while the second interface operates at a lower data rate in NFM, or vice versa. This capability may enable the system to connect entities with different performance capabilities while providing translation between encoding modes.

In some implementations of the system, the computer comprises: translation logic configured to translate between UIO TLPs and non-UIO TLPs; and an address translation unit configured to translate between a first physical address belonging to a first physical address space utilized by the first entity and a second physical address belonging to a second physical address space utilized by the second entity. The translation logic may include opcode mapping circuits, header format converters, and field manipulation logic to transform TLPs between UIO and non-UIO formats while also converting between FM and NFM header layouts. The address translation unit may operate in conjunction with the translation logic to modify addresses during the TLP translation process.

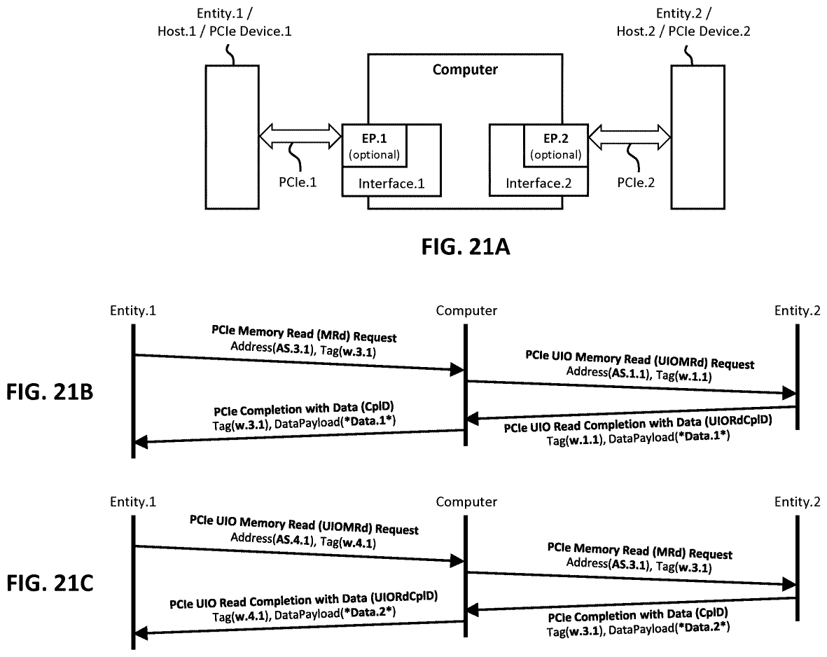

FIG. 21A illustrates an example of a system comprising a computer coupled between first and second interfaces. The first interface (Interface.1) may communicate according to a first PCIe-based protocol, such as PCIe Specification Revision 5.0. The second interface (Interface.2) may communicate according to a second PCIe-based protocol, such as PCIe Specification Revision 6.2. The computer may be implemented in an IC package having high-speed differential I/O balls positioned according to a ball grid array layout defined by PCIe Retimer Supplemental Features and Standard BGA Footprint Specification. The first interface may expose a first endpoint (EP.1) and may communicate according to the first PCIe-based protocol with a first entity (Entity.1), which may be a first host (Host.1) or a first PCIe device (PCIe Device.1). The second interface may expose a second endpoint (EP.2) and may communicate according to the second PCIe-based protocol, with a second entity (Entity.2), which may be a second host (Host.2) or a second PCIe device (PCIe Device.2). The computer may extract physical addresses from first PDUs, such as first TLPs, received via the first interface, wherein these addresses may refer to a first physical address space utilized by the first entity; translate these addresses; and generate second PDUs, such as second TLPs, carrying the translated physical addresses for transmission via the second interface; wherein these translated addresses may correspond to a second physical address space utilized by the second entity.

FIG. 21B illustrates an example of a transaction flow diagram (TFD) demonstrating translations between TLPs associated with a first PCIe, received from a first entity (Entity.1), which may be a first host (Host.1) or a first PCIe device (PCIe Device.1), and UIO TLPs associated with a second PCIe, sent to a second entity (Entity.2), which may be a second host (Host.2) or a second PCIe device (PCIe Device.2), possibly enabling the first entity to access resources mapped to an address space utilized by the second entity. The first entity may initiate a PCIe transaction that includes a PCIe Memory Read (MRd) request comprising Address(AS.3.1) and Tag(w.3.1). A computer may translate the PCIe transaction to a PCIe UIO transaction that includes a PCIe UIO Memory Read (UIOMRd) request comprising Address(AS.1.1) and Tag(w.1.1), and may send the PCIe UIOMRd to the second entity. Upon receiving a completion from the second entity, which may include a PCIe UIO Read Completion with Data (UIORdCplD) comprising Tag(w.1.1), and DataPayload(*Data.1*), the computer may translate the PCIe UIORdCplD to a PCIe Completion with Data (CplD) comprising Tag(w.3.1) and DataPayload(*Data.1*), and send the PCIe CplD to the first entity.

The computer may perform further translations, such as protocol translations, opcode translations, command translations, TLP type translations, Tag translations, length translations, or field translations. Recent PCIe hosts and devices may utilize the PCIe Unordered IO (UIO) optional capability, originally introduced as ECN, and later incorporated into PCIe Base Specification Revision 6.2. PCIe UIO defines a new wire semantic and related capabilities that address limitations of the PCI/PCIe fabric-based ordering rules, enabling improved performance and efficiency, such as by utilizing multi-path routing. Some PCIe revisions, such as PCIe Revision 6.2, may use two Data Stream modes: Flit Mode (FM), and Non-Flit Mode (NFM). Support of Data Stream in NFM may be mandatory, while support of Data Stream in FM may be mandatory for example only if data rate that exceeds 32.0 GT/s is supported. The Data Stream mode may be determined during initial Link training, wherein each PCIe Link is set up following a negotiation of Link width, data rate, and Flit mode by the two agents at each end of the Link. If FM is not disabled, and if both the Ports (and all Pseudo-Ports, if any) support it, FM may be chosen. Otherwise, NFM may be chosen. The current PCIe specifications define PCIe UIO for FM, and no translations of UIO TLPs to NFM are permitted. According to PCIe Revision 6.2 specifications, UIO may be used when the entire path from requester to completer uses FM, supports UIO, and has UIO enabled. The translations may further enable communication between the first entity and the second entity utilizing UIO over a split FM/NFM path, wherein the UIO TLPs may traverse a path that may utilize FM, whereas the non-UIO TLPs may traverse a path that may utilize NFM. Such split FM/NFM path setup is not allowed in standard PCIe Revision 6.2 environments, and may be enabled by the translation capabilities of the computer.

FIG. 21C illustrates an example of a TFD demonstrating translations between UIO TLPs associated with a first PCIe, received from a first entity (Entity.1), which may be a first host (Host.1) or a first PCIe device (PCIe Device.1), and TLPs associated with a second PCIe, sent to a second entity (Entity.2), which may be a second host (Host.2) or a second PCIe device (PCIe Device.2), possibly enabling the first entity to access resources mapped to an address space utilized by the second entity. The first entity may initiate a PCIe UIO transaction that includes a PCIe UIOMRd comprising Address(AS.4.1) and Tag(w.4.1). A computer may translate the PCIe UIO transaction to a PCIe transaction that includes a PCIe MRd comprising Address(AS.3.1) and Tag(w.3.1), and may send the PCIe MRd to the second entity. Upon receiving a completion from the second entity, which may include a PCIe CplD comprising Tag(w.3.1) and DataPayload(*Data.2*), the computer may translate the PCIe CplD to a PCIe UIORdCplD comprising Tag(w.4.1), and DataPayload(*Data.2*), and send the PCIe UIORdCplD to the first entity. The computer may perform further translations, such as protocol translations, opcode translations, command translations, TLP type translations, Tag translations, length translations, or field translations.

The PCIe specification Revision 6.2 defines PCIe UIO for FM, no translations of UIO TLPs to NFM are permitted, and UIO may be used when the entire path from requester to completer uses FM, supports UIO, and has UIO enabled. The translations may further enable communication between the first entity and the second entity utilizing UIO over a split FM/NFM path, wherein the UIO TLPs may traverse a path that may utilize FM, whereas the non-UIO TLPs may traverse a path that may utilize NFM. Such split FM/NFM path setup is not allowed in standard PCIe Revision 6.2 environments, and may be enabled by the translation capabilities of the computer.

### Terminology

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2c, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D 1.4 ), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### General Considerations

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or exchange/exchanging when used to describe elements (e.g., computer, RPU, MxPU, processor, semiconductor device, switch, port, interface) involved in data, message, packet, or other information exchanges, may refer to direct or indirect operation(s) that facilitate information transfer tofrom/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS. 1.1)=00-00-CA-FE in a protocol that utilizes 32-bit address fields, which corresponds to the address (AS. 2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A method for translating between Compute Express Link (CXL) Transaction Layer Packets (TLPs) and Peripheral Component Interconnect Express (PCIe) TLPs, comprising:
receiving, from a first entity, a CXL.io Unordered Input/Output (UIO) Memory Read (UIOMRd) request comprising a first address and a first Tag;
translating, by a computer, the CXL.io UIOMRd to a PCIe memory request comprising a second address and a second Tag;
sending, to a second entity, the PCIe memory request;
receiving, from the second entity, a PCIe Completion corresponding to the PCIe memory request;
translating, by the computer, the PCIe Completion to a CXL.io UIO Read Completion with Data (UIORdCplD) comprising the first Tag and a data payload; and
sending, to the first entity, the CXL.io UIORdCplD.

2. The method of claim 1, wherein the first address is associated with a first physical address space utilized by the first entity, and wherein translating the CXL.io UIOMRd to the PCIe memory request comprises generating the PCIe memory request comprising the second address that is associated with a second physical address space utilized by the second entity.

3. The method of claim 2, wherein the PCIe memory request comprises a PCIe UIO Memory Read (UIOMRd) request, the PCIe Completion comprises a PCIe UIORdCplD, and the CXL.io UIORdCplD comprises a CXL DevLoad (CDL) populated by the computer with Quality-of-Service (QoS) telemetry information.

4. The method of claim 2, wherein the PCIe memory request comprises a PCIe non-UIO Memory Read (MRd) request, and the PCIe Completion comprises a PCIe non-UIO Completion with Data (CplD).

5. The method of claim 4, wherein the CXL.io UIORdCplD comprises a CXL DevLoad (CDL), and wherein the computer populates the CDL with Quality-of-Service (QoS) telemetry information.

6. The method of claim 1, wherein communication between the computer and the first entity utilizes flit-based encoding, and wherein communication between the computer and the second entity utilizes non-flit-based encoding.

7. The method of claim 1, further comprising: receiving, from the first entity, a CXL.io UIO Memory Write request (UIOMWr) comprising a third address, a third Tag, and write data;
translating, by the computer, the CXL.io UIOMWr to a PCIe UIOMWr comprising a fourth address, a fourth Tag, and the write data; sending, to the second entity, the PCIe UIOMWr;
receiving, from the second entity, a PCIe UIO Write Completion (UIOWrCpl) comprising the fourth Tag; translating, by the computer, the PCIe UIOWrCpl to a CXL.io UIOWrCpl comprising a CXL DevLoad (CDL) and the third Tag; and sending, to the first entity, the CXL.io UIOWrCpl.

8. The method of claim 7, wherein the third address is associated with a first physical address space, wherein the fourth address is associated with a second physical address space, and wherein the computer translates between the third address and the fourth address.

9. The method of claim 1, further comprising: receiving, from the first entity, a CXL.io UIO Memory Write request (UIOMWr) comprising a third address and write data; translating, by the computer, the CXL.io UIOMWr to a PCIe non-UIO Memory Write request (MWr) comprising a fourth address and the write data; and sending, to the second entity, the PCIe MWr.

10. The method of claim 9, wherein the third address is associated with a first physical address space utilized by the first entity; wherein the fourth address is associated with a second physical address space utilized by the second entity; wherein the first entity comprises a CXL host or a CXL device; and wherein the second entity comprises a PCIe host or a PCIe device.

11. An apparatus comprising:
a first interface configured to communicate with a first entity based on CXL.io Unordered Input/Output (UIO), wherein CXL denotes Compute Express Link;
a second interface configured to communicate with a second entity based on Peripheral Component Interconnect Express (PCIe); and
a computer coupled to the first interface and the second interface, the computer configured to:
receive, via the first interface, a CXL.io UIO Memory Read (UIOMRd) request comprising a first address and a first Tag;
translate the CXL.io UIOMRd to a PCIe memory request comprising a second address and a second Tag; and
send, via the second interface, the PCIe memory request to the second entity.

12. The apparatus of claim 11, wherein the computer is further configured to: receive, via the second interface, a PCIe Completion corresponding to the PCIe memory request; translate the PCIe Completion to a CXL.io UIO Read Completion with Data (UIORdCplD) comprising the first Tag and a data payload; and send, via the first interface, the CXL.io UIORdCplD to the first entity.

13. The apparatus of claim 12, wherein the first address is associated with a first physical address space utilized by the first entity, the second address is associated with a second physical address space utilized by the second entity, and wherein the computer is further configured to translate between the first address and the second address.

14. The apparatus of claim 13, wherein the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information.

15. The apparatus of claim 13, wherein the PCIe memory request comprises a PCIe non-UIO Memory Read (MRd) request, the PCIe Completion comprises a PCIe non-UIO Completion with Data (CplD), wherein communication via the first interface utilizes flit-based encoding, and wherein communication via the second interface utilizes non-flit-based encoding.

16. The apparatus of claim 11, wherein the first interface exposes a first endpoint to the first entity, and wherein the second interface exposes a second endpoint to the second entity.

17. The apparatus of claim 11, wherein the apparatus comprises a cable including a first module coupled to the first interface, a second module coupled to the second interface, and a physical medium coupling the first module and the second module.

18. A system comprising:
a first entity configured to communicate based on CXL.io Unordered Input/Output (UIO), wherein CXL denotes Compute Express Link;
a second entity configured to communicate based on Peripheral Component Interconnect Express (PCIe); and
a computer coupled between the first entity and the second entity, the computer configured to:
receive, from the first entity, a CXL.io UIO Memory Read (UIOMRd) request comprising a first address;
translate the CXL.io UIOMRd to a PCIe memory request comprising a second address;
send, to the second entity, the PCIe memory request;
receive, from the second entity, a PCIe Completion corresponding to the PCIe memory request;
translate the PCIe Completion to a CXL.io UIO Read Completion with Data (UIORdCplD); and
send, to the first entity, the CXL.io UIORdCplD.

19. The system of claim 18, wherein the first address is associated with a first physical address space utilized by the first entity, the second address is associated with a second physical address space utilized by the second entity, wherein the first entity comprises a CXL host or a CXL device, and wherein the second entity comprises at least one of a memory device, a memory expander, a memory pool, a Graphics Processing Unit (GPU), a Network Interface Card (NIC), an accelerator, a PCIe host, or a PCIe device.

20. The system of claim 19, wherein the PCIe memory request comprises a PCIe non-UIO Memory Read (MRd) request, the PCIe Completion comprises a PCIe non-UIO Completion with Data (CplD), and wherein the CXL.io UIORdCplD comprises a CXL DevLoad (CDL) populated by the computer with Quality-of-Service (QoS) telemetry information.

21. The system of claim 19, wherein the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information.

22. The system of claim 18, wherein communication between the computer and the first entity utilizes flit-based encoding, and wherein communication between the computer and the second entity utilizes non-flit-based encoding.

23. A method for translating between Compute Express Link (CXL) Transaction Layer Packets (TLPs), comprising:
receiving, from a first entity, a CXL.io Memory Read (MRd) request comprising a first address and a first Tag;
translating, by a computer, the CXL.io MRd to a CXL.io Unordered Input/Output (UIO) Memory Read (UIOMRd) request comprising a second address and a second Tag;
sending, to a second entity, the CXL.io UIOMRd;
receiving, from the second entity, a CXL.io UIO Read Completion with Data (UIORdCplD) comprising the second Tag and a data payload;
translating, by the computer, the CXL.io UIORdCplD to a CXL.io Completion with Data (CplD) comprising the first Tag and the data payload;
and sending, to the first entity, the CXL.io CplD.

24. The method of claim 23, wherein the first address is associated with a first physical address space utilized by the first entity, and wherein translating the CXL.io MRd to the CXL.io UIOMRd comprises generating the CXL.io UIOMRd comprising the second address that is associated with a second physical address space utilized by the second entity.

25. The method of claim 23, wherein the computer maintains state information comprising tracker entries or pending transaction tables to correlate the CXL.io UIORdCplD with the CXL.io UIOMRd and to associate the second Tag with the first Tag.

26. The method of claim 23, wherein the CXL.io UIORdCplD comprises a CXL DevLoad (CDL) field carrying Quality-of-Service (QoS) telemetry information, the second entity utilizes the CDL field for throttling requests from the computer, and the computer does not propagate the CDL field to the first entity in the CXL.io CplD.

27. The method of claim 23, wherein a first CXL.io utilized for communicating the CXL.io MRd is an earlier revision than a second CXL.io utilized for communicating the CXL.io UIOMRd, and wherein a first interface utilized by the computer to communicate with the first entity and a second interface utilized by the computer to communicate with the second entity each comprise a CXL endpoint or a switch port.

28. One or more integrated circuits configured to perform the method of claim 23, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

29. An active cable comprising first and second pluggable modules coupled by a physical medium; wherein the active cable further comprises hardware circuitry, integrated into the active cable, configured to perform the method of claim 23.

30. An apparatus configured to operate as a switch, wherein the apparatus comprises switching circuitry and is configured to perform the method of claim 23.
